(19) United States
(12) Patent Application Publication
(10) Pub. No.: US 2021/0320329 A1
(43) Pub. Date: Oct. 14, 2021

(54) Solid Electrolytes, Electronic Devices, and Methods

(71) Applicant: The Florida State University Research Foundation, Inc., Tallahassee, FL (US)

(72) Inventors: Yan-Yan Hu, Tallahassee, FL (US); Po-Hsiu Chien, Tallahassee, FL (US); Xuyong Feng, Tallahassee, FL (US); Sawankumar Patel, Tallahassee, FL (US); Pengbo Wang, Tallahassee, FL (US)

(21) Appl. No.: 17/267,303

(22) PCT Filed: Aug. 9, 2019
(86) PCT No.: PCT/US2019/045870

§ 371 Date: Feb. 9, 2021

Related U.S. Application Data
(60) Provisional application No. 62/717,396, filed on Aug. 10, 2018.

(51) Int. Cl. H01M 10/0562

(52) U.S. Cl. CPC H01M 10/0562; H01M 2300/0091; H01M 2300/008

(57) ABSTRACT

Solid electrolytes, including lithium-argyrodite solid electrolytes, and electronic devices, such as lithium-ion batteries that include the solid electrolytes. Methods of making solid electrolytes, including methods for making solid electrolytes with varying degrees of lithium deficiency.

### CROSS-REFERENCE TO RELATED APPLICATIONS

This application claims priority to U.S. Provisional Patent Application No. 62/717,396, filed Aug. 10, 2018, which is incorporated herein by reference.

### STATEMENT REGARDING FEDERALLY SPONSORED RESEARCH AND DEVELOPMENT

This invention was made with government support under contract number DMR1508404 awarded by the National Science Foundation. The government has certain rights in the invention.

### BACKGROUND

A number of solid electrolytes, including inorganic ceramics, solid polymers, and polymer-ceramic hybrids, have been investigated in recent years. Due at least in part to the excellent thermal and/or electrochemical stability of some solid electrolytes, one or more safety issues associated with liquid electrolytes can be reduced or eliminated by substituting a liquid electrolyte with a solid electrolyte. Solid electrolytes also may exhibit wide electrochemical windows against lithium metal anodes and high-voltage cathodes, which can render improved energy density for lithium ion batteries, and/or an access to novel chemistries in Li—S and Li—O₂ batteries.

However, limited conductivity is a disadvantage associated with solid electrolytes. Sulfides have shown higher conductivity than oxides, which may be ascribed to the low resistance of their grain boundaries and/or high polarizability of their anion frameworks. For example, the sulfide material Li₁₀GeP₂S₁₂ (LGPS) can exhibit an ionic conductivity of 12 mS cm⁻¹, which is comparable to that of liquid electrolytes (Kamaya, N.; Homma, K.; Yamakawa, Y.; Hirayama, M.; Kanno, R.; Yonemura, M.; Kamiyama, T.; Kato, Y.; Hama, S.; Kawamoto, K.; et al. A Lithium Superionic Conductor. Nature Materials 2011, 10 (9), 682-686). However, costly precursors limit its use, especially in industrial applications.

Although some lithium-argyrodite solid electrolytes can exhibit excellent ionic conductivity, these materials typically suffer from poor stability compared to a Li metal anode, which is currently the standard choice for anode materials in all solid-state lithium ion batteries (ASSLIBs).

Therefore, there remains a need for solid electrolytes, including lithium-argyrodite solid electrolytes that have improved stability and/or conductivity, can be produced with relatively inexpensive materials, or a combination thereof.

### BRIEF SUMMARY

Provided herein are solid electrolytes having improved stability, improved conductivity, or a combination thereof. Most, if not all, of the starting materials used, in some embodiments, to make the solid electrolytes herein are relatively inexpensive.

In one aspect, solid electrolytes are provided. In some embodiments, the solid electrolytes include a lithium-argyrodite solid electrolyte. The lithium-argyrodite solid electrolyte may be of formula (I)—

Li₆₋ₐPS₅₋ₐX₁₊ₐ+bLiX (I),

wherein a is about −0.3 to about 0.75, b is 0 to about 0.3, and X is selected from the group consisting of Cl, Br, I, and a combination thereof

In another aspect, electronic devices are provided. In some embodiments, the electronic devices include at least one solid electrolyte provided herein. In some embodiments, the electronic devices include all-solid-state lithium ion batteries.

In a still further aspect, methods of forming a solid electrolyte are provided. In some embodiments, the methods include providing a mixture that includes Li₂S, P₂S₅, and LiX, wherein X is selected from the group consisting of Cl, Br, I, and a combination thereof, and the mixture has a mole ratio of [Li:P:S:X] of [about 5.25 to about 6.3:1:about 4.25 to about 5.3:about 0.7 to about 1.75]; grinding the mixture to form a powder; ball milling the powder to form a milled powder; sintering the milled powder to form a sintered powder; optionally grinding the sintered powder; pressing the sintered powder into a pellet; and sintering the pellet.

Additional aspects will be set forth in part in the description which follows, and in part will be obvious from the description, or may be learned by practice of the aspects described herein. The advantages described herein will be realized and attained by means of the elements and combinations particularly pointed out in the appended claims. It is to be understood that both the foregoing general description and the following detailed description are exemplary and explanatory and are not restrictive.

### BRIEF DESCRIPTION OF THE DRAWINGS

FIG. 1 depicts a hierarchy tree of embodiments of compounds of formula Li₆₋ₐPS₅₋ₐX₁₊a+b LiX.

FIG. 2 depicts powder X-ray diffraction patterns of Li₆PS₅X (X=Cl and Br); the asterisks denote background signals likely resulting from a polyimide film and a stainless holder.

FIG. 3A depicts representative Nyquist plots of Li₆PS₅X (X=Cl and Br).

FIG. 3B depicts a different view of the electrochemical impedance spectroscopy (EIS) results of FIG. 3A; the measurements were performed at 21° C., and In foils were used as current collectors.

FIG. 4A depicts the results of variable-temperature EIS of Li₆PS₅Cl performed from −60° C. to 20° C.

FIG. 4B depicts the results of variable-temperature EIS of Li₆PS₅Cl performed from 40° C. to 120° C.

FIG. 4C depicts an Arrhenius plot of Li₆PS₅Cl.

FIG. 4D depicts a view of the EIS results of FIG. 4A; In foils were used as current collectors.

FIG. 5A depicts a ⁶Li NMR spectra, which indicates an effect of sintering temperature on the Li distribution and P local structures in Li₆PS₅Cl.

FIG. 5B depicts a ⁷Li NMR spectra, which indicates an effect of sintering temperature on the Li distribution and P local structures in Li₆PS₅Cl.

FIG. 5C depicts a ³¹P NMR spectra, which indicates an effect of sintering temperature on the Li distribution and P local structures in Li₆PS₅Cl.

FIG. 6A depicts representative Nyquist plots of Li₆PS₅Cl sintered at 480° C., 500° C., and 550° C.

FIG. 6B depicts ⁶Li site fractions as a function of sintering temperatures.

FIG. 7A depicts a ⁷Li NMR spectra before/after ⁶Li→⁷Li tracer-exchange.

FIG. 7B depicts a ⁶Li NMR spectra before/after ⁶Li→⁷Li tracer-exchange.

FIG. 7C depicts simulation results of a ⁶Li NMR spectra after ⁶Li→⁷Li tracer-exchange.

FIG. 7D depicts normalized ⁶Li integrals of Li sites before/after ⁶Li→⁷Li tracer-exchange.

FIG. 8A depicts variable-temperature ⁶Li NMR spectra of Li₆PS₅Cl.

FIG. 8B depicts variable-temperature ⁷Li NMR spectra of Li₆PS₅Cl.

FIG. 8C depicts variable-temperature ³¹P NMR spectra of Li₆PS₅Cl.

FIG. 9A depicts the results of ⁷Li Ti relaxation time measurements for Li₆PS₅Cl.

FIG. 9B depicts the results of ⁶Li FWHM (Hz) for Li₆PS₅Cl.

FIG. 9C depicts ⁶Li normalized integrals for Li₆PS₅Cl.

FIG. 9D depicts ³¹P normalized integrals for Li₆PS₅Cl.

FIG. 9E depicts the ⁶Li shift for the sites of FIG. 9A.

FIG. 10 depicts the results of a stability test of Li₆PS₅Cl against metallic Li, during which Li₆PS₅Cl was polarized by a biased potential at 0.1 mA/cm², 0.2 mA/cm², and 0.3 mA/cm² at 50° C.

FIG. 11 depicts powder X-ray diffraction patterns of Li₆₋ₐPS₅₋ₐCl₁₊ₐ (a=−0.3, −0.2, and −0.1); the asterisks denote the background signals from a polyimide film and a stainless holder.

FIG. 12 depicts powder X-ray diffraction patterns of Li₆₋ₐPS₅₋ₐBr₁₊ₐ (a=0.1, 0.2, and 0.3); the asterisks denote the background signals from a polyimide film and a stainless holder.

FIG. 13A depicts representative Nyquist plots of Li₆₋ₐPS₅₋ₐCl₁₊ₐ (a=0.1, 0.2, and 0.3).

FIG. 13B depicts representative Nyquist plots of Li₆₋ₐPS₅₋ₐCl₁₊ₐ (a=−0.3, −0.2, and −0.1).

FIG. 13C depicts representative Nyquist plots of Li₆₋ₐPS₅₋ₐBr₁₊ₐ (a=−0.3, −0.2, and −0.1).

FIG. 14A depicts an effect of Li-excess and Li-deficiency on a ⁶Li NMR spectra.

FIG. 14B depicts an effect of Li-excess and Li-deficiency on a ⁷Li NMR spectra.

FIG. 14C depicts an effect of Li-excess and Li-deficiency on a ³¹P NMR spectra.

FIG. 14D depicts an ^{6,7}Li isotropic chemical shift as a function of singular Cl doping level.

FIG. 15A depicts ⁶Li site fraction relaxation time as a function of Cl doping level.

FIG. 15B depicts ³¹P site fraction relaxation time as a function of Cl doping level.

FIG. 15C depicts ⁷Li Ti relaxation time as a function of Cl doping level.

FIG. 16A depicts representative Nyquist plots of Li_{5.7}PS_{4.7}ClₐBr_{b} (a+b=1.3; a≤1.0).

FIG. 16B depicts an enhanced view of the Nyquist plots of FIG. 16A.

FIG. 17A depicts a plot obtained from a variable-temperature EIS of Li_{5.7}PS_{4.7}Cl_{1.0}Br_{0.3} performed from −60° C. to 0° C.

FIG. 17B depicts a plot obtained from a variable-temperature EIS of Li_{5.7}PS_{4.7}Cl_{1.0}Br_{0.3} performed from 20° C. to 100° C.

FIG. 17C depicts an Arrhenius plot of Li_{5.7}PS_{4.7}Cl_{1.0}Br_{0.3}.

FIG. 17D depicts an enhanced view of the plot of FIG. 17A.

FIG. 18 depicts a ³¹P NMR spectrum of Li_{5.7}PS_{4.7}Cl₁Br_{0.3}.

FIG. 19A depicts a representative Nyquist plot of Li_{5.7}PS_{4.7}Cl_{1.0}I_{0.3}.

FIG. 19B depicts an enhanced view of the plot of FIG. 19B.

FIG. 20 depicts a representative Nyquist plot of Li_{5.8}PS_{4.8}Cl_{1.2}+0.2 LiCl.

FIG. 21 depicts a representative Nyquist plot of an embodiment of a symmetric Li |Li_{5.7}PS_{4.7}Cl_{1.3}+0.3 LiCl| Li battery.

FIG. 22 depicts the results of a stability test of Li_{5.7}PS_{4.7}Cl_{1.3}+0.3 LiI against metallic Li.

FIG. 23 depicts representative Nyquist plots of Li₆PS₅Cl_{0.9}I_{0.1} and Li₆PS₅Cl_{0.8}I_{0.2}.

FIG. 24A depicts the results of a stability test of Li₆PS₅Cl_{0.9}I_{0.1} against metallic Li.

FIG. 24B depicts an enlarged view of the results of FIG. 24A.

FIG. 25 depicts powder X-ray diffraction patterns of Li₆₊ₓP₂S₈Iₓ (x=0, 0.75, 1, 2).

FIG. 26A depicts a plot of the Ac impedance of embodiments of materials.

FIG. 26B depicts an Arrhenius plot for embodiments of materials.

FIG. 26C depicts an enhanced view of several plots of FIG. 26A.

FIG. 27 depicts a summary of ⁶Li NMR results for Li₆₊ₓP₂S₈Iₓ (x=0, 0.75, 1, and 2).

FIG. 28 depicts a summary of ³¹P NMR results for Li₆₊ₓP₂S₈Iₓ (x=0, 0.75, 1, and 2).

FIG. 29 depicts cycle performances of embodiments of samples with Li/SE/Li symmetric cells: (a) Li₃PS₄, (b) Li_{6.75}P₂S₈I_{0.75}, (c) Li₇P₂S₈I, (d) Li₈P₂S₈I₂.

FIG. 30 depicts powder X-ray diffraction patterns of Li_{20/3}P₂S₈I_{2/3} sintered at 230° C. for different periods.

FIG. 31A depicts Ac impedance of Li_{20/3}P₂S₈I_{2/3} sintered at 230° C. for different periods.

FIG. 31B depicts an enhanced view of the plots of FIG. 31A.

FIG. 32A depicts an Arrhenius plot of Li_{20/3}P₂S₈I_{2/3} sintered at 230° C. for 1 hour.

FIG. 32B depicts the Ac impedance of Li_{20/3}P₂S₈I_{2/3} at the indicated temperatures.

FIG. 32C depicts the Ac impedance of Li_{20/3}P₂S₈I_{2/3} at the indicated temperatures.

FIG. 33A-F depict ⁷Li spectra of (FIG. 33A) L_{20/3}P₂S₈I_{2/3} (sintered for 0.5 h) and (FIG. 33D) L_{20/3}P₂S₈I_{2/3} (sintered for 2.0 h). ⁶Li spectra of (FIG. 33B) L_{20/3}P₂S₈I_{2/3} (sintered for 0.5 h) and (FIG. 33E) L_{20/3}P₂S₈I_{2/3} (sintered for 2.0 h). ³¹P spectra of (FIG. 33C) L_{20/3}P₂S₈I_{2/3} (sintered for 0.5 h) and (FIG. 33F) L_{20/3}P₂S₈I_{2/3} (sintered for 2.0 h).

FIG. 34A and FIG. 34B depict a comparison of ⁷Li and ⁶Li NMR of Li_{20/3}P₂S₈I_{2/3} before and after ⁶Li→⁷Li replacement, and the difference spectra, respectively.

FIG. 34C and FIG. 34D depict ⁷Li and ⁶Li NMR of Li_{20/3}P₂S₈I_{2/3} before and after ⁶Li→⁷Li replacement, respectively.

FIG. 34E and FIG. 34F depict detailed analyses of the ⁷Li and ⁶Li difference spectra to show more clearly the phases that participate in Li ion conduction.

FIG. 35A depicts a ³¹P spectra of Li_{20/3}P₂S₈I_{2/3} before and after ⁶Li→⁷Li tracer-exchange, and the difference spectrum.

FIG. 35B depicts a detailed analyses of the ³¹P spectrum of FIG. 35A after ⁶Li→⁷Li tracer-exchange.

FIG. 36 depicts the results of a stability test of Li_{20/3}P₂S₈I_{2/3} (230° C. for 1h) with Li/Li_{20/3}P₂S₈I_{2/3}/Li cells.

FIG. 37 depicts powder X-ray diffraction patterns of Li₃PS_{3.75}O_{0.25} sintered at 230° C. for 2 h, 6 h, and 12 h.

FIG. 38A depicts representative Nyquist plots of Li₃PS_{3.75}O_{0.25} sintered at 230° C. for 0.5 h, 1 h, 2 h, 6 h, and 12 h.

FIG. 38B depicts the ionic conductivity of Li₃PS_{3.75}O_{0.25} as a function of sintering duration.

FIG. 39A depicts variable-temperature EIS of Li₃PS_{3.75}O_{0.25} performed from 25° C. to 115° C.

FIG. 39B depicts an Arrhenius plot of Li₃PS_{3.75}O_{0.25}.

FIG. 40A depicts representative Nyquist plots of Li₃PS_{3.75}O_{0.25} after exposure to moisture/oxygen.

FIG. 40B depicts a calculated resistance as a function of accumulated exposure time.

FIG. 41 depicts the results of a stability test of Li₃PS_{3.75}O_{0.25} against metallic Li.

FIG. 42A depicts ⁶Li MAS NMR spectra of Li₆₋ₓPS₅₋ₓCl₁₊ₓ (x=0, 0.3, 0.5, and 0.7).

FIG. 42B depicts normalized Li site fractions and ionic conductivity in Li₆₋ₓPS₅₋ₓCl₁₊ₓ (x=0, 0.3, 0.5, and 0.7).

FIG. 43 depicts a correlation of ionic conductivity with a normalized P integral of NMR resonances as a function of Cl content for an embodiment of a solid electrolyte.

FIG. 44 depicts comparisons of site fractions before/after ⁶Li→⁷Li tracer-exchange for an embodiment of a solid electrolyte; the ⁶Li absolute integrals were normalized based on the integral of Li (48 h) in pristine Li₆PS₅Cl.

FIG. 45 depicts ionic conductivities of embodiments of solid electrolytes.

FIG. 46 depicts the ⁷Li Ti relaxation times of Li₆₋ₓPS₅₋ₓClBrₓ[0≤x≥0.7].

FIG. 47 depicts a summary of chlorine site occupancy among two sites of an embodiment of a solid electrolyte.

FIG. 48A depicts the overall jump rate and conductivity as a function of x in Li₆₋ₓPS₅₋ₓBr₁₊ₓ.

FIG. 48B depicts the fraction of 1S3Br as a function of x in Li₆₋ₓPS₅₋ₓBr₁₊ₓ in comparison with overall jump rate.

FIG. 49 depicts normalized ⁶Li NMR spectral integrals of resonances from Li at 24 g and 48 h sites.

FIG. 50 depicts an embodiment of an electronic device.

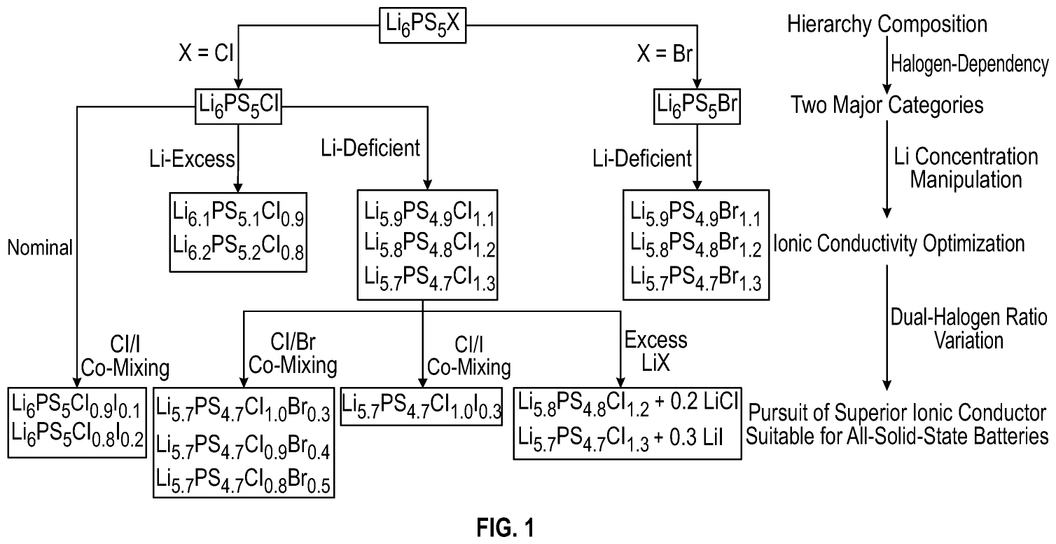

### DETAILED DESCRIPTION

Provided herein are solid electrolytes, methods of producing solid electrolytes, and electronic devices that include solid electrolytes.

### Solid Electrolytes

In some embodiments, the solid electrolytes include a lithium-argyrodite solid electrolyte of formula (I)—

Li₆₋ₐPS₅₋ₐX₁₊ₐ+b LiX (I),

wherein a is about −0.3 to about 0.75, b is 0 to about 0.3, and X is selected from the group consisting of Cl, Br, I, and a combination thereof. In some embodiments, X is (i) Cl, (ii) Br, (iii) I, (iv) ClₘBrₙ, (v) ClₘIₙ, (vi) BrₘIₙ, or (vii) ClₘIₙBrₚ. When b is 0, and X is (iv), (v), or (vi),
then—

m+n=1+a.

When b is 0, and X is (vii), then—

m+n+p=1+a.

In some embodiments, the solid electrolytes include a lithium-argyrodite solid electrolyte of formula (I), wherein a is about 0 to about 0.7. In some embodiments, the solid electrolytes include a lithium-argyrodite solid electrolyte of formula (I), wherein a is about 0.1 to about 0.7.

In some embodiments, the solid electrolytes include a lithium-argyrodite solid electrolyte of formula (I), wherein a is about 0.2 to about 0.7. In some embodiments, the solid electrolytes include a lithium-argyrodite solid electrolyte of formula (I), wherein a is about 0.3 to about 0.7.

In some embodiments, the solid electrolytes include a lithium-argyrodite solid electrolyte of formula (I), wherein a is about 0.4 to about 0.7. In some embodiments, the solid electrolytes include a lithium-argyrodite solid electrolyte of formula (I), wherein a is about 0.5 to about 0.7. In some embodiments, the solid electrolytes include a lithium-argyrodite solid electrolyte of formula (I), wherein a is about 0.6 to about 0.7.

In some embodiments, the solid electrolytes include a lithium-argyrodite solid electrolyte of formula (I), wherein (i) a is about 0 to about 0.7, about 0.1 to about 0.7, about 0.2 to about 0.7, about 0.3 to about 0.7, about 0.4 to about 0.7, about 0.5 to about 0.7, or about 0.6 to about 0.7, and (ii) b is 0.

In some embodiments, the solid electrolytes include a lithium-argyrodite solid electrolyte of formula (I), wherein a is about −0.3 to about 0.3.

In some embodiments, the solid electrolytes include a lithium-argyrodite solid electrolyte of formula (I), wherein (i) a is about 0.7, and (ii) b is 0. In some embodiments, the solid electrolytes include a lithium-argyrodite solid electrolyte of formula (I), wherein (i) a is about 0.7, (ii) b is 0, and (iii) X is a combination of Cl and Br, such as Cl_{1.0}Br_{0.7}. In some embodiments, the solid electrolytes include a lithium-argyrodite solid electrolyte of formula (I), wherein (i) a is about 0.7, (ii) b is 0, and (iii) X is Cl or Br.

In some embodiments, the solid electrolytes include a lithium-argyrodite solid electrolyte of formula (I), wherein (i) a is 0.5, and (ii) b is 0. In some embodiments, the solid electrolytes include a lithium-argyrodite solid electrolyte of formula (I), wherein (i) a is 0.5, (ii) b is 0, and (iii) X is Cl or Br.

In some embodiments, the solid electrolytes include a lithium-argyrodite solid electrolyte of formula (I), wherein (i) a is 0, and (ii) and b is 0. In some embodiments, the solid electrolytes include a lithium-argyrodite solid electrolyte of formula (I), wherein (i) a is 0, (ii) and b is 0, and X is Cl or Br.

In some embodiments, the solid electrolytes include a lithium-argyrodite solid electrolyte of formula (I), wherein X is Cl. In some embodiments, the solid electrolytes include a lithium-argyrodite solid electrolyte of formula (I), wherein (i) X is Cl, (ii) a is −0.1, and (iii) b is 0. In some embodiments, the solid electrolytes include a lithium-argyrodite solid electrolyte of formula (I), wherein (i) X is Cl, (ii) a is −0.2, and (iii) b is 0. In some embodiments, the solid electrolytes include a lithium-argyrodite solid electrolyte of formula (I), wherein (i) X is Cl, (ii) a is 0.1, and (iii) b is 0. In some embodiments, the solid electrolytes include a lithium-argyrodite solid electrolyte of formula (I), wherein (i) X is Cl, (ii) a is 0.2, and (iii) b is 0. In some embodiments, the solid electrolytes include a lithium-argyrodite solid electrolyte of formula (I), wherein (i) X is Cl, (ii) a is 0.3, and (iii) b is 0.

In some embodiments, the solid electrolytes include a lithium-argyrodite solid electrolyte of formula (I), wherein X is Br. In some embodiments, the solid electrolytes include a lithium-argyrodite solid electrolyte of formula (I), wherein (i) X is Br, (ii) a is −0.1, and (iii) b is 0. In some embodiments, the solid electrolytes include a lithium-argyrodite solid electrolyte of formula (I), wherein (i) X is Br, (ii) a is −0.2, and (iii) b is 0. In some embodiments, the solid electrolytes include a lithium-argyrodite solid electrolyte of formula (I), wherein (i) X is Br, (ii) a is 0.1, and (iii) b is 0. In some embodiments, the solid electrolytes include a lithium-argyrodite solid electrolyte of formula (I), wherein (i) X is Br, (ii) a is 0.2, and (iii) b is 0. In some embodiments, the solid electrolytes include a lithium-argyrodite solid electrolyte of formula (I), wherein (i) X is Br, (ii) a is 0.3, and (iii) b is 0.

In some embodiments, the solid electrolytes include a lithium-argyrodite solid electrolyte of formula (I), wherein (i) a is 0, (ii) b is 0, and (iii) X is a combination of Cl and I, such as Cl_{0.9}I_{0.1} or Cl_{0.8}I_{0.2}.

In some embodiments, the solid electrolytes include a lithium-argyrodite solid electrolyte of formula (I), wherein (i) a is 0.3, (ii) b is 0, and (iii) X is a combination of Cl and Br, such as Cl_{1.0}Br_{0.3}, Cl_{0.9}Br_{0.4}, or Cl_{0.8}Br_{0.5}.

In some embodiments, the solid electrolytes include a lithium-argyrodite solid electrolyte of formula (I), wherein (i) a is 0.3, (ii) b is 0, and (iii) X is a combination of Cl and I, such as Cl_{1.0}I_{0.3}. In some embodiments, the solid electrolytes include a lithium-argyrodite solid electrolyte of formula (I), wherein (i) a is 0.3, (ii) b is 0, and (iii) X is a combination of Br and I, such as I_{1.0}Br_{0.3}.

In some embodiments, the solid electrolytes include a lithium-argyrodite solid electrolyte of formula (I), wherein (i) a is 0.2, (ii) b is 0.2, and (iii) X is Cl.

In some embodiments, the solid electrolytes include a lithium-argyrodite solid electrolyte of formula (I), wherein the solid electrolyte has the following formula:

Li_{5.7}PS_{4.7}Cl_{1.3}+0.3 LiI (Ia).

In some embodiments, the solid electrolytes include a lithium-argyrodite solid electrolyte of formula (I), wherein the solid electrolyte has the following formula:

Li₆₋ₐPS₅₋ₐClBrₐ (Ib),

wherein a is 0 to about 0.7, or about 0.3 to about 0.7.

### Electronic Devices

Also provided herein are electronic devices that include a solid electrolyte as described herein.

In some embodiments, the electronic devices include an all-solid-state lithium ion battery. In some embodiments, the electronic device is an all-solid-state lithium ion battery, which includes an anode, and the anode includes a solid electrolyte described herein.

An embodiment of an all-solid-state lithium ion battery is depicted at FIG. 50. The battery 100 includes a cathode 101, and anode 103, and a solid electrolyte 102 as described herein arranged between the cathode 101 and the anode 103. Other configurations are envisioned.

### Methods

Also provided herein are methods of forming a solid electrolyte. In some embodiments, the methods include providing a mixture that includes Li₂S, P₂S₅, and LiX, wherein X is selected from the group consisting of Cl, Br, I, and a combination thereof, and the mixture has a mole ratio of [Li:P:S:X] of [about 5.25 to about 6.3:1:about 4.25 to about 5.3:about 0.7 to about 1.75]; grinding the mixture to form a powder; ball milling the powder to form a milled powder; sintering the milled powder to form a sintered powder; optionally grinding the sintered powder; pressing the sintered powder into a pellet; and sintering the pellet.

In some embodiments, the mole ratio of [Li:P:S:X] is [about 5.3 to about 6.3:1:about 4.3 to about 5.3:about 0.7 to about 1.7]. In some embodiments, the mole ratio of [Li:P:S:X] is [about 5.5 to about 6.3:1:about 4.5 to about 5.3:about 0.7 to about 1.5]. In some embodiments, the mole ratio of [Li:P:S:X] is [about 5.7 to about 6.3:1:about 4.7 to about 5.3:about 0.7 to about 1.3].

In some embodiments, the sintering of the milled powder includes heating the milled powder to a temperature of about 280° C. to about 320° C. for about 8 hours to about 16 hours. In some embodiments, the sintering of the milled powder includes heating the milled powder to a temperature of about 300° C. for about 8 hours to about 16 hours. In some embodiments, a ramping rate of about 1° C. per minute is used to achieve the temperature.

In some embodiments, the pressing of the sintered powder into the pellet includes applying a pressure of about 350 MPa to about 450 MPa to the sintered powder.

In some embodiments, the sintering of the pellet includes heating the pellet to a temperature of about 500° C. to about 600° C. for about 8 hours to about 16 hours.

In some embodiments, the ball milling of the powder includes disposing the powder in a ZrO₂ jar comprising two or more 10-mm ZrO₂ balls.

In some embodiments, the pellet includes about 50 mg of the sintered powder. In some embodiments, the pellet includes about 25 mg to about 75 mg of the sintered powder.

The terms “a,” “an,” and “the” are intended to include plural alternatives, e.g., at least one. For instance, the disclosure of “a solid electrolyte,” and the like, is meant to encompass one, or mixtures or combinations of more than one solid electrolyte, and the like, unless otherwise specified.

In the descriptions provided herein, the terms “includes,” “is,” “containing,” “having,” and “comprises” are used in an open-ended fashion, and thus should be interpreted to mean “including, but not limited to.” When methods or compositions are claimed or described in terms of “comprising” various components or steps, the methods or compositions can also “consist essentially of” or “consist of” the various components or steps, unless stated otherwise.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, numerical end points of ranges disclosed herein are approximate. As a representative example, Applicant discloses, in one embodiment, that a is about 0.2 to about 0.7. This range should be interpreted as encompassing values in a range of about 0.2 and about 0.7, and further encompasses “about” each of 0.3, 0.4, 0.5, and 0.6, including any ranges and sub-ranges between any of these values.

Throughout this application, the term “about” is used to indicate that a value includes a variation of error, such as for the device, the method being employed to determine the value, or the variation that exists among the study subjects. The term “about” is used to imply the natural variation of conditions and represent a variation of plus or minus 5% of a value. In some embodiments, the variation is plus or minus 1% of a value.

The processes described herein may be carried out or performed in any order as desired in various implementations. Additionally, in certain implementations, at least a portion of the processes may be carried out in parallel. Furthermore, in certain implementations, less than or more than the processes described may be performed.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims

The present invention is further illustrated by the following examples, which are not to be construed in any way as imposing limitations upon the scope thereof On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### EXAMPLES

### Example 1—Preparation of Li₆PS₅Cl and Li₆PS₅Br

In this example, a higher ionic conductivity was achieved than the reported values in the relevant literature. It was believed that, in this example, a higher ionic conductivity was achieved, at least in part, by a two-step sintering process.

In this example, Li₂S and P₂S₅ were received without purifications. LiCl and LiBr were vacuum dried at 200° C. for 12 h prior to synthesis. All chemicals were purchased from Sigma-Aldrich.

Li₆PS₅X (X=Cl and Br): Stoichiometric amounts of Li₂S, P₂S₅, and LiCl/LiBr were ground using a motor/pestle in a Li:P:S:Cl ratio of 6:1:5:1 for 10 minutes. After grinding, a uniform light-yellow color of powders was obtained. The pre-ground powders were placed in a ZrO₂ jar and two 10-mm ZrO₂ ball were added as grinding medium.

The ZrO₂ jar was then vacuum sealed for a ball-milling event of 0.5-12 h. After ball-milling, the powders were transferred into a quartz tube and firstly sintered at 300° C. for 12 h (ramping rate of 1° C./min) followed by natural cooling under Ar environment. After sintering, the powders (gray) were then ground again for 10 minutes using a motor/pestle. Typically, ˜50 mg of the pre-sintered powders was pressed into a 6-mm pellet under the pressure of ˜400 MPa. The pelletized powders were then sintered at 550° C. for 12 h (ramping rate of 1° C./min) followed by natural cooling under vacuum.

The resulting pellet after the second sintering had a ˜6.1 mm diameter and ˜1 mm thickness, and the pellet appeared dark gray.

Characterizations: The characteristics of the as-synthesized Li₆PS₅X (X=Cl and Br) were investigated by several techniques including powder X-ray diffraction (PXRD), electrochemical impedance spectroscopy (EIS), solid-state nuclear magnetic resonance (NMR), scanning electron microscopy (SEM), and galvanic cycling.

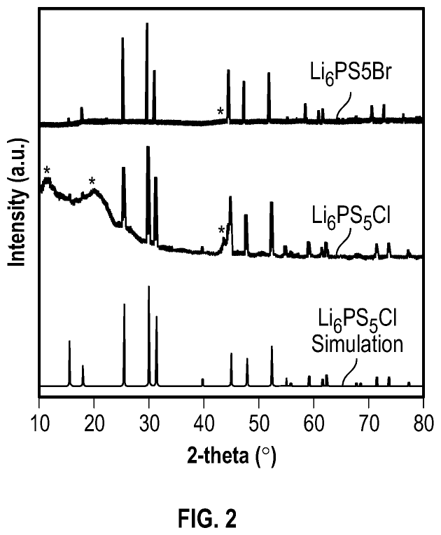

As depicted at FIG. 2, both Li₆PS₅Cl and Li₆PS₅Br formed a single phase (F4̅3m), which was the target phase of Li₆PS₅X (X=Cl, Br, or I), without any observable impurities as compared with the simulated pattern. The well-defined diffraction peaks, i.e., sharp peaks, indicated that Li₆PS₅Cl and Li₆PS₅Br were highly crystalline. A noticeable intensity of background signals detected in Li₆PS₅Cl was due to a shorter acquisition time; however, it did not interfere with the phase identifications.

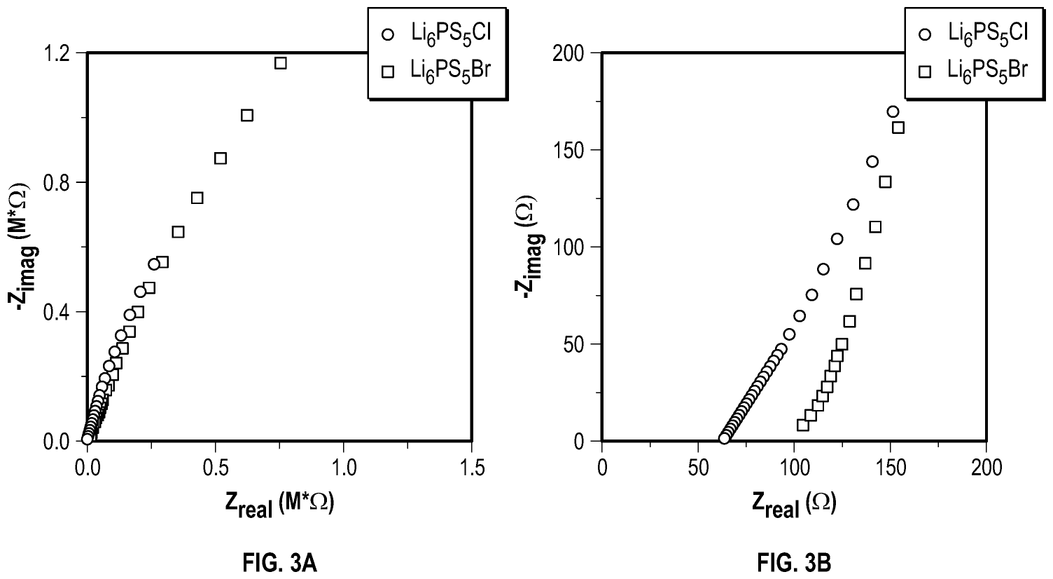

FIG. 3A and FIG. 3B indicate that Li₆PS₅Cl had a higher ionic conductivity than Li₆PS₅Br. The calculated ionic conductivity at 21° C. was, respectively, ˜7 mS/cm for Li₆PS₅Cl and ˜5 mS/cm for Li₆PS₅Br. The obtained ionic conductivities of Li₆PS₅X (X=Cl and Br) were higher than reported values in the literature.

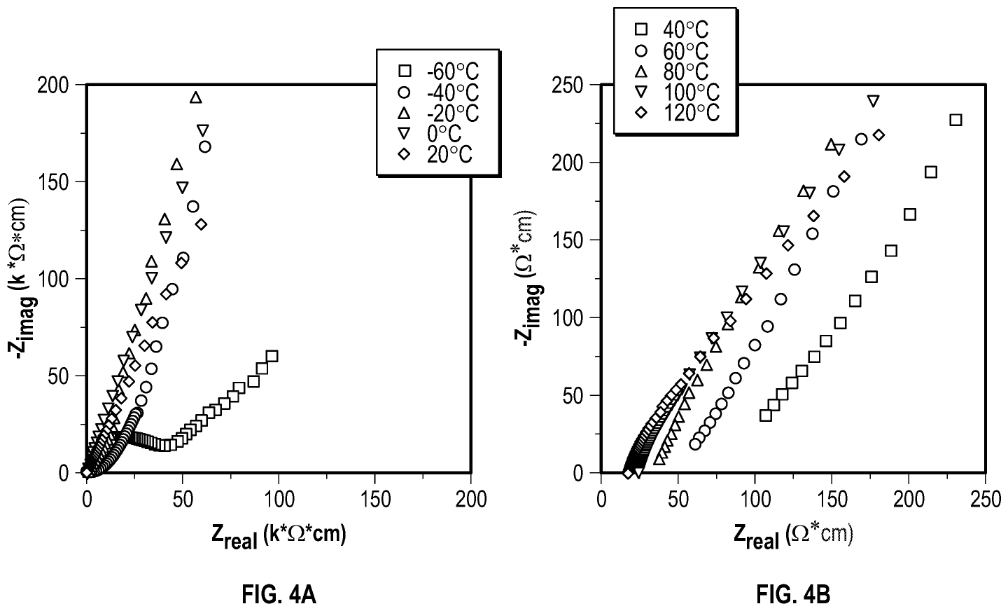

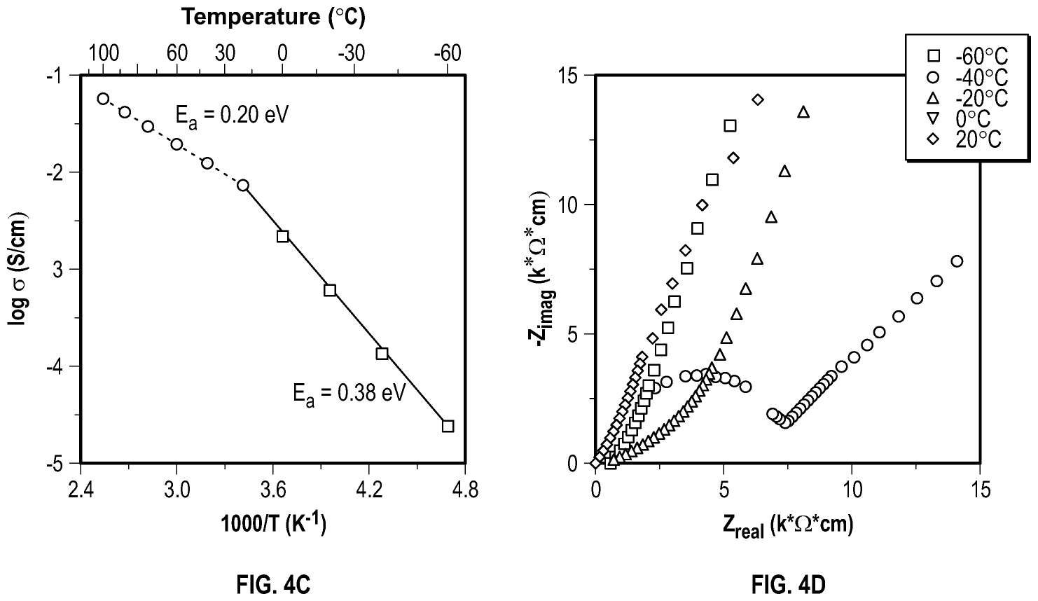

FIG. 4A, FIG. 4B, FIG. 4C, and FIG. 4D summarize the EIS response of Li₆PS₅Cl upon heating. Two well-defined linearities reflective of different conduction mechanisms were observed. The activation energy for each conduction mechanism was 0.38 eV (from −60° C. to 20° C.) and 0.20 eV (from 20 to 120° C.), respectively. Also, phase transition was suspected to be responsible for the change in linearity of conductivity upon heating.

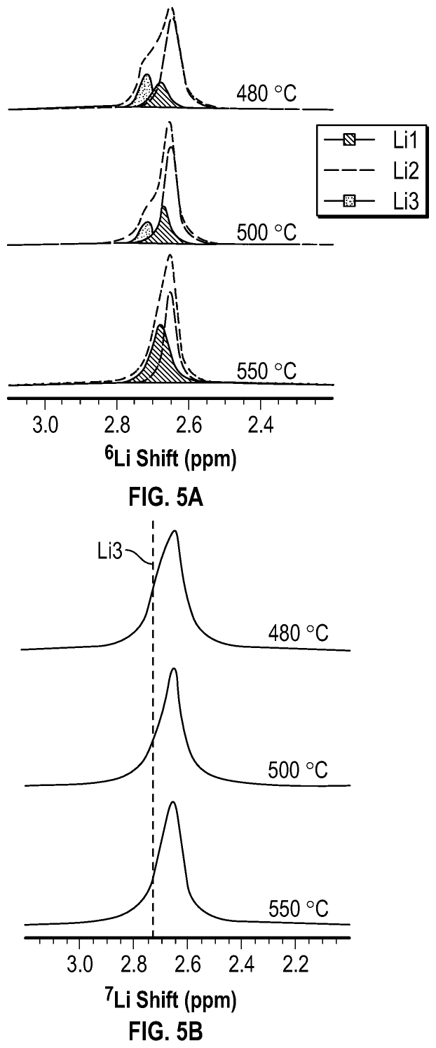

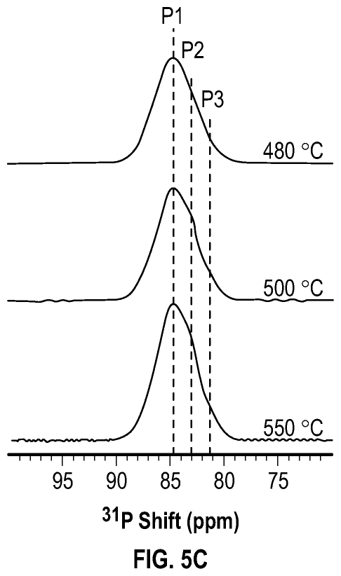

FIG. 5A, FIG. 5B, and FIG. 5C summarize the evolution of Li distribution and P local structures over sintering temperature. ⁶Li spectra (FIG. 5A) clearly showed a gradual decrease of Li3 site towards higher sintering temperature. ⁷Li spectra (FIG. 5B) showed a similar trend of spectral evolution with a compromised resolution; nonetheless, a small shoulder associated with Li3 site turned weaker when higher sintering temperature was employed. ³¹P spectra (FIG. 5C) indicated that the P local environments became more structurally ordered at higher sintering temperatures as a more well-defined line-shape of ³¹P resonances (P1, P2, and P3) were observed. All room-temperature solid-state magic-angel-spinning NMR spectra were acquired under the spinning rate of 25 kHz at the National High Magnetic Field Laboratory.

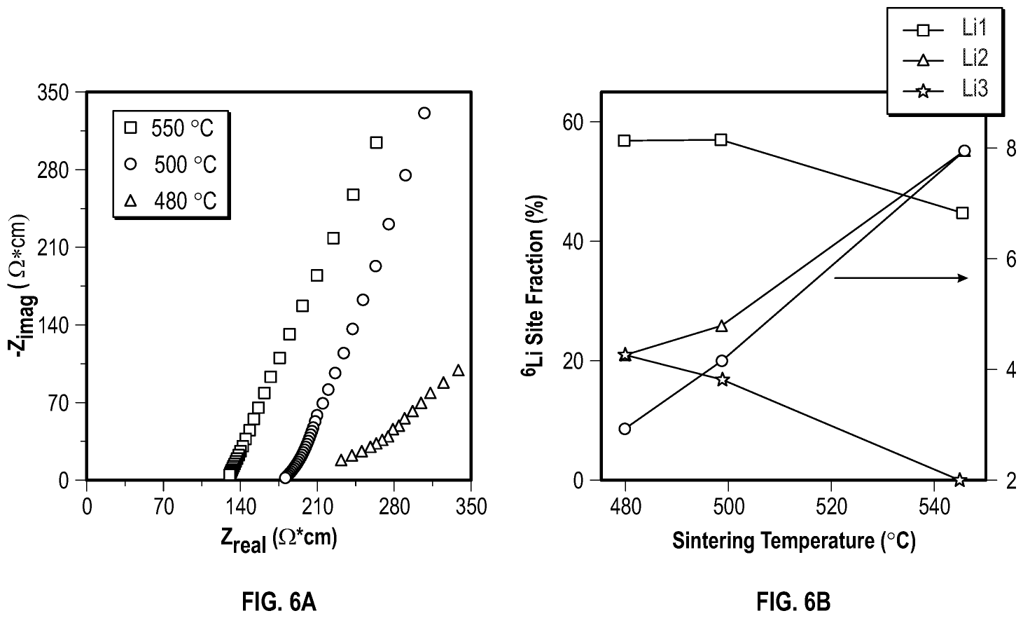

FIG. 6A and FIG. 6B elucidate the connection between higher ionic conductivity and Li distribution in Li₆PS₅Cl. EIS measurements were performed at 21° C. In foils were used as current collectors. FIG. 6A indicates that a higher sintering temperature, i.e., 550° C. for Li₆PS₅Cl in this embodiment, largely helped improve the ionic conductivity from 2.95 mS/cm (480° C.) to 4.17 mS/cm (500° C.), and to 7 mS/cm (550° C.).

FIG. 6B shows that the enhanced ionic conductivity over sintering temperatures were positively correlated with the increased fraction of Li2 site in Li₆PS₅Cl, whereas Li3 site was found to be detrimental to ionic conductivity. The capability of high-resolution solid-state NMR to decipher the functional site and/or phase fractions beneficial to increasing the ionic conductivity was demonstrated.

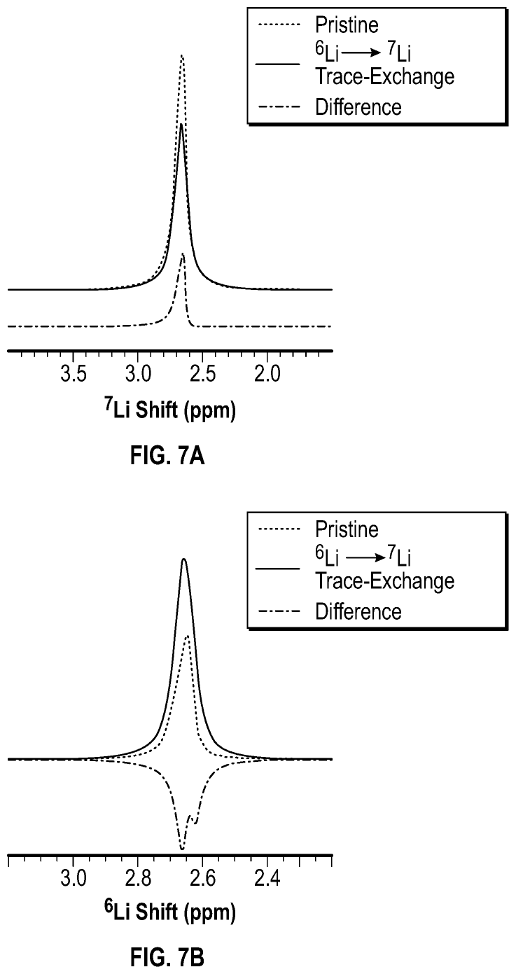

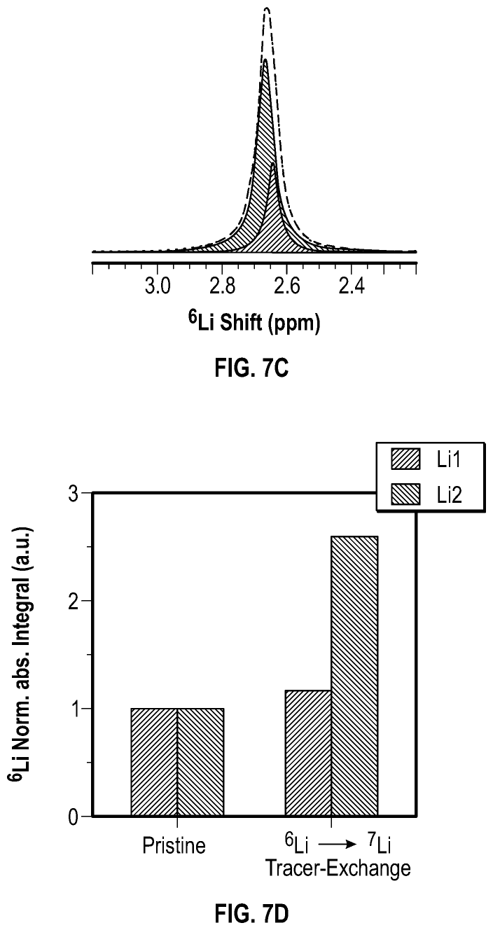

FIG. 7A, FIG. 7B, FIG. 7C, and FIG. 7D depict the identification of a functional site responsible for Li-ion conduction in Li₆PS₅Cl. FIG. 7A and FIG. 7B demonstrate the capability of ⁶Li→⁷Li tracer-exchange in which the concentration of mobile ions, i.e., functional sites, were enriched after ^{6,7}Li isotopes replacement. This method could distinguish the “functional site” from the other relatively “sluggish” one by comparing the change in peak intensity as shown at FIG. 7C. Therefore, the Li2 site played a role in the ion transport pathway of Li₆PS₅Cl. FIG. 7D quantitatively revealed the extent to which site was preferentially enriched.

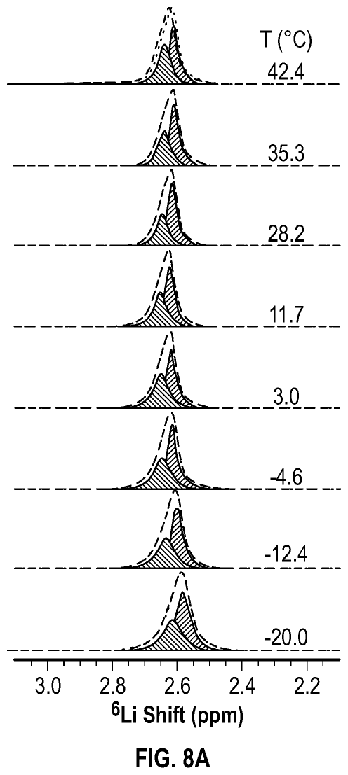

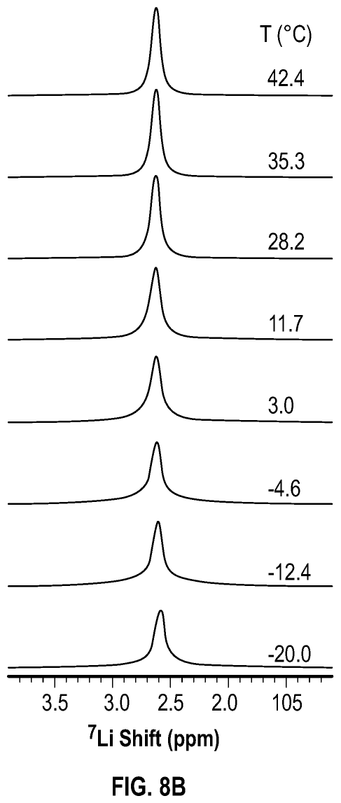

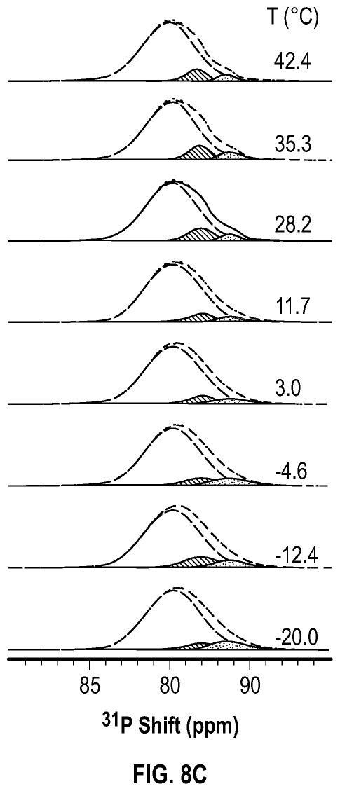

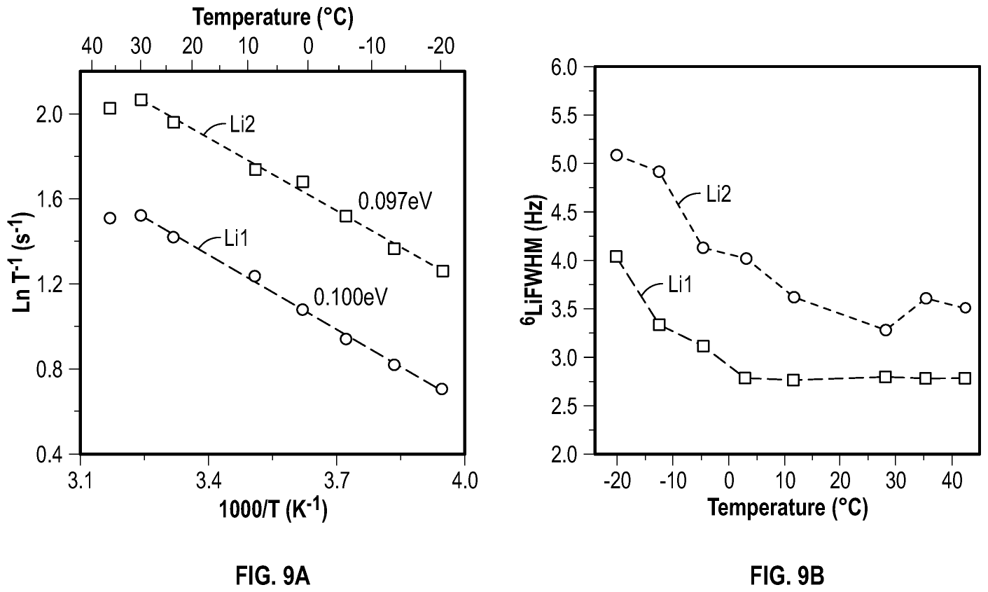

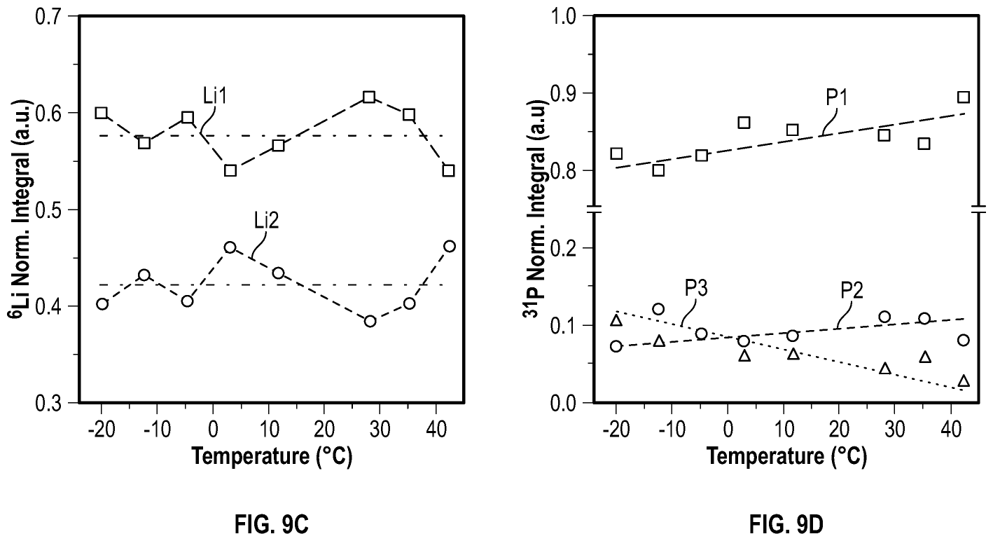

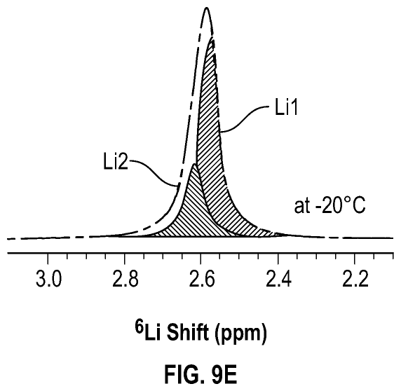

FIG. 8A, FIG. 8B, and FIG. 8C summarize the responses of ion dynamics upon heating from −20° C. using ⁶Li, ⁷Li, and ³¹P NMR. All variable-temperature solid-state magic-angel-spinning NMR spectra were acquired under the spinning rate of 25 kHz at the National High Magnetic Field Laboratory. General information obtained by multi-nuclear NMR included the following: 1) the Li distribution among two sites upon heating/cooling barely changed; 2) the full width at half maximum (FWHM) had little change, indicating that Li₆PS₅Cl possessed high ion motions even at low temperatures; 3) the effect of heating/cooling on P local structure was subtle, although a relatively broadened FWHM of P resonances was seen. (Detailed analysis results are depicted at FIG. 9A, FIG. 9B, FIG. 9C, FIG. 9D, and FIG. 9E.)

FIG. 9A, FIG. 9B, FIG. 9C, FIG. 9D, and FIG. 9E depict a summary of variable-temperature ion dynamics of Li₆PS₅Cl. FIG. 9A and FIG. 9E present similar activation energies of two Li sites; however, the local motion of Li2 site was slightly faster than that of Lil and this agreed well with data presented in FIG. 7A-7D. FIG. 9B hints that the extremely fast ion motion regime may have been achieved at low temperatures. FIG. 9C indicates no obvious change of Li distribution (Li1:Li2=55:45) among two sites over temperatures was seen. FIG. 9D shows a slight increase in P1 and P2 sites at the expense of P3 site. The change in ³¹P site fractions may be reasoned that a conversion between disordered and ordered P environments occurred during a heat-treatment.

SEM images were collected of the surface and the cross-section of Li₆PS₅Cl. The images included various artifacts, such as pores, streaks, and irregular stacking texture. The images revealed that some empty voids or disconnected grains existed within Li₆PS₅Cl after sintering at 550° C. for 12 hours. These results suggested that a higher conductivity can be possibly achieved when, for example, hot-press is applied to the process of pellet making. In other words, boundary-less pellets, which may be ideal for the application of all-solid-state lithium-ion batteries, can be obtained.

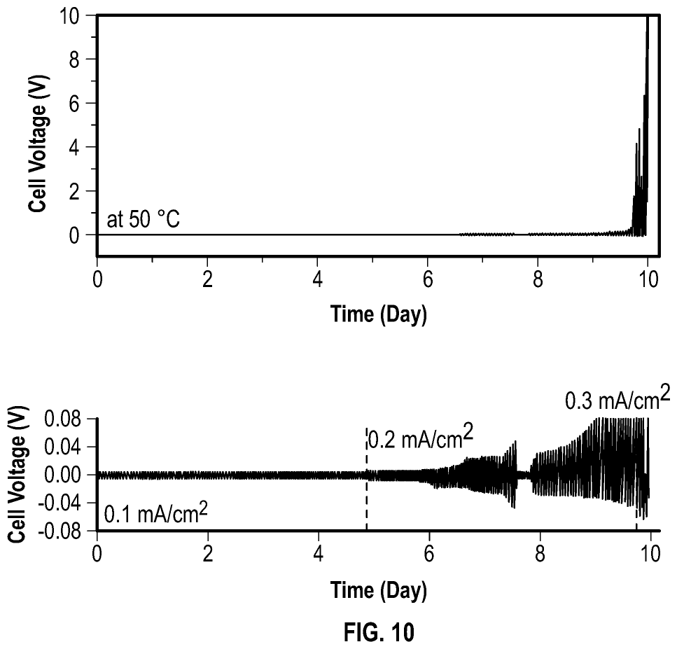

FIG. 10 shows that L₆PS₅Cl was inherently unstable against metallic Li especially at higher current density. The boost of cell voltage witnessed near the end of test indicated a rapid growth of side products between Li—Li₆PS₅Cl interfaces, which caused a high reading of interfacial resistance. Each cycle consisted of 30 minutes charge and 30 minutes discharge. Li foils were used as current collectors.

### Example 2—Synthesis and Characterization of Li_{6.1}PS_{5.1}Cl_{0.9}, Li_{6.2}PS_{5.2}Cl_{0.8}, Li_{6.3}PS_{5.3}Cl_{0.7}, Li_{5.9}PS_{4.9}Cl_{1.1}, Li_{5.8}PS_{4.8}CL_{1.2}, and Li_{5.7}PS_{4.7}Cl_{1.3}, Li_{5.9}PS_{4.9}Br_{1.1}, Li_{5.8}PS_{4.8}Br_{1.2}, and Li_{5.7}PS_{4.7}Br_{1.3} (Lithium Concentration Manipulation)

In this example, Li-deficient and Li-excess materials were developed and, most importantly, a higher ionic conductivity was achieved than the pristine Li₆PS₅X (X=Cl and Br) reported in this document. It was believed that the higher ionic conductivity was achieved in this example, at least in part, by controlling the Li concentration/distribution by varying the doping level of halogens.

Li₂S, P₂S₅, LiCl, and LiBr were received without purifications. LiCl and LiBr were vacuum dried at 200° C. for 12 h prior to synthesis. All chemicals were purchased from Sigma-Aldrich.

Typically, the synthesis steps were the same as described for Li₆PS₅X (X=Cl and Br) unless otherwise stated. Changes regarding the stoichiometric ratio and sintering temperature are given below according to each formula:

Li_{6.1}PS_{5.1}Cl_{0.9}: Stoichiometric amounts of Li₂S, P₂S₅, and LiCl were ground using a motor/pestle in a Li:P:S:Cl ratio of 6.1:1:5.1:0.9 for 10 minutes. Second sintering temperature was 550° C./12 h.

Li_{6.21}PS_{5.2}Cl_{0.8}: Stoichiometric amounts of Li₂S, P₂S₅, and LiCl were ground using a motor/pestle in a Li:P:S:Cl ratio of 6.2:1:5.2:0.8 for 10 minutes. Second sintering temperature was 550° C./12 h.

Li_{6.3}PS_{5.3}Cl_{0.7}: Stoichiometric amounts of Li₂S, P₂S₅, and LiCl were ground using a motor/pestle in a Li:P:S:Cl ratio of 6.3:1:5.3:0.7 for 10 minutes. Second sintering temperature was 550° C./12 h.

Li_{5.9}PS_{4.9}Cl_{1.1}: Stoichiometric amounts of Li₂S, P₂S₅, and LiCl were ground using a motor/pestle in a Li:P:S:Cl ratio of 5.9:1:4.9:1.1 for 10 minutes. Second sintering temperature was 540° C./12 h.

Li_{5.81}PS4.8Cl_{1.2}: Stoichiometric amounts of Li₂S, P₂S₅, and LiCl were ground using a motor/pestle in a Li:P:S:Cl ratio of 5.8:1:4.8:1.2 for 10 minutes. Second sintering temperature was 530° C./12 h.

Li_{5.7}PS_{4.7}Cl_{1.3}: Stoichiometric amounts of Li₂S, P₂S₅, and LiCl were ground using a motor/pestle in a Li:P:S:Cl ratio of 5.7:1:4.7:1.3 for 10 minutes. Second sintering temperature was 520° C./12 h.

Li_{5.9}PS_{4.9}Br_{1.1}: Stoichiometric amounts of Li₂S, P₂S₅, and LiBr were ground using a motor/pestle in a Li:P:S:Cl ratio of 5.9:1:4.9:1.1 for 10 minutes. Second sintering temperature was 540° C./12 h.

Li_{5.81}PS_{4.8}Br_{1.2}: Stoichiometric amounts of Li₂S, P₂S₅, and LiBr were ground using a motor/pestle in a Li:P:S:Cl ratio of 5.8:1:4.8:1.2 for 10 minutes. Second sintering temperature was 530° C./12 h.

Li_{5.7}PS_{4.7}Br_{1.3}: Stoichiometric amounts of Li₂S, P₂S₅, and LiBr were ground using a motor/pestle in a Li:P:S:Cl ratio of 5.7:1:4.7:1.3 for 10 minutes. Second sintering temperature was 520° C./12 h.

The resulting pellet after the second sintering had a ˜6.1 mm diameter and ˜1 mm thickness, and the pellet appeared dark gray.

Characterizations: The characteristics of the as-synthesized Li₆₋ₐPS₅₋ₐX₁₊ₐ (X=Cl, Br; −0.3≤a≤0.3, a≠0) were investigated by several techniques, including powder X-ray diffraction (PXRD), electrochemical impedance spectroscopy (EIS), solid-state nuclear magnetic resonance (NMR), and galvanic cycling.

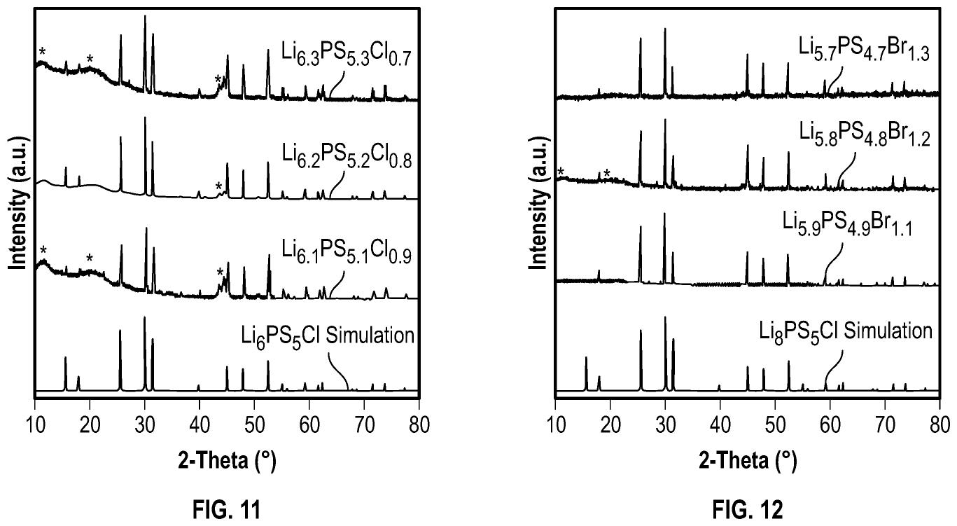

FIG. 11 shows that Li₆₋ₐPS₅₋ₐX₁₊ₐ (X=Cl; a=−0.2 and −0.1) formed a single phase (F4̅3m), which was the target phase of Li₆PS₅X (X=Cl, Br, or I), without any observable impurities as compared with the simulated pattern. A very minor amount of Li₂S (denoted in “o” symbol) was seen in Li_{6.3}PS_{5.3}Cl_{0.7}, implying that excess Li₂S was segregated as a secondary phase.

FIG. 12 shows that Li₆₋ₐPS₅₋ₐX₁₊ₐ (X=Br; a=0.1, 0.2, and 0.3) formed a single phase (F4̅3m), which was the target phase of Li₆PS₅X (X=Cl, Br, or I), without any observable impurities as compared with the simulated pattern. Excess LiBr was successfully dissolved in the structure and it was expected to create Li vacancies to further improve the ionic conductivity.

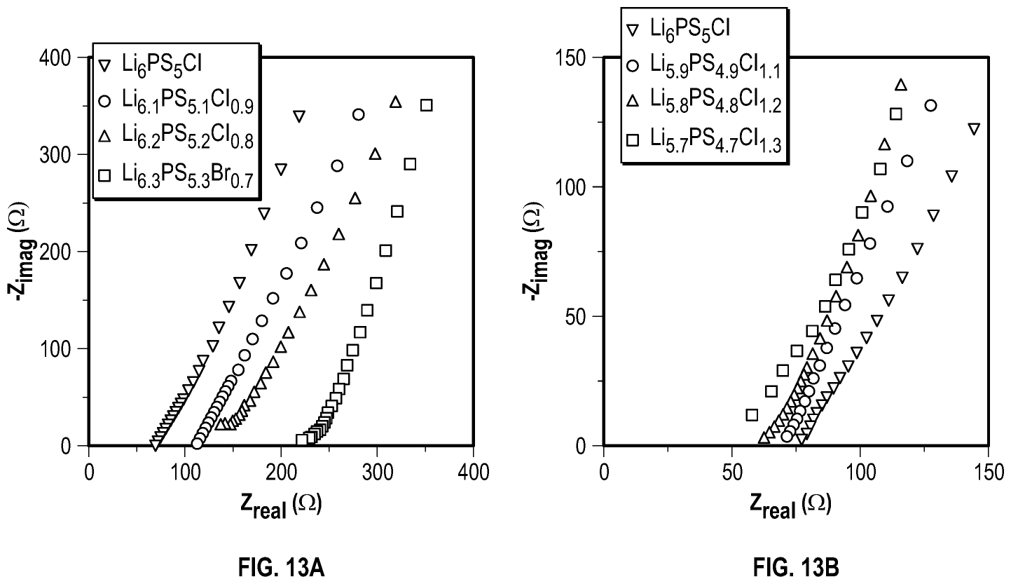

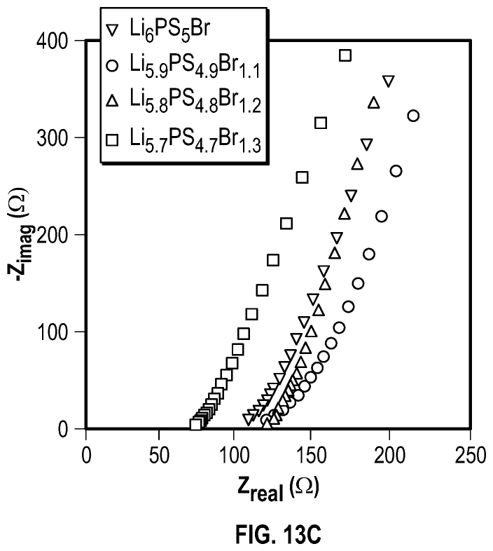

FIG. 13A, FIG. 13B, and FIG. 13C summarize the effect of singular Cl/Br doping level on the ionic conductivity in Li₆PS₅X (X=Cl and Br). EIS of pristine Li₆PS₅X (X=Cl and Br) was given for reference. Measurements were performed at 21° C. In foils were used as current collectors. Li-excess argyrodites presented negative outcomes, whereas Li-deficient one showed promising results. The calculated ionic conductivity at 21° C. was, respectively, ˜5 mS/cm for Li_{5.9}PS_{4.9}Br_{1.1}, ˜5 mS/cm for Li_{5.8}PS_{4.8}Br_{1.2}, ˜6.9 mS/cm for Li_{5.7}PS_{4.7}Br_{1.3}, ˜7.3 mS/cm for Li_{5.9}PS_{4.9}Cl_{1.1}, ˜7.8 mS/cm for Li_{5.8}PS_{4.8}Cl_{1.2}, and ˜8.5 mS/cm for Li_{5.7}PS_{4.7}Cl_{1.3}.

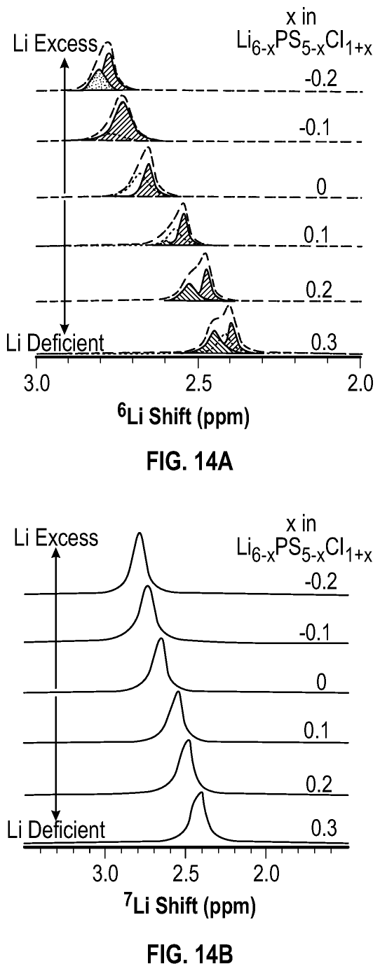

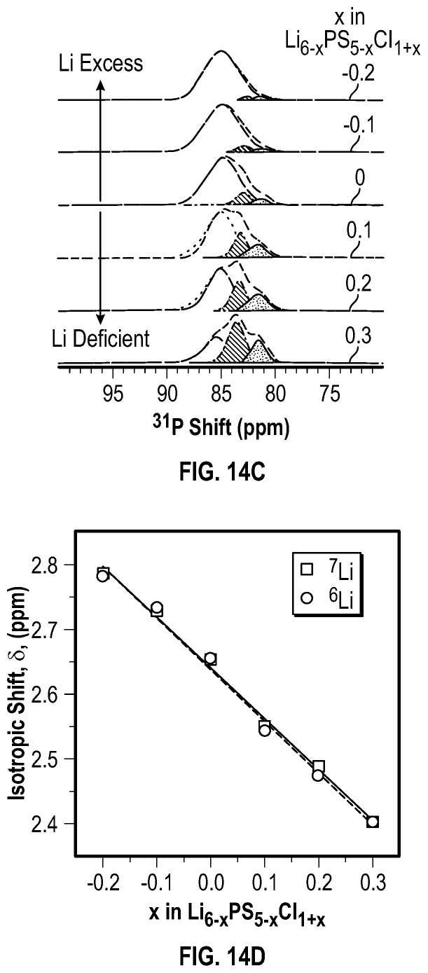

FIG. 14A, FIG. 14B, FIG. 14C, and FIG. 14D depict the effect of singular Cl doping level on the local structure in Li₆₋ₓPS₅₋ₓCl₁₊ₓ (−0.3≤x≤0.3, x≠0). All room-temperature solid-state magic-angel-spinning NMR spectra were acquired under the spinning rate of 25 kHz at the National High Magnetic Field Laboratory.

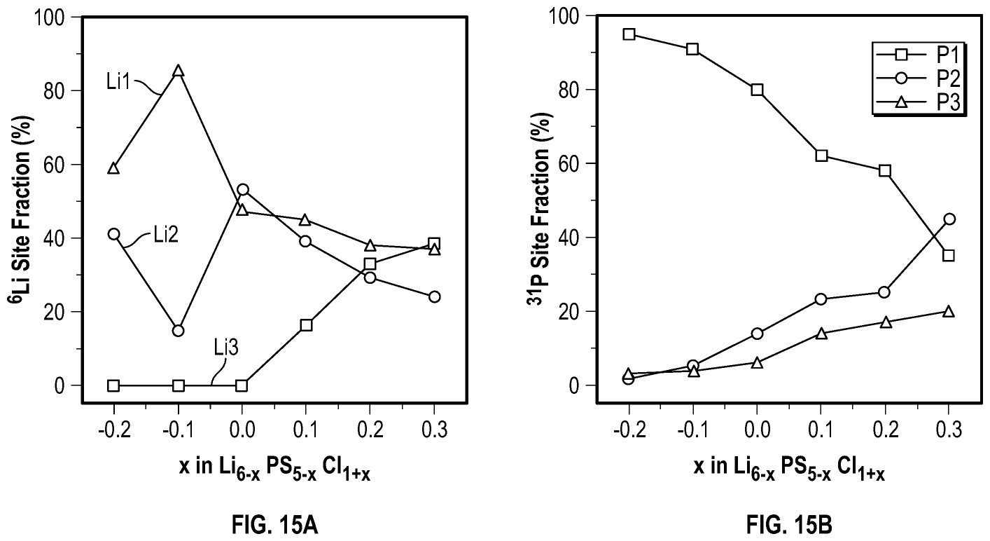

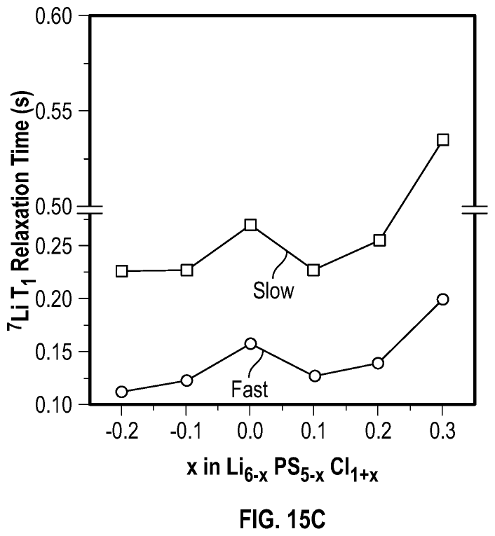

FIG. 14A, FIG. 14B, FIG. 14C, and FIG. 14D show how singular Cl doping level influenced the Li distribution and local structures in Li₆₋ₐPS₅₋ₐCl₁₊ₐ (−0.3≤a≤0.3, a≠0). Useful information was extracted: 1) ^{6,7}Li isotropic chemical shifts linearly depended on the concentration of Cl; 2) With the increase of Cl doping level, a new Li site, presented in green peak in ⁶Li NMR spectra, grew over the evolution from Li-excess to Li-deficient phase as shown at FIG. 14A and FIG. 14B. On the other hand, the amount of Lil (purple) site gradually dropped; 3) ³¹P NMR observed the gradual growth of P2 (green) and P3 (brown) sites at the cost of P1 (purple) site without noticeable shifting of ³¹P resonances. (Detailed analysis results are given at FIG. 15.)

FIGS. 15A-15C present a detailed analysis of the ⁶Li, ⁷Li, and ³¹P NMR spectra shown at FIG. 14. FIG. 15A, FIG. 15B, and FIG. 15C depict a summary of the dependency of Cl doping level upon Li₆₋ₓPS₅₋ₓCl₁₊ₓ (−0.3≤x≤0.3, x≠0) investigated by ⁶Li, ⁷Li, and ³¹P NMR. FIG. 15A shows the variation of three Li sites, in which a new site, Li_{3,} emerged in Li-deficient phase, upon the change in Cl doping level. The increase of Li₃ site likely contributed to enhancing the ionic conductivity. FIG. 15B implies that P1 site gradually converted to P2 and P3 sites during Cl-enrichment, i.e., Li-depletion. The change in the ratio between three P sites might also explain ionic conductivity, at least in part, because the local structures of P were inevitably affected by the replacement of S by Cl. FIG. 15C shows the behavior of ion dynamics upon the change in Cl doping level. Fast ion motions resulted in short T₁ relaxation time, which largely correlated itself with higher ionic conductivity. The slower T₁ relaxation response in Li-deficient phases in both fast and slow Li reservoirs may not have corresponded to lower ionic conductivity because it may have involved ion motions associated with defects.

### Example 3—Synthesis and Characterization of Li_{5.7}PS_{4.7}Cl_{1.0}Br_{0.3}, Li_{5.7}PS_{4.7}Cl_{0.9}Br_{0.4}, and Li_{5.7}PS_{4.7}Cl_{0.8}Br_{0.5} (Dual Halogen Ratio Variations)

Based on the improvement in ionic conductivity of Li-deficient Li_{5.7}PS_{4.7}Cl_{1.3} phase, a strategy was developed, in this example, to finely adjust the Li distribution by incorporating a second halogen, e.g., Br, and altering the ratio between Cl and Br. The highest ionic conductivity achieved by Li_{5.7}PS_{4.7}Cl_{1.0}Br_{0.3} was ˜10 mS/cm at 21° C., which proved the effectiveness of the strategy. The higher ionic conductivity was believed to be achieved by the micro-adjustments of C//Br ratio.

Li₂S, P₂S₅, LiCl, and LiBr were received without purifications. LiCl and LiBr were vacuum dried at 200° C. for 12 h prior to synthesis. All chemicals were purchased from Sigma-Aldrich.

Typically, the synthesis steps were the same as described in Li₆PS₅X (X =Cl and Br) unless otherwise stated. Changes regarding the stoichiometric ratio and sintering temperature are given below according to each formula:

Li_{5.7}PS_{4.7}Cl_{1.0}Br_{0.3}: Stoichiometric amounts of Li₂S, P₂S₅, LiCl, and LiBr were ground using agate motor/pestle in a Li:P:S:Cl : Br ratio of 5.7:1:4.7:1.0:0.3 for 10 minutes. Second sintering temperature was 500° C./12 h.

Li_{5.7}PS_{4.7}Cl_{0.9}Br_{0.4}: Stoichiometric amounts of Li₂S, P₂S₅, LiCl, and LiBr were ground using agate motor/pestle in a Li:P:S:Cl : Br ratio of 5.7:1:4.7:0.9:0.4 for 10 minutes. Second sintering temperature was 500° C./12 h. Li_{5.7}PS_{4.7}Cl_{0.8}Br_{0.5}: Stoichiometric amounts of Li₂S, P₂S₅, LiCl, and LiBr were ground using agate motor/pestle in a Li:P:S:Cl : Br ratio of 5.7:1:4.7:0.8:0.5 for 10 minutes. Second sintering temperature was 500° C./12 h.

The resulted pellet after second sintering had a dimension of ˜6.1 mm in diameter and ˜1 mm in thickness and the pellet appeared dark gray.

Characterizations: The characteristics of the as-synthesized Li_{5.7}PS_{4.7}ClₐBr_{b} (a+b=1.3; a≤1.0) were preliminarily investigated by electrochemical impedance spectroscopy (EIS).

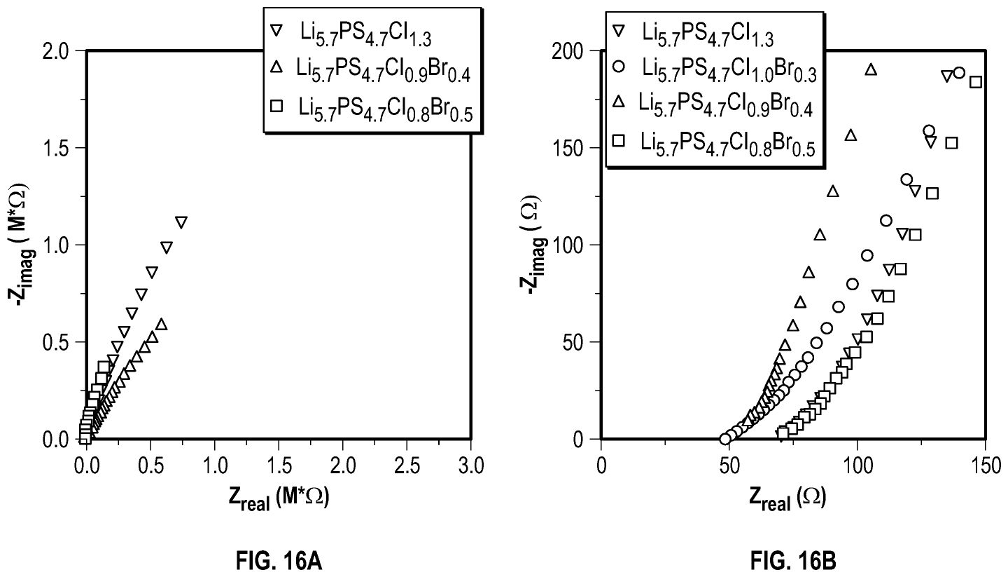

FIG. 16A and FIG. 16B show that the incorporation of second halogen, e.g., Br, helped improve the ionic conductivity as compared to its pristine Li-deficient Li_{5.7}PS_{4.7}Cl_{1.3} phase. The calculated ionic conductivity at 21° C. was, respectively, ˜10.3 mS/cm for Li_{5.7}PS_{4.7}Cl₁Br_{0.3} and ˜9 mS/cm for Li_{5.7}PS_{4.7}Cl_{0.9}Br_{0.4}, and ˜7.1 mS/cm for Li_{5.7}PS_{4.7}Cl_{0.8}Br_{0.5}. EIS of pristine Li_{5.7}PS_{4.7}Cl_{1.3} was given for reference. Measurements were performed at 21° C. In foils were used as current collectors.

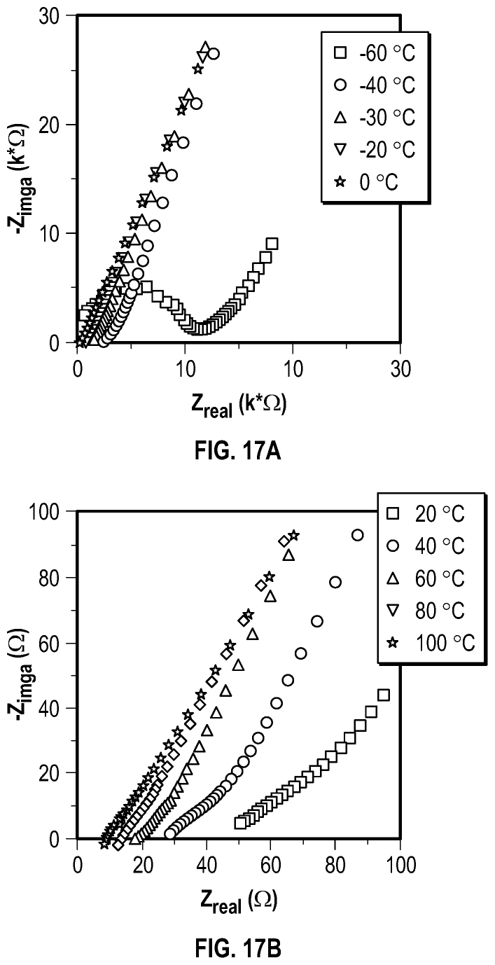

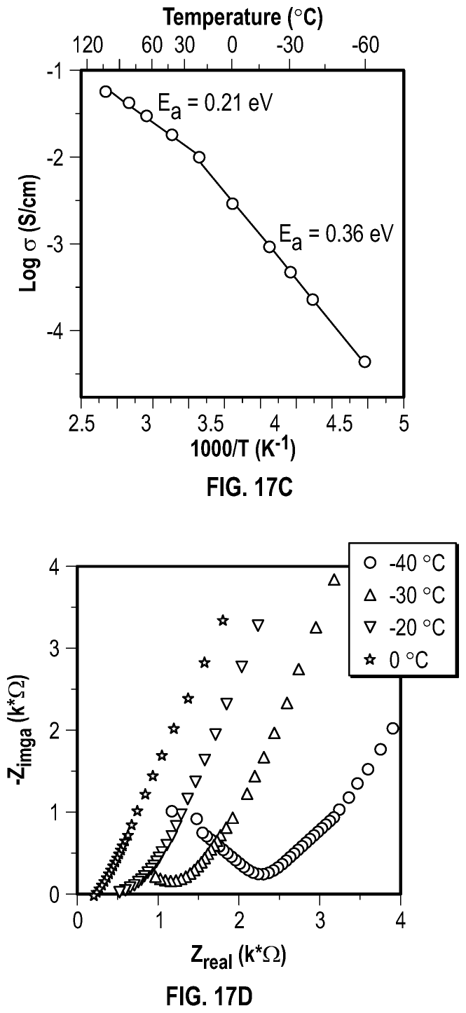

FIG. 17A, FIG. 17B, FIG. 17C, and FIG. 17D summarize the EIS response of Li_{5.7}PS_{4.7}Cl_{1.0}Br_{0.3} upon heating. Two well-defined linearities reflective of different conduction mechanisms were observed. The activation energy for each conduction mechanism was 0.36 eV (from −60° C. to 20° C.) and 0.21 eV (from 20 to 100° C.), respectively. Also, phase transition was suspected to be responsible for the change in linearity of conductivity upon heating. In foils were used as current collectors.

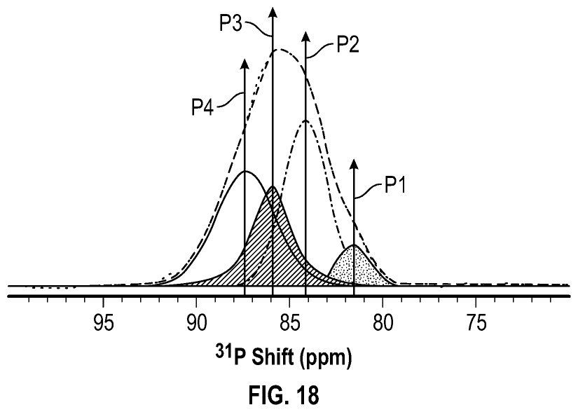

FIG. 18 presents a ³¹P NMR spectrum of Li_{5.7}PS_{4.7}Cl₁Br_{0.3} acquired at the spinning rate of 25 kHz. Tentative ³¹P resonances assignments are given in the simulated results. Distinctive difference between Li₆PS₅Cl and Li_{5.7}PS_{4.7}Cl_{1.3} (FIG. 14c) ³¹P NMR spectra can be directly observed in line-shape. A newly formed ³¹P resonance (P4) induced by Cl/Br co-mixing is detected in Li_{5.7}PS_{4.7}Cl₁Br_{0.3}.This implies that the enhanced ionic conductivity could be further correlated with the more structurally disordered ³¹P local environments, which facilitates Li-ion conductions

### Example 4—Synthesis and Characterization of Li_{5.7}PS_{4.7}Cl_{1.0}I_{0.3} (Dual Halogen Ratio Variations)

Inspired by the structural engineering of Li-deficient phase, Li_{5.7}PS_{4.7}Cl_{1.0}Br_{0.3}, Li_{5.7}PS_{4.7}Cl_{1.0}I_{0.3} was synthesized in an attempt to enhance the chemical stability against metallic Li while maintaining the decent ionic conductivity. The achieved ionic conductivity of Li_{5.7}PS_{4.7}Cl_{1.0}I_{0.3} was 4.2 mS/cm at 21° C. Introducing one or more functions (ionic conductivity and stability) was believed to occur due to the combination and/or ratio of lithium halides.

Li₂S, P₂S₅, LiCl, and LiI were received without purifications. LiCl and LiI were vacuum dried at 200° C. for 12 h prior to synthesis. All chemicals were purchased from Sigma-Aldrich.

Typically, the synthesis steps were the same as described in Li₆PS₅X (X=Cl and Br) unless otherwise stated. Changes regarding the stoichiometric ratio and sintering temperature are given below according to each formula:

Li_{5.7}PS_{4.7}Cl_{1.0}I_{0.3}: Stoichiometric amounts of Li₂S, P₂S₅, LiCl, and LiI were ground using agate motor/pestle in a Li:P:S:Cl:I ratio of 5.7:1:4.7:1.0:0.3 for 10 minutes. Second sintering temperature was 500° C./12 h.

The resulting pellet after second sintering had a dimension of ˜6.1 mm in diameter and ˜1 mm in thickness and the pellet appeared light gray.

The characteristics of the as-synthesized Li_{5.7}PS_{4.7}Cl_{1.0}I_{0.3} was preliminarily investigated by electrochemical impedance spectroscopy (EIS).

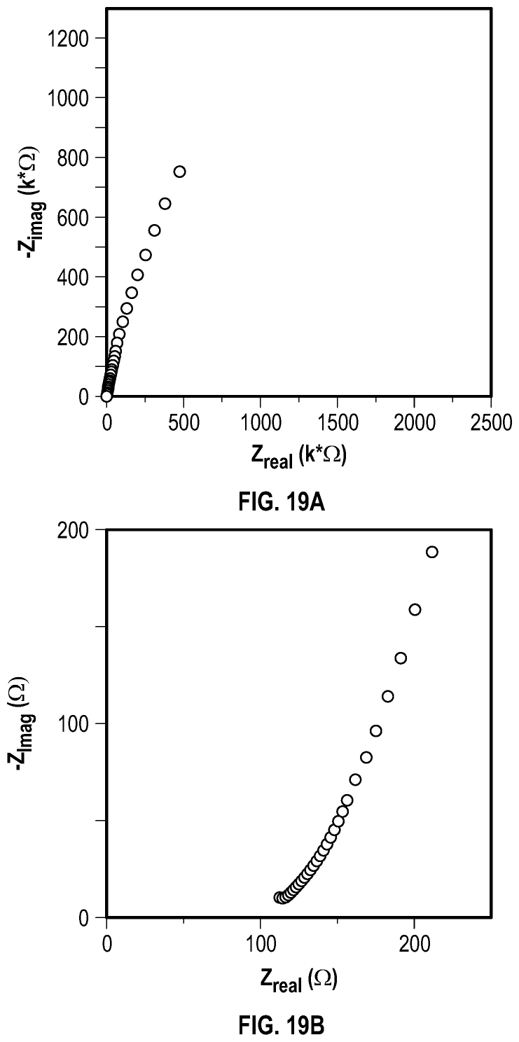

FIG. 19A and FIG. 19B show that Li_{5.7}PS_{4.7}Cl_{1.0}I_{0.3} had an acceptable ionic conductivity of ˜4.2 mS/cm at 21° C. Measurements were performed at 21° C. In foils were used as current collectors. The decreased ionic conductivity could be correlated with the larger ionic radius of I⁻. This prevented the mixing of S²⁻/I⁻ and thus rendered more locally ordered PS₄³⁻ units, which slowed down the ion conductions. However, higher I⁻ content was aimed to help improve the chemical stability against metallic Li.

### Example 5—Synthesis and Characterization of Li_{5.8}PS_{4.8}Cl_{1.2}+0.2LiCl and Li_{5.7}PS_{4.7}Cl_{1.3}+0.3 LiI (Dual Halogen Ratio Variations)

Materials synthesized by this strategy were to bring more Li content back to fill the vacancies and, most importantly, to finely tune the chemical stability against metallic Li. The pre-created vacancies in Li-deficient argyrodites afforded the flexibility of choosing lithium halide to meet the needs. The achieved ionic conductivity of Li_{5.8}PS_{4.8}Cl_{1.2}+0.2 LiCl and Li_{5.7}PS_{4.7}Cl_{1.3}+0.3 LiI was, respectively, 11 mS/cm and 3.4 mS/cm at 21° C. Introducing one or more functions (ionic conductivity and stability) was believed to be possible due at least to the combination and/or ratio of lithium halides.

Li₂S, P₂S₅, and LiI were received without purifications. LiCl was vacuum dried at 200° C. for 12 h prior to synthesis. All chemicals were purchased from Sigma-Aldrich.

Typically, the synthesis steps were the same as described in Li₆PS₅X (X=Cl and Br) unless otherwise stated. Changes regarding the stoichiometric ratio and sintering temperature are given below according to each formula:

Li_{5.7}PS_{4.7}Cl_{1.3}+0.3 LiI: Stoichiometric amounts of Li₂S, P₂S₅, LiCl, and LiI were ground using agate motor/pestle in a Li:P:S:Cl:I ratio of 5.7:1:4.7:1.3:0.3 for 10 minutes. Second sintering temperature was 500° C./12 h.

The resulting pellet after second sintering had a dimension of ˜6.1 mm in diameter and ˜1 mm in thickness and the pellet appeared light gray.

Li_{5.8}PS_{4.8}Cl_{1.2}+0.2 LiCl: Stoichiometric amounts of Li₂S, P₂S₅, and LiCl were ground using agate motor/pestle in a Li:P:S:Cl ratio of 5.8:1:4.8:1.4 for 10 minutes. Second sintering temperature was 520° C./12 h.

The resulting pellet after second sintering had a dimension of ˜6.1 mm in diameter and ˜1 mm in thickness and the pellet appeared dark gray.

Characterizations: The characteristics of the as-synthesized Li_{5.8}PS_{4.8}Cl_{1.2}+0.2 LiCl and Li_{5.7}PS_{4.7}Cl_{1.3}+0.3 LiI was preliminarily investigated by electrochemical impedance spectroscopy (EIS) and galvanic cycling.

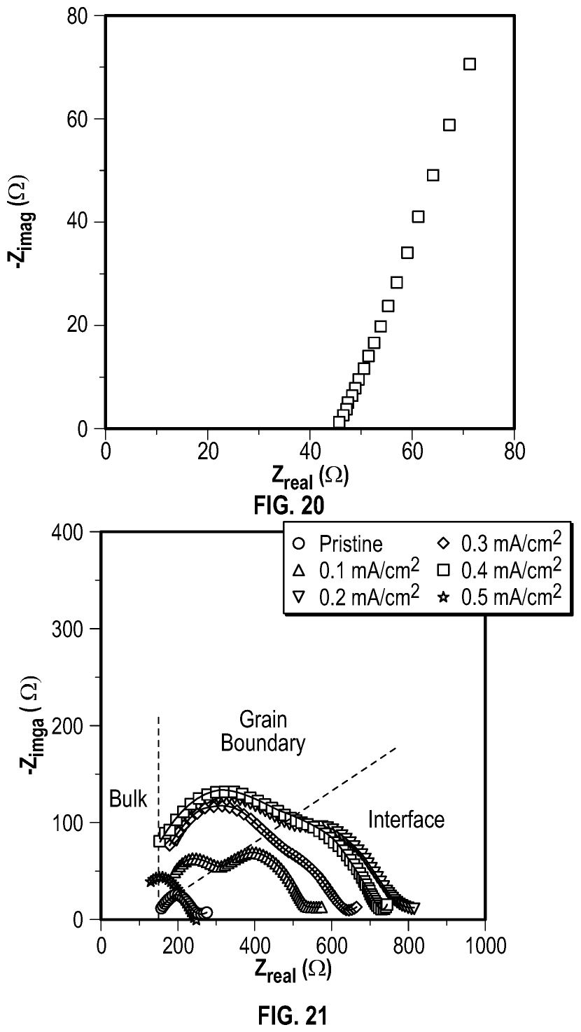

FIG. 20 shows that Li_{5.8}PS_{4.8}Cl_{1.2}+0.2 LiCl had an extraordinary ionic conductivity of 11 mS/cm at 21° C. This result confirmed the effectiveness of this “back-filling” strategy to further enhance the ionic conductivity. The extra Li brought by the addition of 0.2 mole of LiCl contributed to this improvement as compared to the pristine Li_{5.81}PS_{4.8}Cl_{1.2}. Note that Li_{5.8}PS_{4.8}Cl_{1.2}+0.2 LiCl, i.e. Li₆PS_{4.6}Cl_{1.4} was not a Li-excess argyrodite. This strategy may open another door for the optimization of ionic conductivity of thiophosphate solid electrolytes. EIS of pristine Li_{5.8}PS_{4.8}Cl_{1.2} is shown at FIG. 13B. Measurements were performed at 21° C. In foils were used as current collectors.

TABLE 1
Summary of impedance alysis of Li_{5.7}PS_{4.7}Cl_{1.3} + 0.3 LiI upon galvanic cycling.

| Current | | | | | | |
|---|---|---|---|---|---|---|
| density | R_{g} | C_{g} | R_{gb} | C_{gb} | Rᵢₙₜ | Cᵢₙₜ |
| (mA/cm²) | (ohm) | (F) | (Ohm) | (F) | (Ohm) | (F) |
| 0^{b} | 121 | 2.7 × 10⁻¹² | N/A | N/A | 76 | 1.0 × 10⁻⁶ |
| 0.1 | 121 | 4.9 × 10⁻¹¹ | 125 | 8.0 × 10⁻⁹ | 206 | 1.5 × 10⁻⁶ |
| 0.2 | 147 | 3.7 × 10⁻¹¹ | 236 | 3.7 × 10⁻⁹ | 351 | 2.4 × 10⁻⁶ |
| 0.3 | 128 | 0.7 × 10⁻¹² | 196 | 4.0 × 10⁻⁹ | 298 | 5.3 × 10⁻⁶ |
| 0.4 | 120 | 3.3 × 10⁻¹¹ | 227 | 8.9 × 10⁻⁹ | 377 | 2.8 × 10⁻⁶ |
| 0.5 | 84 | 0.5 × 10⁻¹² | 120 | 0.4 × 10⁻⁹ | 45 | 0.6 × 10⁻⁶ |

^{a}g = grain; gb = grain boundary; int = interface.
^{b}pristine sample.

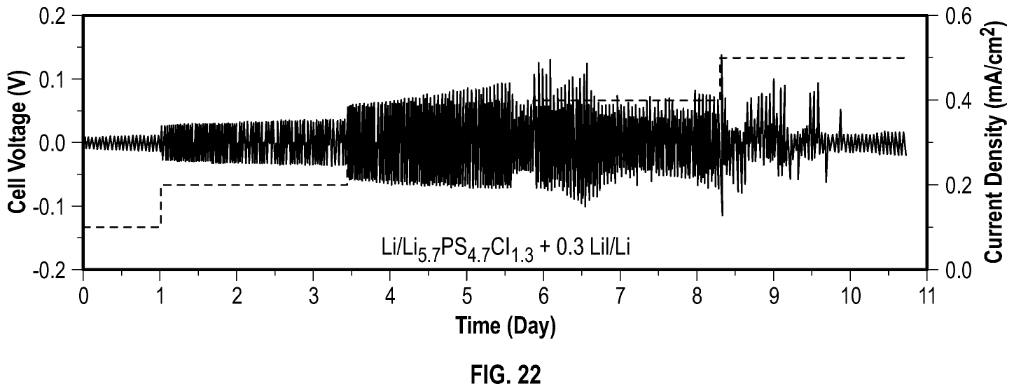

FIG. 21 and Table 1 summarize the stability of Li_{5.7}PS_{4.7}Cl_{1.3}+0.3 LiI against metallic Li. Galvanic cycling (FIG. 22) had triggered a serious degradation between Li-electrolyte interfaces. EIS of pristine Li_{5.7}PS_{4.7}Cl_{1.3} is shown at FIG. 13B. Measurements were performed at 21° C. after polarization at different current densities. Li foils were used as current collectors.

Also, suspected contributions from grain boundary after cycling were detected as revealed by the fitting of EIS results using equivalent circuit, R_{bulk}(R_{grain-boundary}Q_{grain-boundary})(R_{interface}Q_{interface})Q_{electrode} (Table 1.). Extracted capacitances validated the assignments. The suddenly dropped resistances may have been attributed to the formation of Li microstructures.

FIG. 22 shows that Li_{5.7}PS_{4.7}Cl_{1.3}+0.3 LiI had a better chemical stability against metallic Li as compared to pristine Li₆PS₅Cl (FIG. 11). Li_{5.7}PS_{4.7}Cl_{1.3}+0.3 LiI was polarized by biased potential at 0.1 mA/cm², 0.2 mA/cm², 0.3 mA/cm², 0.4 mA/cm², and 0.5 mA/cm² at 50° C. Each cycle consists of 30 minutes charge and 30 minutes discharge. Li foils were used as current collectors. Lower polarization (lower cell voltage readings) was obtained. However, the formation of Li dendritic structures may have been responsible for the failure of steady cycling at higher current density.

### Example 6—Synthesis and Characterization of Li₆PS₅ClₐI_{b} (a+b=1; a<1) (Dual Halogen Ratio Variations)

The strategy “Dual halogen ratio variations” could also be applied to nominal Li₆PS₅Cl, in which I was incorporated into the structure as an active component to improve the stability. The design of this material was to reference the level of stability with Li_{5.7}PS_{4.7}Cl_{1.3}+0.3 LiI. The achieved ionic conductivity of Li₆PS₅Cl_{0.9}I_{0.1} and Li₆PS₅Cl_{0.8}I_{0.2}, respectively, of 3.5 and 2.9 mS/cm at 21° C. Controlling the Li concentration/distribution by varying the doping level of halogens was believed to cause one or more of these features. Li₂S, P₂S₅, LiCl, and LiI were received without purifications. LiCl and LiI were vacuum dried at 200° C. for 12 h prior to synthesis. All chemicals were purchased from Sigma-Aldrich.

Typically, the synthesis steps were the same as described in Li₆PS₅X (X=Cl and Br) unless otherwise stated. Changes regarding the stoichiometric ratio and sintering temperature are given below according to each formula:

Li₆PS₅Cl_{0.9}I_{0.1}: Stoichiometric amounts of Li₂S, P₂S₅, LiCl, and LiI were ground using agate motor/pestle in a Li:P:S:Cl:I ratio of 6:1:5:0.9:0.1 for 10 minutes. Second sintering temperature was 500° C./12 h.

The resulting pellet after second sintering had a dimension of ˜6.1 mm in diameter and ˜1 mm in thickness and the pellet appeared light gray.

Li₆PS₅Cl_{0.8}I_{0.2}: Stoichiometric amounts of Li₂S, P₂S₅, LiCl, and LiI were ground using agate motor/pestle in a Li:P:S:Cl:I ratio of 6:1:5:0.8:0.2 for 10 minutes. Second sintering temperature was 500° C./12 h.

The resulting pellet after second sintering had a dimension of ˜6.1 mm in diameter and ˜1 mm in thickness and the pellet appeared dark gray.

Characterizations: The characteristics of the as-synthesized Li₆PS₅ClₐI_{b} (a+b=1; a<1) were preliminarily investigated by electrochemical impedance spectroscopy (EIS) and galvanic cycling.

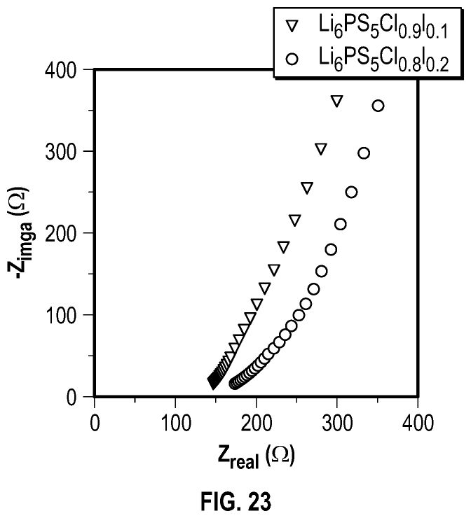

FIG. 23 shows that the ionic conductivity of Li₆PS₅Cl_{0.9}I_{0.1} and Li₆PS₅Cl_{0.8}I_{0.2} decreased. This may have been due to the fact that the mixing of S²⁻/I⁻ was prohibited due to the undesired ionic radius of I. Therefore, disordered S²⁻/I⁻ in PS₄³⁻ units may not have existed to promote ion conduction. As a result, higher I content in this composition may have deteriorated the ionic conductivity. Measurements were performed at 21° C. EIS of pristine Li₆PS₅Cl is shown at FIG. 2. In foils were used as current collectors.

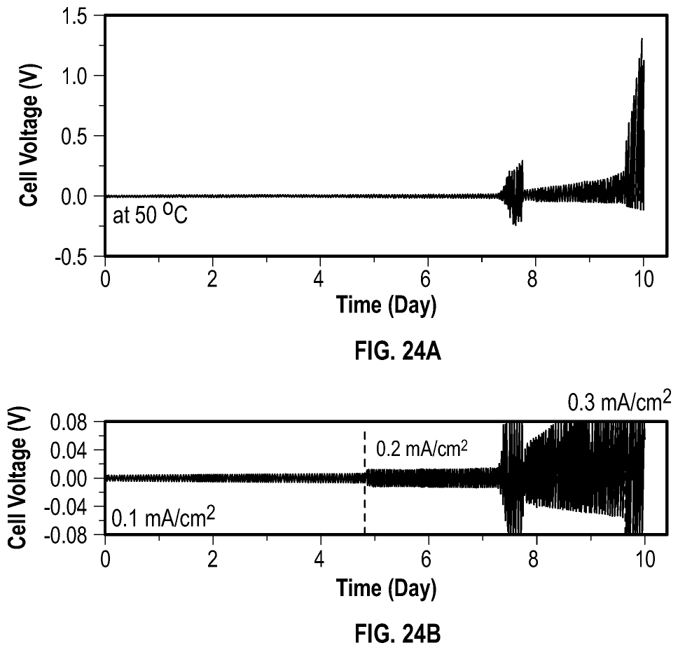

FIG. 24A and FIG. 24B show that Li₆PS₅Cl_{0.9}I_{0.1} did not present a good stability against metallic Li as compared with the case shown in FIG. 22. Li₆PS₅Cl_{0.9}I_{0.1} was polarized by biased potential at 0.1 mA/cm², 0.2 mA/cm², and 0.3 mA/cm² at 50° C. Each cycle consists of 30 minutes charge and 30 minutes discharge. Li foils were used as current collectors.

The dramatic increase in cell voltage readings occurred when the side reactions happened in Li-electrolyte interfaces. The inherent instability was not clear so far. However, a general phenomenon was that higher LiI content in Li-deficient argyrodite may help with this serious issue.

### Example 7—Syntheses of Li₆₊ₓP₂S₈Iₓ (Wherein x is 0-2) Glass-Ceramic Solid Electrolyte

In this example, Li₆₊ₓx₂S₈Iₓ (x=0, 0.75, 1, 2) was prepared. A higher ionic conductivity was achieved in this example than reported values in the literature. The higher ionic conductivity was believed to be achieved due, at least in part, to the high energy ball milling process and the low-temperature heat treatment to maximize the conductive glass phase.

Li₂S and P₂S₅ were purchased from Sigma-Aldrich and LiI was purchased from Alfa Aesar. All the chemicals were used without further purification.

Li₆₊ₓP₂S₈Iₓ (x=0, 0.75, 1, 2): Stoichiometric amounts of Li₂S, P₂S₅, and LiI were ground using agate motor/pestle in a Li:P:S:I ratio of 6+x:2:8:x for 10 minutes. After grinding, a uniform light-yellow color of powders was obtained. The pre-ground powders were placed in a ZrO₂ jar and two 10-mm ZrO₂ ball were added as grinding medium. The ZrO₂ jar was then vacuum sealed for a ball-milling of 5 h (SPEX 8000M). After ball-milling, the powders were ground again for 10 minutes using agate motor/pestle and pressed into a 6-mm pellet under the pressure of ˜400 MPa. Typically, the amount of samples were around 50 mg and the thickness of pellet was around 1 mm. The pelletized powders were then sintered at 230° C. for 2 h (ramping rate of 1° C./min) followed by natural cooling under Ar.

The resulting pellet after second sintering had a dimension of ˜6 mm in diameter and ˜1 mm in thickness and the pellet appeared light gray.

Characterizations: The characteristics of the as-synthesized Li₆₊ₓP₂S₈Iₓ (x=0, 0.75, 1, 2) were investigated by several techniques including: powder X-ray diffraction (PXRD), electrochemical impedance spectroscopy (EIS), solid-state nuclear magnetic resonance (NMR), and galvanic cycling.

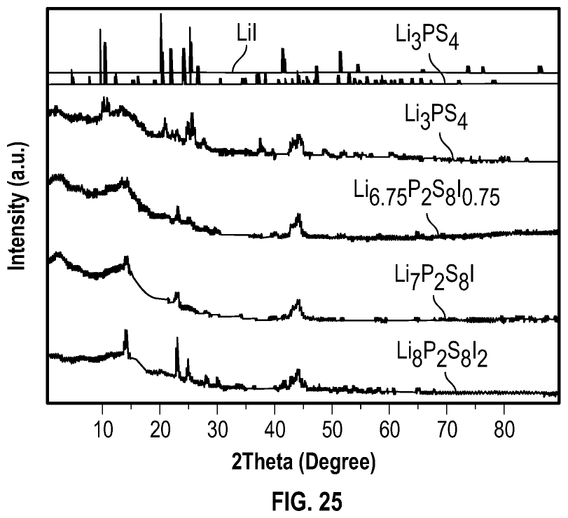

FIG. 25 shows weak peaks for all the patterns, which meant there was low crystallinity of these samples and a glassy phase existed. Besides the glassy phase, there were three crystal phases existing for these samples, Li₃PS₄, Li₇P₂S₈I and LiI. Each sample contained one or two kinds of these crystal phases, like Li₃PS₄ in Li₃PS₄, Li₃PS₄ and Li₇P₂S₈I in Li_{6.75}P₂S₈I_{0.75}, Li₇P₂S₈I in Li₇P₂S₈I and Li₇P₂S₈I and LiI in Li₈P₂S₈I₂. Also, based on mass conservation, the composition of glassy phase in each sample should be different and close to the composition of the raw materials.

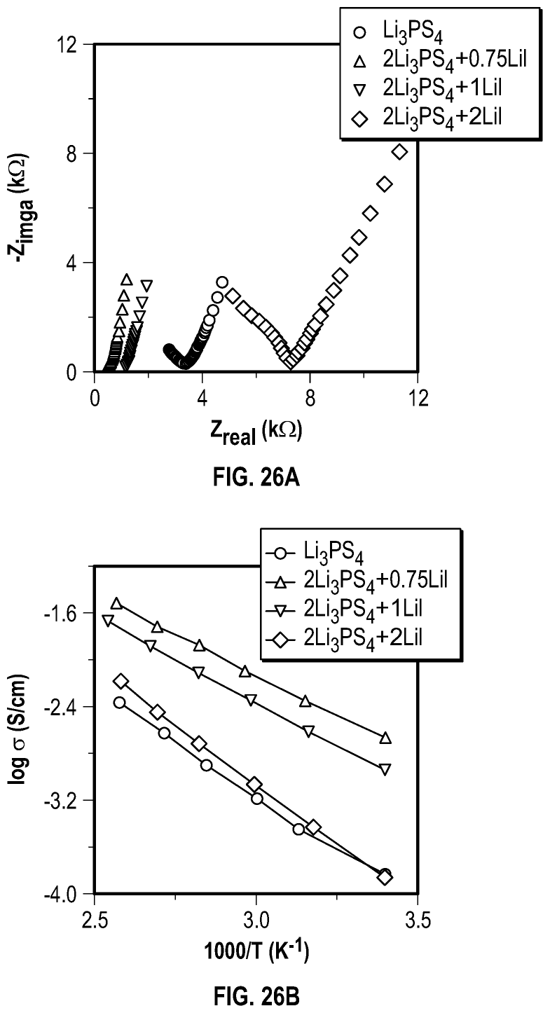

FIG. 26A, FIG. 26B, and FIG. 26C depict the different impedances of different samples at 21° C. When x=0 or 2, Li₃PS₄ and Li₈P₂S₈I₂ showed higher resistance, which meant that these two samples were not good ionic conductors, with low ionic conductivity. When x was between 1 and 0, the conductivity was much higher, over 1 mS/cm. In addition, when x was between 1 and 0, the activation energy was lower (0.3 eV for Li₇P₂S₈I and 0.27 eV for Li_{6.75}P₂S₈I_{0.75}).

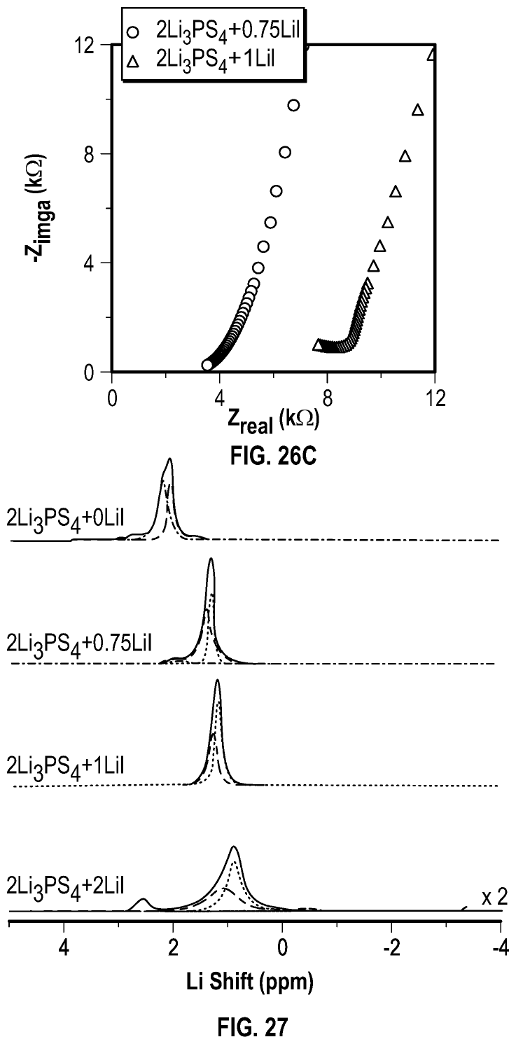

FIG. 27 depicts a summary of ⁶Li NMR results for Li₆₊ₓP₂S₈Iₓ (x=0, 0.75, 1, and 2). In pristine Li₃PS₄, two components with similar distribution of local structural environments are labeled separately for reference. After incorporation of LiI, the glass and ceramic phase is labeled with pink and green line, respectively.

The ⁶Li NMR of these samples with LiI was much different from those without LiI. For Li₃PS₄, both ⁶Li peaks were from different Li₃PS₄ phases, one was the crystal and the other one was glass. For different samples, the ratio between different Li sites were different, which affected the ionic conductivity. The pink Li site should be the conductive site, thus Li_{6.75}P₂S₈I_{0.75} with more pink Li showed the highest conductivity.

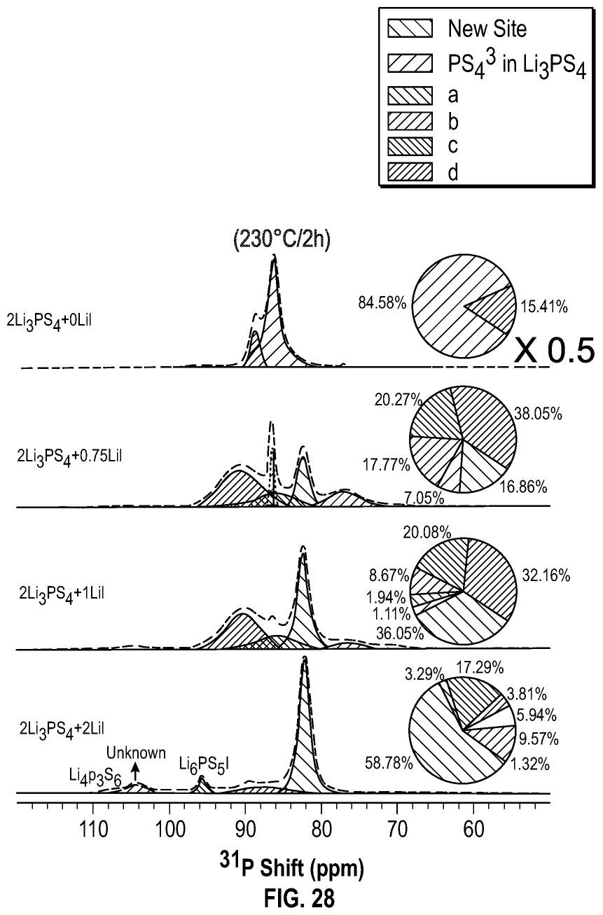

FIG. 28 depicts a summary of ³¹P NMR result of Li₆₊ₓP₂S₈Iₓ (x=0, 0.75, 1, and 2). π charts are shown for quantity information on each simulated ³¹P components.

Comparing with the conductivity and ³¹P NMR, it seemed the blue broad peak, which was from the glassy phase had a positive correlation with the conductivity. With more glassy phases, the conductivity increased. Combining the ⁶Li and ³¹P NMR together revealed that the glassy phase was responsible to the Li-ion conduction.

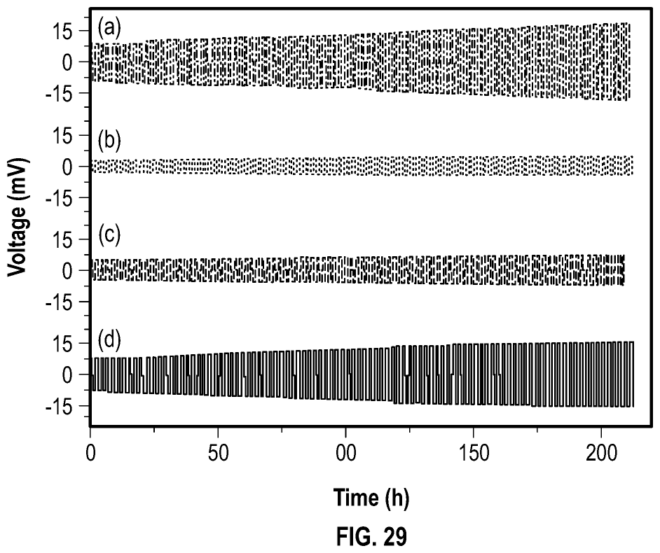

FIG. 29 depicts cycle performances of embodiments of samples with Li/SE/Li symmetric cells: (a) Li₃PS₄, (b) Li_{6.75}P₂S₈I_{0.75}, (c) Li₇P₂S₈I, (d) Li₈P₂S₈I₂.

The samples with LiI showed better stability against Li metal, which changed less after several cycles. But more LiI was not good for achieving higher conductivity, in this example.

### Example 9—Preparation of Li₆₊ₓP₂S₈Iₓ (x=⅔)

A higher ionic conductivity was achieved with longer ball milling time. Achieving higher ionic conductivity in this example was believed to be due to the high energy ball milling process, followed by low-temperature heat treatment to maximize the conductive glass phase.

Li₂S and P₂S₅ were purchased from Sigma-Aldrich and LiI was purchased from Alfa Aesar. All the chemicals were used without further purification.

Li₆₊ₓP₂S₈Iₓ (x=2/3): Stoichiometric amounts of Li₂S, P₂S₅, and LiI were ground using agate motor/pestle in a Li:P:S:I ratio of 6+x:2:8:x (x=⅔) for 10 minutes. After grinding, a uniform light-yellow color of powders was obtained. The pre-ground powders were placed in a ZrO₂ jar and two 10-mm ZrO₂ ball were added as grinding medium. The ZrO₂ jar was then vacuum sealed for a ball-milling of 10 h (SPEX 8000M). After ball-milling, the powders were ground again for 10 minutes using agate motor/pestle and pressed into a 6-mm pellet under the pressure of ˜400 MPa. Typically, the amount of samples were around 50 mg and the thickness of pellet was around 1 mm. The pelletized powders were then sintered at 230° C. for 0.5 h, 1 h or 2 h (ramping rate of 1° C./min) followed by natural cooling under Ar.

The resulting pellet after second sintering had a dimension of ˜6 mm in diameter and 1 mm in thickness and the pellet appeared light gray.

Characterizations: The characteristics of the as-synthesized Li₆₊ₓP₂S₈Iₓ (x=⅔) were investigated by several techniques including: powder X-ray diffraction (PXRD), electrochemical impedance spectroscopy (EIS), scanning electron microscopy (SEM), solid-state nuclear magnetic resonance (NMR), and galvanic cycling.

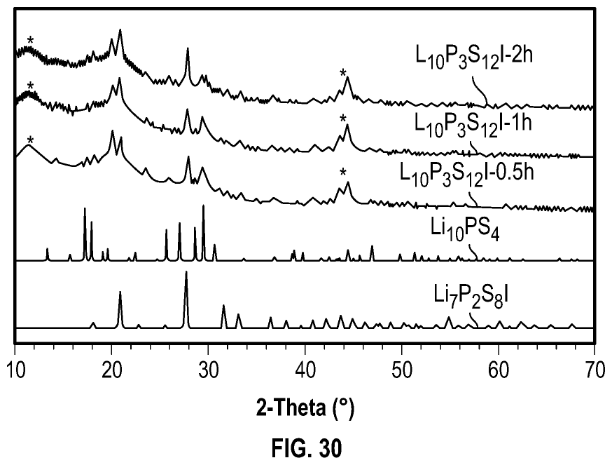

FIG. 30 depicts powder X-ray diffraction patterns of Li_{20/3}P₂S₈I_{2/3} sintered at 230° C. for different periods.

The main crystal phases for Li_{20/3}P₂S₈I_{2/3} samples were Li₃PS₄ and Li₇P2S8I. When sintering time changed, the intensity of different phases changed, which affected the conductivity.

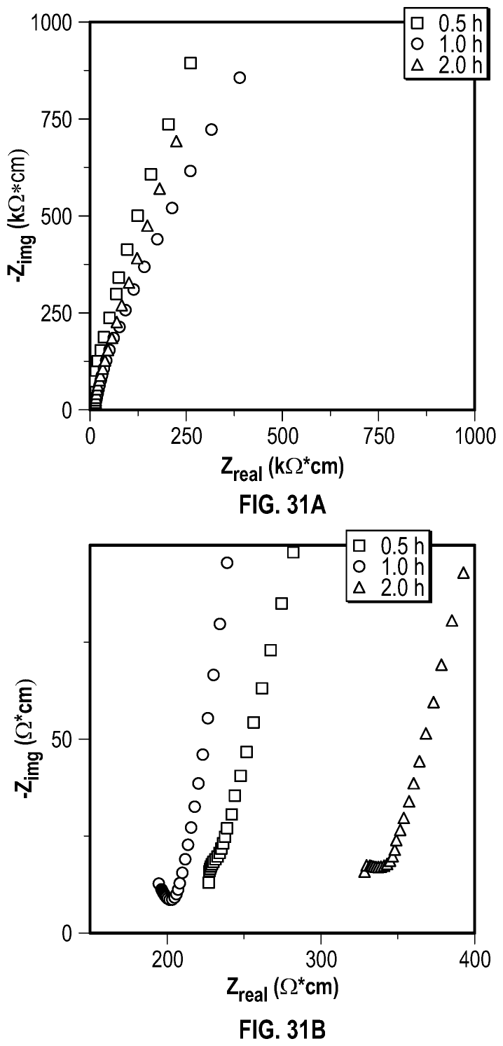

FIG. 31A and FIG. 31B depict Ac impedance of Li_{20/3}P₂S₈I_{2/3} sintered at 230° C. for different periods.

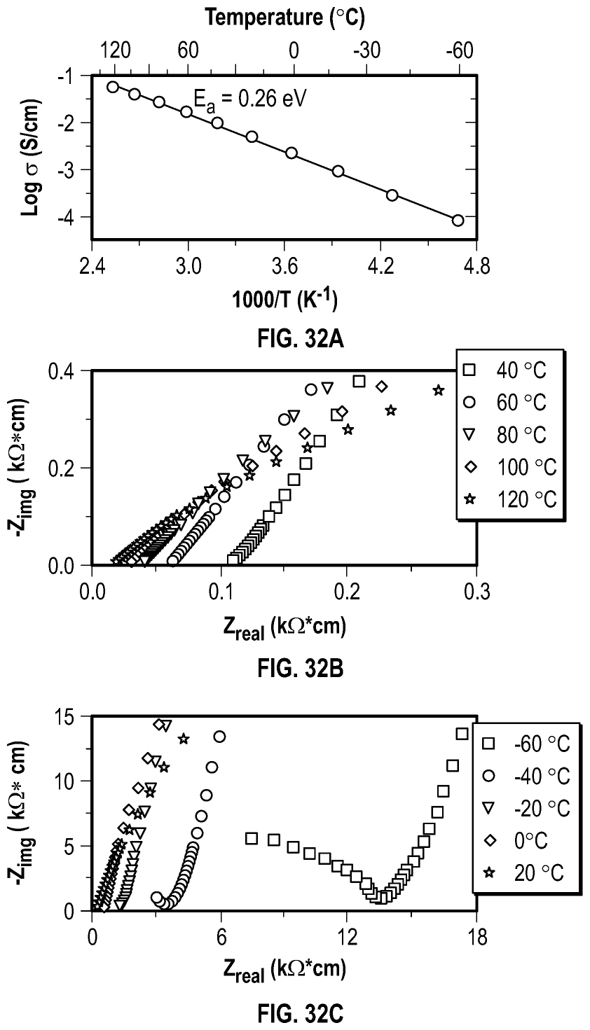

FIG. 32A, FIG. 32B, and FIG. 32C depict the Ac impedance and an Arrhenius plot of Li_{20/3}P₂S₈I_{2/3} sintered at 230° C. for 1 hour.

The conductivity achieved the highest value at 1 h sintering, which reached about 4.8 mS/cm at 21° C. For the 1 h sample with highest conductivity, the activation energy was measured to be 0.26 eV, which was as low as the best Li-ion conductors.

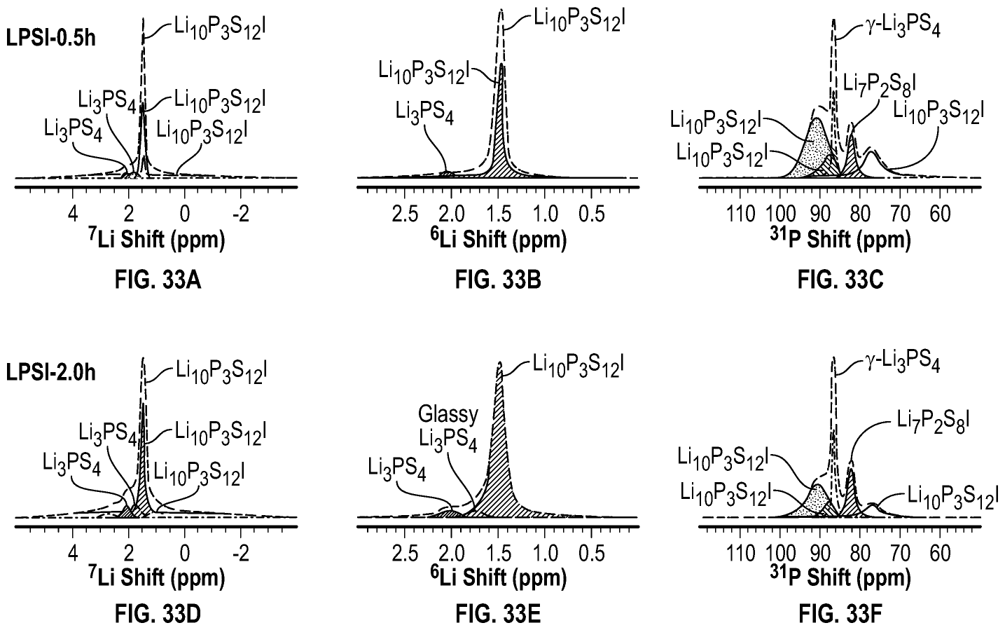

FIG. 33A-F depicts ⁷Li, ⁶Li, and ³¹P NMR spectra of the Li_{20/3}P₂S₈I_{2/3} family studied in this example. ⁷Li spectra of (FIG. 33A) Li_{20/3}P₂S₈I_{2/3} (sintered for 0.5 h) and (FIG. 33D) Li_{20/3}P₂S₈I_{2/3} (sintered for 2.0 h). ⁶Li spectra of (FIG. 33B) Li_{20/3}P₂S₈I_{2/3} (sintered for 0.5 h) and (FIG. 33E) Li_{20/3}P₂S₈I_{2/3} (sintered for 2.0 h). ³¹P spectra of (FIG. 33C) Li_{20/3}P₂S₈I_{2/3} (sintered for 0.5 h) and (FIG. 33F) Li_{20/3}P₂S₈I_{2/3} (sintered for 2.0 h).

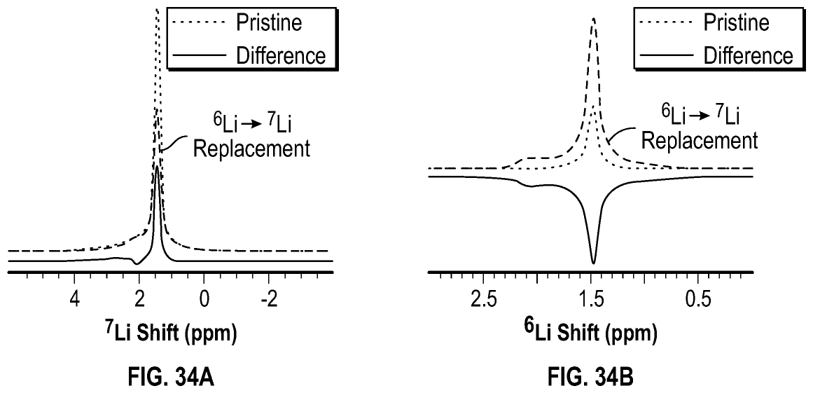

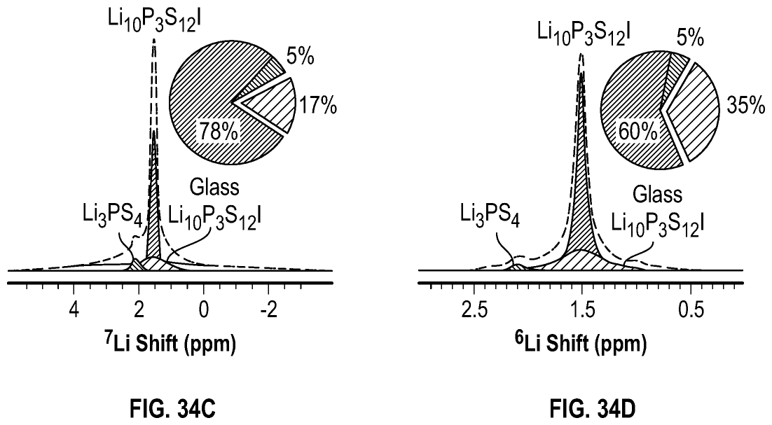

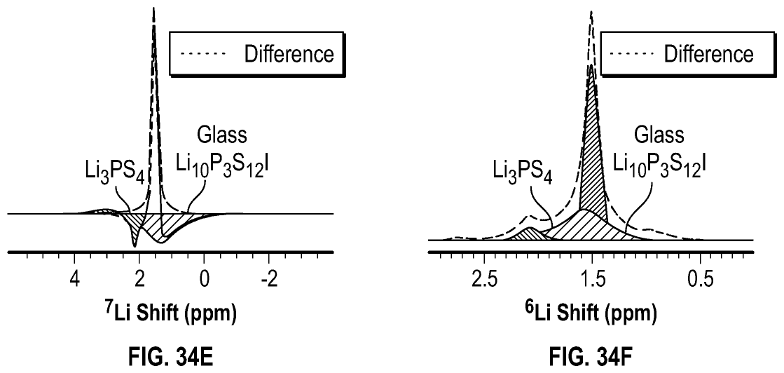

FIG. 34A-FIG. 34F depict ⁶Li→⁷Li tracer-exchange NMR probe Li-ion transport pathways in Li_{20/3}P₂S₈I_{2/3}. FIG. 34A and FIG. 34B depict a comparison of ⁷Li and ⁶Li NMR of Li_{20/3}P₂S₈I_{2/3} before and after ⁶Li→⁷Li replacement, and the difference spectra, respectively. FIG. 34C and FIG. 34D depict ⁷Li and ⁶Li NMR of Li_{20/3}P₂S₈I_{2/3} before and after ⁶Li→⁷Li replacement, respectively. FIG. 34E and FIG. 34F depict detailed analyses of the ⁷Li and ⁶Li difference spectra to show more clearly the phases that participate in Li-ion conduction.

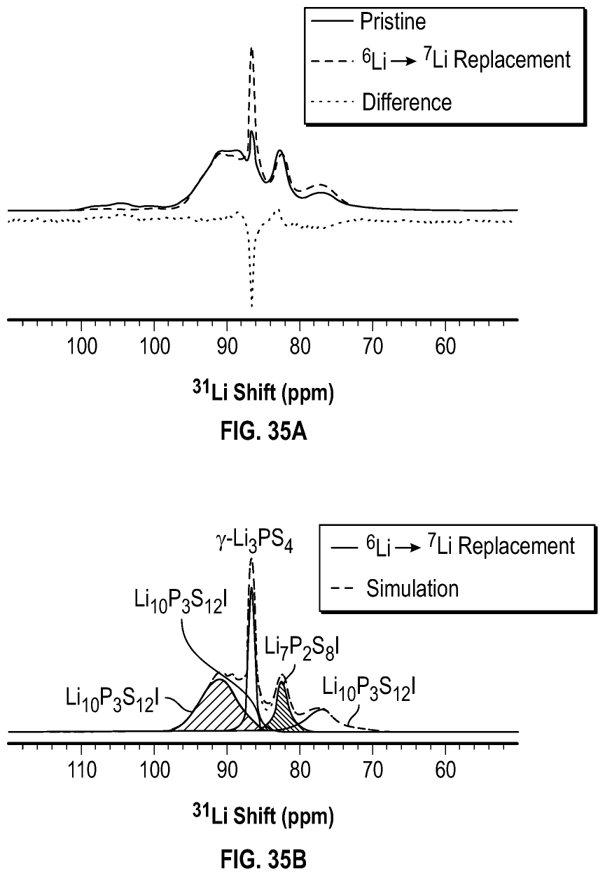

FIG. 35A depicts a ³¹P spectra of Li_{20/3}P₂S₈I_{2/3} before and after ⁶Li→⁷Li tracer-exchange, and the difference spectrum. FIG. 35B depicts a detailed analyses of the ³¹P spectrum of FIG. 35A after ⁶Li→⁷Li tracer-exchange.

Based on the ⁶Li, ⁷Li, and ³¹P NMR, the conductive phase was the glass phase, similar to other Li₆₊ₓP₂S₈Iₓ samples mentioned before. Also, it was confirmed that the Li ions preferred to diffuse through the glass phase, via ⁶Li→⁷Li-ion exchange experiment combined with ⁶Li, ⁷Li NMR.

SEM images were collected Li_{20/3}P₂S₈I_{2/3} which had been sintered at 230° C. for 1 h.

The Li_{20/3}P₂S₈I_{2/3} pressed under low pressure and sintered at low temperature was kind of porous, which limited the Li-ion diffusion and lead to a lower conductivity. On the other hand, the conductivity of the conductive glass phase should be even higher than 5 mS/cm and comparable to that of Li₁₀GeP₂S₁₂ and liquid-based electrolytes.

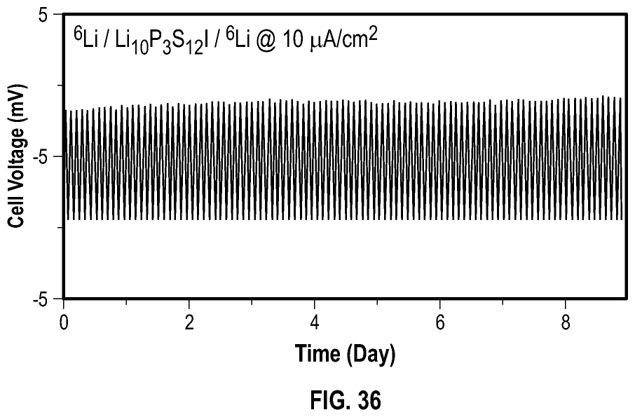

FIG. 36 depicts the results of a stability test of Li_{20/3}P₂S₈I_{2/3} (230° C. for 1 h) with Li/Li_{20/3}P₂S₈I_{2/3}/Li cells.

The stability of Li_{20/3}P₂S₈I_{2/3} was very good at low current, which almost didn't change after cycling.

### Example 10—Syntheses and Characterizations of Oxy Thiophosphate, Li₃PS_{3.75}O_{0.25}

Li₃PS_{3.75}O_{0.25} (hereafter LPSO) was a newly developed lithium oxy-thiophosphate solid electrolyte that aims to maintain the high ionic conductivity while enhancing the stability against moisture/oxygen. The improved stability was expected to reduce the cost of cell-assembly lines, which require extremely low moisture/oxygen level. Also, the toxicity of this material was reduced as the production of H₂S gas was minimized.

Depending on the ratio of reactants used for the synthesis of LPSO, several materials of new compositions have been developed. In general, a typical formula of LPSO can be written as Li₃PS₄₋ₓOₓ (x≤0.5). In this example, Li₃PS_{3.75}O_{0.25} served to demonstrate its performance and the feasibility of obtaining the desired materials.

An improved ionic conductivity was achieved in comparison to the pristine Li₃PS₄ solid electrolyte by the incorporation of O²⁻ into the structure. It was believed that the higher ionic conductivity was achieved by the optimized synthesis conditions of this example.

Li₂S, P₂S₅, and P₂O₅ were received without purifications. All chemicals are purchased from Sigma-Aldrich.

Li₃PS₄₋ₓOₓ (x≤0.5): Stoichiometric amounts of Li₂S, P₂S₅, and P₂O₅ were ground using agate motor/pestle in a Li:P:S:O ratio of 3:1:4−x:x for 10 minutes. After grinding, a uniform light-yellow color of powders was obtained. The pre-ground powders were placed in a ZrO₂ jar and two 10-mm ZrO₂ ball were added as grinding medium. The ZrO₂ jar was then vacuum sealed for a ball-milling event of 5 h (SPEX 8000M). After ball-milling, ˜50 mg of the pre-sintered powders was pressed into a 6-mm pellet under the pressure of ˜400 MPa. The pelletized powders were then sintered at 230° C. for 0.5-12 h (ramping rate of 1° C./min) followed by natural cooling under Ar. The resulted pellet after second sintering had a dimension of ˜6.1 mm in diameter and ˜1 mm in thickness and the pellet appeared light gray.

Characterizations: The characteristics of the as-synthesized Li₃PS₄₋ₓOₓ (x≤0.5) were investigated by several techniques including: powder X-ray diffraction (PXRD), electrochemical impedance spectroscopy (EIS), and galvanic cycling.

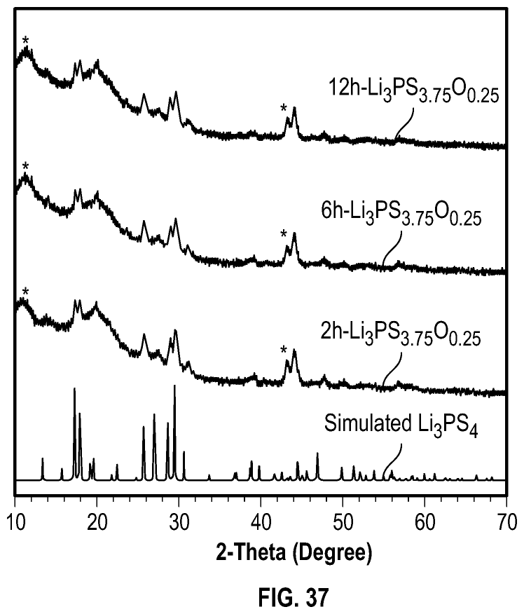

FIG. 37 depicts powder X-ray diffraction patterns of Li₃PS_{3.75}O_{0.25} sintered at 230° C. for 2 h, 6 h, and 12 h. Asterisk “*” denotes the background signals from polyimide film and stainless holder.

FIG. 37 demonstrates that all Li₃PS_{3.75}O_{0.25} samples presented a glass-ceramic crystallinity. Longer sintering at 230° C. did not improve the crystallinity. The strategies employed to improve the ionic conductivity included: 1) the replacement S²⁻ by O²⁻ in the structure; 2) mild sintering conditions promote the formation of low-crystalline glass phase, which was found to be helpful in enhancing ionic conductivity.

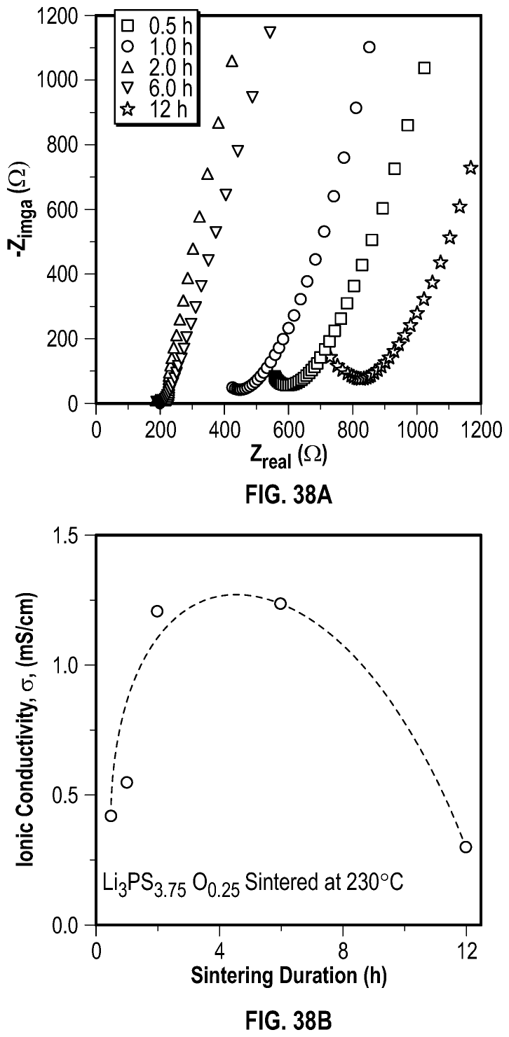

FIG. 38A depicts representative Nyquist plots of Li₃PS_{3.75}O_{0.25} sintered at 230° C. for 0.5 h, 1 h, 2 h, 6 h, and 12 h. FIG. 38B depicts the ionic conductivity of Li₃PS_{3.75}O_{0.25} as a function of sintering duration. Red dash line is the guild-to-the-eyes. Measurements were performed at 21° C. In foils were used as current collectors.

FIG. 38A and FIG. 38B show the effect of sintering duration on the ionic conductivity of Li₃PS_{3.75}O_{0.25}. The optimal synthesis condition for this example was found to be 230° C. for 2-6 h. Shorter or longer sintering duration as compared to this range resulted in a worse ionic conductivity.

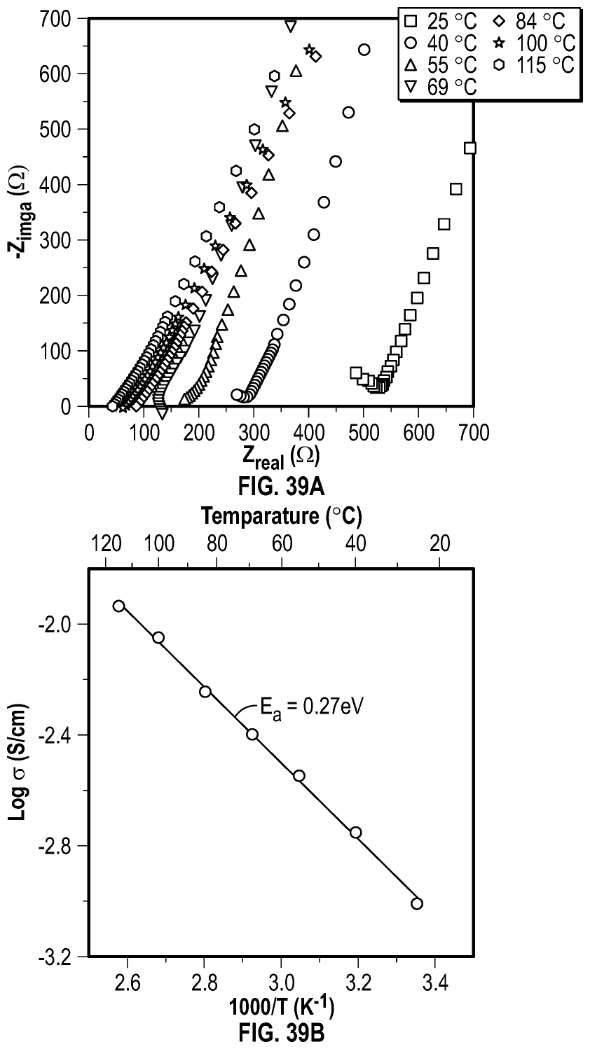

FIG. 39A depicts variable-temperature EIS of Li₃PS_{3.75}O_{0.25} performed from 25° C. to 115° C. FIG. 39B depicts an Arrhenius plot of Li₃PS_{3.75}O_{0.25}. In foils were used as current collectors.

FIG. 39A and FIG. 39B summarize the EIS response of Li₃PS_{3.75}O_{0.25} upon heating. The activation energy was 0.27 eV, which fell into the category of moderate thiophosphate solid electrolyte with an ionic conductivity of 1 mS/cm at room temperature.

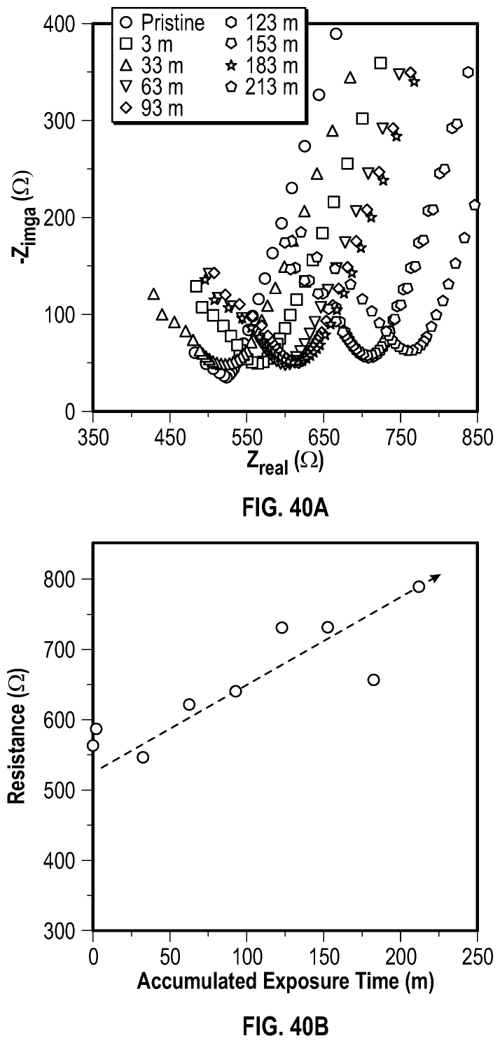

FIG. 40A and FIG. 40B depict the results of a stability test of Li₃PS_{3.75}O_{0.25} against moisture/oxygen. FIG. 40A depicts representative Nyquist plots of Li₃PS_{3.75}O_{0.25} after exposure to moisture/oxygen. FIG. 40B depicts a calculated resistance as a function of accumulated exposure time. Measurements were performed at 21° C. In foils were used as current collectors.

FIG. 40A and FIG. 40B present the stability of Li₃PS_{3.75}O_{0.25} upon exposure to moisture/oxygen. The slowly increased resistance was likely due to the degradation Li₃PS_{3.75}O_{0.25} after exposure.

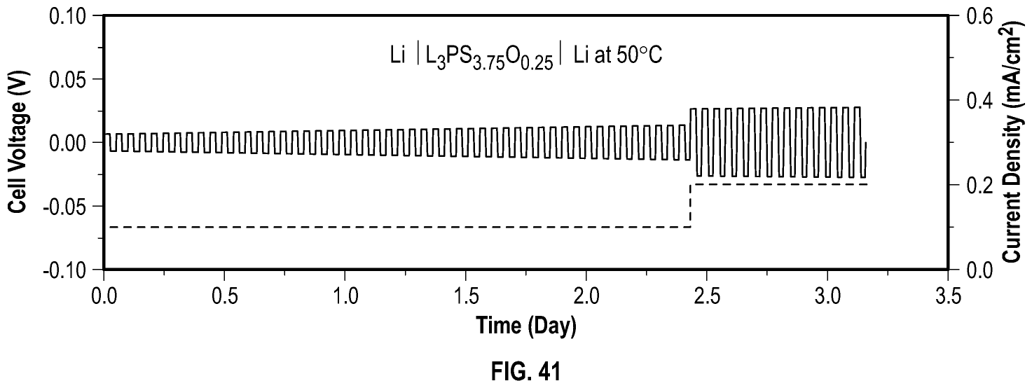

FIG. 41 depicts the results of a stability test of Li₃PS_{3.75}O_{0.25} against metallic Li. Li₃PS_{3.75}O_{0.25} was polarized by biased potential at 0.1 mA/cm², 0.2 mA/cm², at 50° C. Each cycle consisted of 30 minutes charge and 30 minutes discharge. Li foils were used as current collectors. FIG. 41 shows that Li₃PS_{3.75}O_{0.25} experienced a very small polarization (small cell voltage) up to biased potential of 0.2 mA/cm². This stability may be attributed to the glass phase of Li₃PS_{3.75}O_{0.25}.

### Example 11—Synthesis of Li₆₋ₓPS₅₋ₓCl₁₊ₓ.

In this example, both experimental and theoretic tools produced a series of highly conductive Li-deficient argyrodites, Li₆₋ₓPS₅₋ₓCl₁₊ₓ (x=0, 0.3, 0.5, 0.7), with a maximum achieved ionic conductivity of 17 mS/cm at 25° C. and a low activation energy of 0.22 eV. The tests of this example revealed that Li-deficient, Cl-rich Li₆₋ₓPS₅₋ₓCl₁₊ₓ yielded a higher degree of Cl⁻ at the 4 d sites, and the occupancy of Cl⁻ at 4 d sites was quantified with both ³⁵Cl and ³¹P NMR. Cl⁻ at 4 d sites changed energy landscape and stabilized 24 g sites, leading to Li redistribution among 48 h and 24 g sites. The insights gained from Li-ion dynamics and ⁷Li/⁶Li tracer-exchange NMR indicated that 24 g Li occupancy may facilitate fast ion conduction. Li₂S, P₂S₅, and LiCl were all purchased from Sigma-Aldrich. Prior to synthesis, LiCl was dried under dynamic vacuum at 200° C. for 12 h. Li₂S, P₂S₅, and LiCl were mixed with a Li:P:S:Cl molar ratio of (6−x):1:(5−x):(1+x). The pre-mixed powders (light-yellow) were then placed in a ZrO₂ jar (two ZrO₂ balls; 10-mm) and ball-milled (Spex 8000M) for 30 min under vacuum. After ball-milling, the mixed powders were heated at 300° C. for 12 h under an Ar environment and then were gently ground for 10 min. 50 mg of the pre-heated powders (gray) were pelletized into a disk (6-mm in diameter and 1-mm in thickness) under ˜400 MPa and sintered at temperatures between 440° C. and 550° C. for different x values for 12 h under vacuum in a quartz tube. All operations were performed under the protection of Ar gas in a glovebox (Mbrun, H₂O<0.5 ppm, O₂<0.5 ppm).

Solid-state NMR. ⁶Li, ⁷Li, and ³¹P MAS NMR experiments were performed on a Bruker Avance-III 500 spectrometer at the Larmor frequency of 73.6 MHz, 194.4 MHz, and 202.4 MHz, respectively. A spinning rate of 25 kHz was used for all the experiments. A single pulse was employed to acquire all ⁶Li and ⁷Li NMR spectra with a solid 90° pulse length and the recycle delay of 4.75 us and 500 s, and 3.35 us and 5 s for ⁶Li and ⁷Li NMR, respectively. ³¹P NMR was recorded with a rotor-synchronized spin-echo sequence with a 90° pulse length of 4.2 us and a recycle delay of 200 s. ⁷Li T₁ relaxation time was measured with an inversion-recovery pulse sequence. ^{6,7}Li and ³¹P NMR spectra were calibrated to LiCl₍ₛ₎ at −1.1 ppm²⁰ and 85% H₃PO₄₍₁₎ at 0 ppm, respectively. ³⁵Cl MAS NMR experiments were performed on a Bruker 830 spectrometer using a home-built 3.2-mm probe²¹ at the Larmor frequency of 81.3 MHz. The rotor-synchronized spin-echo sequence with a solid 90° pulse length of 2.9 us and a recycle delay of 20 s was employed. ³⁵Cl NMR spectra were calibrated to LiCl₍ₛ₎ at 9.93 ppm. All ^{6,7}Li, ³¹P, and ³⁵Cl NMR spectra were analyzed and processed on Topspin (v4.0)

⁶Li→⁷Li tracer exchange. The stoichiometric Li-Argyrodite, Li₆PS₅Cl-550° C. pellet, was sandwiched by two ⁶Li sheets (O.D.=5 mm) and placed in a home-built cylindrical cell. The symmetric ⁶Li|Li₆PS₅Cl|⁶Li cell was then galvanically polarized at 10 μA/cm² for 100 cycles (charge:30 min; discharge:30 min) at room temperature (˜21° C.). After polarization, ⁶Li sheets were removed from Li₆PS₅Cl pellet and then the Li₆PS₅Cl pellet was crushed and ground into fine powders for solid-state NMR characterizations.

Powder X-ray diffraction (XRD). Powder XRD experiments were performed using a Philips X'Pert powder diffractometer at 45 kV and 40 mA with Cu—K_{α} radiation (λ=1.5406 Å). The as-synthesized pellets were crushed and ground gently into powders and then placed in a zero-background holder, which was sealed with a Kapton film to avoid air exposure. The data was collected at room temperature with 20 from 10° to 80°, with a scan rate of 2°/min.

Scanning electron microscope. The morphology at the surface and cross-section of the as-synthesized Li₆PS₅Cl pellet was examined with a FEI Nova 400 NanoSEM.

Electrochemical test. The ionic conductivity of Li₆₋ₓPS₅₋ₓCl₁₊ₓ was measured at 21° C. using Ac electrochemical impedance spectroscopy (EIS) in the frequency range from 5 MHz to 1 Hz with a potential perturbation of 50 mV. To extract the activation energy of ion conduction in Li₆₋ₓPS₅₋ₓCl₁₊ₓ, variable-temperature impedance measurements were then performed from room temperature to 120° C. in a CSZ microclimate chamber. The as-synthesized Li₆₋ₓPS₅₋ₓCl₁₊ₓ disks were sandwiched by Indium foils (Sigma-Aldrich, 4.7 mm in diameter) and sealed in a home-built cylindrical cell²²for all measurements.

DFT structural optimization. First-principles calculations were performed using density functional theory as implemented in the plane-wave-basis-set Vienna ab initio simulation package (VASP). Projector augmented wave potentials with kinetic energy cutoff of 520 eV were employed in all structural optimizations and total-energy calculations, and the exchange and correlation functionals were described within Perdew-Burke-Ernzerhof generalized gradient approximation (GGA-PBE). A k-point density of at least 500 per atom in the unit cell was used in all calculations. For Li₆₋ₓPS₅₋ₓCl₁₊ₓ an electrostatic energy criterion is used to pre-screen structures with different Li/vacancy, S/Cl orderings based on the experimental crystal structure of Li₆PS₅Cl. The structures of the 10 to 20 lowest electrostatic energy arrangements are further optimized DFT, and the structures of the lowest DFT total energy in each composition are chosen as the ground states for ionic conductivity studies.

Li-Ion diffusivity and conductivity calculations. The ionic diffusivity and conductivity were calculated using ab initio molecular dynamics (AIMD) as implemented in VASP. The simulations were performed on the canonical ensemble with a time step of 2 fs, and the temperature was initialized at 100 K and elevated to the appropriate temperature (500, 600, 720, 900, and 1200 K) with simulations over 100 ps for statistical analysis. Each supercell consists of eight formula units. A γ-point-only sampling of k-space and a lower but sufficient (280 eV) plane-wave energy cutoff than that for the structural optimization calculation was used. The Li diffusivity was calculated from atomic trajectories using the Einstein relation, and the activation energy and extrapolation to room-temperature diffusivity were obtained assuming Arrhenius behavior.

The Li-argyrodites, Li₆₋ₓPS₅₋ₓCl₁₊ₓ (x=0, 0.3, 0.5, 0.7, and 0.8), were prepared to investigate the correlation of chemistry, structure, and composition with ionic conductivity. To create more S²⁻/Cl⁻ disorder, beyond the limit generated by Cl/S exchange in Li₆PS₅Cl, more Cl is inserted into the structure to replace S at the 4d site with charge compensated by Li deficiency, leading to nominal compositions of Li₆₋ₓPS₅₋ₓCl₁₊ₓ. The arrangement of PS³⁻ tetrahedra, Cl⁻, and free S²⁻ in the structure of Li₆PS₅Cl without disorder was analyzed, and Cl⁻ exclusively occupies 4a sites, whereas free S²⁻ resides at 4d sites.

It was believed that S²⁻/Cl⁻ mixing at the 4d site contributed to anion site disorder, which may have promoted ion conduction via an inter-cage jump (48 h-48 h) mechanism. The X-ray powder diffraction patterns of Li₆₋ₓPS₅₋ₓCl₁₊ₓ (x=0, 0.3, 0.5, 0.7, and 0.8) were collected. Preservation of structural integrity to modifications induced by varying ratios between free S²⁻ and Cl⁻ (from 1:1, 0.7:1.3, 0.5:1.5, 0.3:1.7, to 0.2:1.8) was observed, the long-range structural order stayed the same as suggested by the XRD patterns. No impurities were detected up to x=0.7, indicating that added LiCl was successfully integrated into the structures. However, unknown phases and residual LiCl were observed in nominal Li_{5.2}PS_{4.2}Cl_{1.8}. All the diffraction peaks continued to shift to the right when doping with LiCl till x=0.8 in Li₆₋ₓPS₅₋ₓCl₁₊ₓ, which indicated shrinkage of crystal lattice parameters, and demonstrated the successful Cl doping with the limit of x=0.7 (Li_{5.3}PS_{4.3}Cl_{1.7}).

Enhanced Ionic Conductivity. The ionic conductivity of Li₆₋ₓPS₅₋ₓCl₁₊ₓ positively correlated with Cl⁻ content and the highest σ of 17 mS/cm was obtained, in this example, with Li_{5.3}PS_{4.3}Cl_{1.7} at 25° C. Significant improvement in ionic conductivity in this example was achieved by simply varying the Cl⁻ concentration rather than adding dopants such Si⁴⁺ or Ge⁴⁺, which can ultimately yield the unwanted electronically conducting interphases. After passing the maximum Cl⁻ solubility (x=0.7), the ionic conductivity dropped along with the detection of LiCl and other impurities, and this was observed in the PXRD when x>0.7 in Li₆₋ₓPS₅₋ₓCl₁₊ₓ. The activation energy decreased from 0.257 eV (x=0) to 0.251 eV (x=0.3), 0.221 eV (x=0.5), and 0.218 eV (x=0.7).

The AIMD simulations on stoichiometric Li₆PS₅Cl and Li-deficient Li_{5.25}PS_{4.25}Cl_{1.75} could support the evidence of enhanced Li conductivity with an increasing amount of Cl. It was found that the S/Cl mixing at 4d could lead to a high ionic conductivity in the stoichiometric Li₆PS₅Cl. The probability density analysis on the distribution of Li ions in the AIMD simulations, clearly demonstrated that Cl occupation at 4d sites lead to a frustrated Li-ion energy landscape in the Li₆PS₅Cl and Li₆₋ₓPS₅₋ₓCl₁₊ₓ.

The ion conduction was mostly isolated surrounding the S (4d) site in the ordered Li₆PS₅Cl without any S/Cl mixing. When a Cl⁻ occupied the 4d site, it induced non-localized ion conduction. The more evenly distributed probability densities of Li+in Li_{5.25}PS_{4.25}Cl_{1.75} indicated a relatively flatter energy landscape than in the case of the pristine Li₆PS₅Cl. The calculated activation energy from the AIMD simulations was smaller with a much higher ionic conductivity in the Li_{5.25}PS_{4.25}Cl_{1.75}, which agreed with the results from the impedance measurements.

To gain further new insights into the structural origin of fast ion conduction in Li₆₋ₓPS₅₋ₓCl₁₊ₓ, a combined study of DFT structural optimization, high-resolution MAS (25 kHz) ^{6,7}Li, ³¹P, and ³⁵Cl NMR was employed to study systematically the effect of Cl⁻ occupancy at 4d sites in Li-deficient argyrodites.

The flatter energy landscape induced by Cl at 4d sites in Li₆₋ₓPS₅₋ₓCl₁₊ₓ was closely related to the re-distribution of Li ions within the crystal structures. In the DFT optimized structure of Li₆PS₅Cl without any S/Cl mixing, Li ions solely occupy 48 h sites. In contrast, with S/Cl mixing at 4d sites in Li₆PS₅Cl, nearly half of the Li ions were found to be displaced off 48 h sites towards 24 g sites, primarily due to local structural distortion caused by S/Cl disorder at 4a and 4d sites. This shift of Li ions towards 24 g sites could also be clearly found in the Li-deficient and Cl-rich structures, for example, Li_{5.25}PS_{4.25}Cl_{1.75}. These DFT calculations confirmed the existence of 24 g Li in Li₆PS₅Cl and the Cl-rich case Li₆₋ₓPS₅₋ₓCl₁₊ₓ with Cl—S mixing at 4d sites, which was consistent with experimental results obtained from high-resolution ⁶Li NMR as discussed herein. Furthermore, the tendency of Li to occupy 24 g sites increased with increasing Cl at 4d sites.

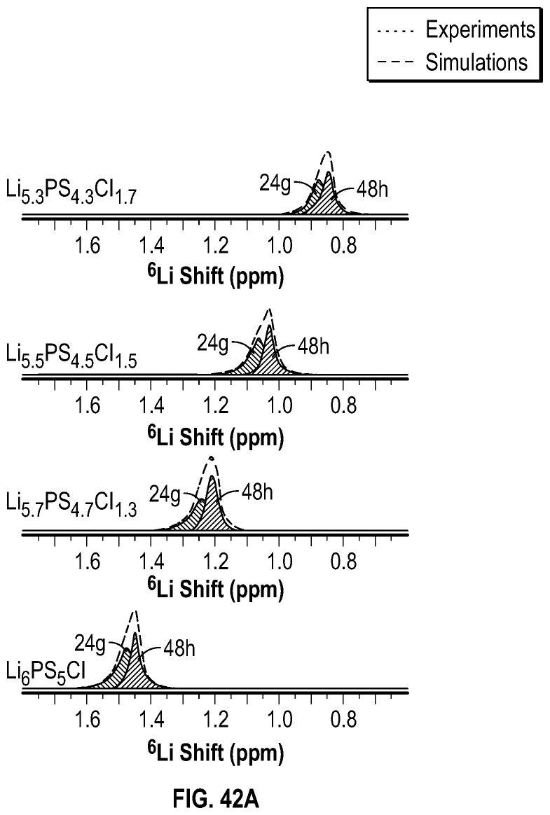

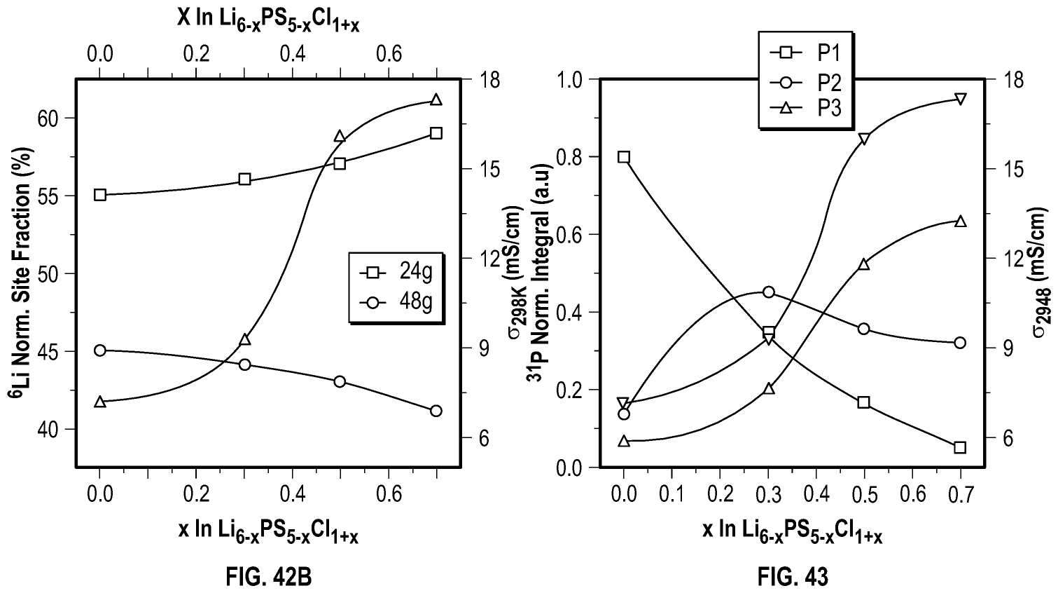

The ⁶Li NMR spectra of Li₆₋ₓPS₅₋ₓCl₁₊ₓ (x=0, 0.3, 0.5, and 0.7) are shown at FIG. 42A. Two distinct Li resonances (Li1 and Li₂) were identified in all Li₆₋ₓPS₅₋ₓCl₁₊ₓ. In the structure of Li₆PS₅Cl, Li⁺ could occupy both 24 g and 48 h sites, and the majority of Li+occupied more energetically favorable 48 h sites in stoichiometric Li₆PS₅Cl. ²⁶ Li⁺ at 24 g sites was stabilized in Li-deficient Li₆₋ₓPS₅₋ₓCl₁₊ₓ as more Li vacancies were created in the Li⁺cages, as a result of reduced repulsions between Li⁺. Therefore, Li1 and Li₂ were assigned to Li⁺ at 48 h and 24 g sites, respectively. This assignment was also supported by recent literature that investigated the correlation of ionic conductivity with the content of Li₂ (Li⁺ at 24 g). Li occupancy at 24 g sites contributed to shortening the inter-cage jump distances, and thus promoted long-range ion conduction. As revealed in the plots shown at FIG. 42B, a small increment in Li fraction at 24 g sites upon the increase of x in Li₆₋ₓPS₅₋ₓCl₁₊ₓ corresponded to increased ionic conductivity. To quantify Li occupancies at 24 g and 48 h sites, the x values in nominal Li₆₋ₓPS₅₋ₓCl₁₊ₓ were first validated. The ⁷Li NMR shifts of Li₆₋ₓPS₅₋ₓCl₁₊ₓ decreased linearly with increasing x. Therefore, based on this linear calibration curve, the x value (x=0, 0.3, 0.5, 0.7) in each Li₆₋ₓPS₅₋ₓCl₁₊ₓ was confirmed. Taking into account the reduced total Li amount in Li₆₋ₓPS₅₋ₓCl₁₊ₓ as x increased, the calibrated ⁶Li site fraction of both Li1 and Li₂ decreased, but the normalized Li⁺ fraction at 24 g sites increased. This suggested that when S²⁻/Cl⁻ mixing at 4d site occurred with Li deficiency, Li⁺ preferred to occupy 24 g sites.

To examine the impact of Li deficiency and S/Cl exchange on Li⁺ mobility, NMR relaxometry was employed. The ⁷Li T₁ relaxation time increased with x value in Li₆₋ₓPS₅₋ₓCl₁₊ₓ. Relaxation times were indicators to reflect the jump rate (τ_{c}⁻¹) in diffusional hopping processes. Based on BPP model in the fast motion region, when ion motion increases, T₁ times increase. Therefore, the increased ⁷Li T₁ NMR relaxation times may have suggested faster Li⁺ motion as x increased in Li₆₋ₓPS₅₋ₓCl₁₊ₓ. Therefore, the fast ion conduction in Li₆₋ₓPS₅₋ₓCl₁₊ₓ could possibly be at least partially attributed to increased Li⁺ mobility. Li⁺ at 24 g sites exhibited slightly longer T₁ time, which could possibly suggest a faster ion motion. Therefore, the increased Li⁺ occupancy at 24 g sites likely contributed to overall faster Li⁺ motion.

The S²⁻ (4d) located in the 2^{nd} coordination shell of P in Li₆₋ₓPS₅₋ₓCl₁₊ₓ, and S²⁻/Cl⁻ mixing at 4d sites affected P local structural environment, which could be quantitatively probed by ³¹P NMR. In a pristine Li₆PS₅Cl without S²⁻/Cl⁻ mixing, the Wyckoff 4d sites were solely taken by free S within the secondary coordination sphere around the P (Wyckoff 4b), which likely results in one single ³¹P resonance. S²⁻/Cl⁻ mixing at 4d sites could lead to different P local environments. The arrangements of S²⁻/Cl⁻ atoms at 4d sites can be 4S, 3S1Cl, 2S2Cl, 1S3Cl, and 4Cl. Non-mixing, i.e., the 4S and 4Cl configurations, was not detected as both S and Cl tended to partially secure 4d sites due to their close ionic radii. Therefore, ³¹P NMR resonances (P1, P2, and P3) reflecting with the three remaining possibilities of S²⁻/Cl⁻ mixing were observed in Li₆₋ₓPS₅₋ₓCl₁₊ₓ. As a result, ³¹P signals of P1, P2, and P3 sites were assigned to the P sites surrounded by 3S1Cl, 2S2Cl, and 1S3Cl in the 2^{nd} coordination shell, respectively. Upon the replacement of more S²⁻ with Cl⁻ at 4d sites, P1 diminished whereas P3 grew. On the other hand, P2 initially increased but decreased afterward. The quantified evolution of ³¹P resonances as a function of x in Li₆₋ₓPS₅₋ₓCl₁₊ₓ is depicted at FIG. 43. By comparing the variation of ³¹P NMR signals with ionic conductivity as a function of x in Li₆₋ₓPS₅₋ₓCl₁₊ₓ (FIG. 43), it was found that the amount of the P3 (1S3Cl) resonance was positively correlated with the improvement of ionic conductivity. This indicated that up to x=0.7 in Li₆₋ₓPS₅₋ₓCl₁₊ₓ, higher Cl⁻ content gave rise to the larger degree of S²⁻/Cl⁻ anion site-disorder at 4d sites. Without producing impurities, a higher degree of anion site-disorders at 4d sites promoted faster ion conduction. This experimental observation echoed with DFT MD simulation, which revealed that the 3Cl1S configuration yielded the highest Li⁺ jump rates.

In principle, ³⁵Cl NMR is sensitive to Cl⁻ local structural environments, and S²⁻/Cl⁻ mixing in Li₆₋ₓPS₅₋ₓCl₁₊ₓ at 4d sites was expected to at least produce two ³⁵Cl resonances, which corresponded to Cl⁻ at the original 4a sites and the mixing 4d sites. As observed in a ³⁵Cl NMR spectra of Li₆₋ₓPS₅₋ₓCl₁₊ₓ, one sharp peak at 9 ppm and one broad signal at −25 ppm were identified. To make reliable assignments of these two ³⁵Cl resonances, ³⁵Cl NMR on lab synthesized Li_{5.7}PS_{4.7}Cl_{0.3}I were acquired. In Li_{5.7}PS_{4.7}Cl_{0.3}I, due to the significant difference in ionic radius between I⁻ and Cl⁻, Cl⁻ was expected to exclusively reside at 4d sites, while I⁻ fully occupied 4a sites. Therefore, the major resonance found in ³⁵Cl NMR of Li_{5.7}PS_{4.7}Cl_{0.3}I at 9 ppm should have been from Cl⁻ at 4d sites. Therefore, the 9-ppm resonance was assigned to Cl⁻ at 4d sites while the −25 ppm one to Cl⁻ at 4a sites. This assignment was consistent with the observation that the 9-ppm resonance grew with increasing x value in Li₆₋ₓPS₅₋ₓCl₁₊ₓ, suggesting increased Cl⁻ at 4d sites. Furthermore, the ion dynamics of Cl⁻ at 4d sites and at 4a sites were remarkably different, revealed by very different T₁ relaxation times. An estimated T₁ time for Cl⁻ at 4d sites was 6 s, while a very short T₁ time of 0.02 s was observed for Cl⁻ at 4a sites. The extremely short T₁ time on the order of milliseconds suggested that Cl⁻ at 4a site experienced strong quadrupolar couplings, causing a rapid dephasing of longitudinal magnetization. On the other hand, the significantly longer Ti time on the order of seconds for Cl⁻ at 4d sites indicated that the relaxation was driven by dipolar couplings. In general, a nucleus which had a quadrupolar moment such as ³⁵Cl (I= 3/2) was expected to have quadrupolar couplings as the dominating NMR interaction, especially in a non-symmetric structural environment, which largely drives fast relaxation. In such cases, a ³⁵Cl NMR signal should observe a broad linewidth as shown by Cl⁻ at 4a sites. However, a sharp ³⁵Cl NMR resonance and slower NMR relaxation were expected when Cl⁻ sites were at a relatively symmetric structural environment or exhibited fast motion.

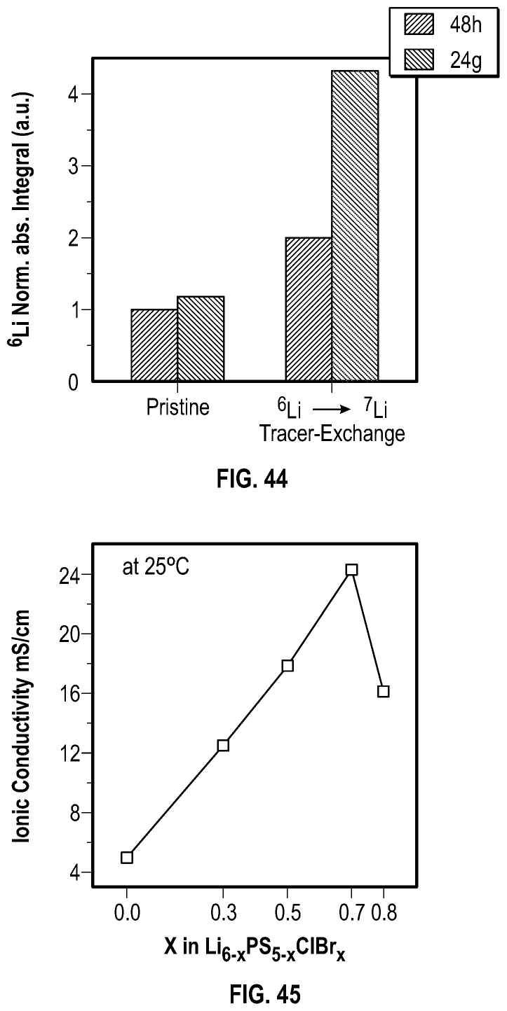

To identify which Li site, 24 g or 48 h, was essential for fast ion conduction, ⁶Li→⁷Li tracer-exchange was performed on Li₆PS₅Cl. Li ions were expected to pass through the critical Li sites more frequently than the rest, therefore more ⁶Li enrichment should be observed for active Li sites. ⁶Li NMR spectra of Li₆PS₅Cl before/after ⁶Li→⁷Li tracer-exchange and the difference spectrum were collected. Negative ⁶Li NMR peaks indicated that the ⁶Li NMR signal intensity was enhanced after tracer-exchange. The more negative the ⁶Li NMR signal was, the higher the ⁶Li NMR signal of the corresponding site was enriched. When simulating the ⁶Li NMR spectrum after tracer-exchange, two resonances were found with Li₂ (24 g, green) showing higher intensity than Li1 (48 h, purple). This was consistent with the difference spectrum. Quantification of normalized ⁶Li site integral (FIG. 44) between two sites before/after ⁶Li→⁷Li tracer-exchange showed that the ⁶Li enrichment was observed for both sites. The ⁶Li-enrichment of Li₂ (24 g) site was significantly greater. The results suggested the role of 24 g sites for fast Li-ion conduction. This was consistent with the positive correlation found between enhanced ionic conductivity and increased Li occupancy at 24 g sites.

### Example 11—Halide Codoping Enhanced Structural Disorder and Ionic Conductivity

The tests of this example explored the possible effect(s) of an entropic driven anion disordered framework on ion conduction by hetero-anion doping of two halogens in the argyrodite structure. The partial substitution of sulfur with bromine in the formula Li₆₋ₓPS₅₋ₓClBrₓ was investigated. By combining Solid-state NMR and neutron total scattering analysis, local structural disorder induced by bromine substitution was analyzed. It was investigated how anion disorder may prompt increased configuration entropy in the structural framework and how it may trigger the lithium distribution in the two sites (24 g and 48 h). Electrochemical Impedance Spectroscopy (EIS) was used to measure ionic conductivity and X-ray powder diffraction to identify the phase purity. With increasing bromine fraction, structural disorder among the anion site (4a and 4d) was increased which correlated with increase in ionic conductivity. The highest ionic conductivity of 24 mS/cm, with activation energy of 0.127 eV at 25° C., was achieved when x=0.7, in Li_{5.3}PS_{4.3}ClBr_{0.7}.

Synthesis of Defective Argyrodite: The precursor materials used were binary halide, LiCl and LiBr (>99.9% Sigma-Aldrich), Li₂S (>99.9% Alfa-Aesar) and P₂S₅ (>99.9% Sigma-Aldrich). Samples were weighed based on the stoichiometric mole ratio, finely ground in mortar and pestle, followed by high-energy mechanical milling for 30 minutes in zirconia jar with 10 mm zirconia balls. All procedures were conducted under argon atmosphere in a Mbrun glovebox (O₂<0.5 ppm, H₂O<0.5 ppm). The as prepared powders were annealed at 300° C., pressed into 6 mm pellets followed by final sintering at 550° C.-450° C. under static vacuum.

Solid-state NMR: ⁶Li, ⁷Li and ³¹P MAS NMR experiments were performed using Bruker Avance-III 500 spectrometer at Larmor frequency of 73.6 MHz, 194.4 MHz, and 202.4 MHz respectively under Magic Angle Spinning rate of 25 kHz. For ⁶Li and ⁷Li, single pulse experiment was employed using a pulse length of 4.75 μs and 3.35 μμs, with recycle delay of 500 s and 5 s, respectively. For ³¹P, rotor-synchronized spin-echo sequence with a 90° pulse length of 4.2 μμs and recycle delay of 300 s was employed. ^{6,7}Li and ³¹P NMR spectra were calibrated to LiCl(s) at −1.1 ppm and 85% H3PO4₍₁₎ at 0 ppm respectively. ³⁵Cl and ⁷⁹Br MAS NMR were performed on 830 MHz spectrometer at Larmor frequency of 81.4 MHz and 208.3 MHz respectively under spinning rate of 16 kHz. ⁷⁹Br NMR was obtained using single pulse experiment with a pulse length of 1 μs and recycle delay of 1 s. ³⁵Cl NMR was obtained using rotor-synchronized spin-echo sequence with a 90° pulse length of 2.9 μμs and recycle delay of 20 s. ⁷⁹Br NMR was obtained using a single pulse with 90° pulse length of 1 μs and recycle delay of 1 s. Solid KBr (54.5 ppm) and LiCl (9.93 ppm) was used to calibrate ⁷⁹Br and ³⁵Cl, respectively.

Powder-X-ray Diffraction: Powder XRD was performed using Philips X'Pert powder diffractometer with Bragg-Brentano geometry at 45 kV and 40 mA with Cu—Kα radiation (80 =1.5406 Å). Kapton film was used to seal the samples in-order to prevent from humid air.

Rietveld Analysis: Rietveld refinement was carried out using GSAS II software. The following parameters were refined step wisely: (1) scale factor, (2) background coefficient using Chebyschev function with 6 free parameters, (3) peak shape described as pseudo-Voigt function, (4) lattice constants, (5) fractional atomic coordinates, (6) isotropic thermal displacement (Uiso) parameters and (7) zero shift error. Atomic occupancy of the anion's Br and S (4a vs 4d site) were refined by adding constraints in the Uiso parameters and setting the sum of occupancy as 1.

Electrochemical measurements: Ionic conductivity was measured by Ac impedance spectroscopy, using a Gamry Analyzer. Indium foil was pressed between the pellets as the blocking electrode and the pellets were placed in custom built cylindrical cell between two stainless steel disks. Impedance measurements were conducted in the temperature range of 21 to 120° C. at frequencies from 5 MHz to 1 Hz with amplitude of 10 mV.

Lithium deficient argyrodite Li₆₋ₓPS₅₋ₓClBrₓ (x=0, 0.3, 0.5 and 0.7) was synthesized to investigate the impact of structural disorder induced by substituting sulfur with bromine on ion conduction. High-resolution total neutron scattering pattern was obtained using the NOMAD instrument at Oakridge National Lab. Bragg scattering data from Li₆PS₅Cl was collected, and indexed to space group F-43m (216). The model seemed to match well with the experimental data with R_{wp} of 3.73 and 6.50 for low and large d-spacing region respectively. An overlay of the Bragg peaks of bromine substituted argyrodite from x=0.3 to 0.7 was analyzed. Minor unknown phases appear at high bromine content.

Ionic conductivity was determined by electrochemical impedance spectroscopy. The ionic conductivity was significantly enhanced by substitution of sulfur with bromine as depicted at FIG. 45.

Highest ionic conductivity of 24 mS/cm at 25° C. was achieved when Br=0.7, further increase in bromine reduced the conductivity as additional impurities were observed. Temperature-dependent conductivity measurements were performed to determine the activation energy. Li_{5.3}PS_{4.3}ClBr_{0.7} displayed activation energy of 0.127 eV which was much lower than pristine Li₆PS₅Cl. Substituting sulfur with bromine increased the site disorder among 4a and 4d sites which likely attributed to high ionic conductivity with low activation energy and increased conductivity.

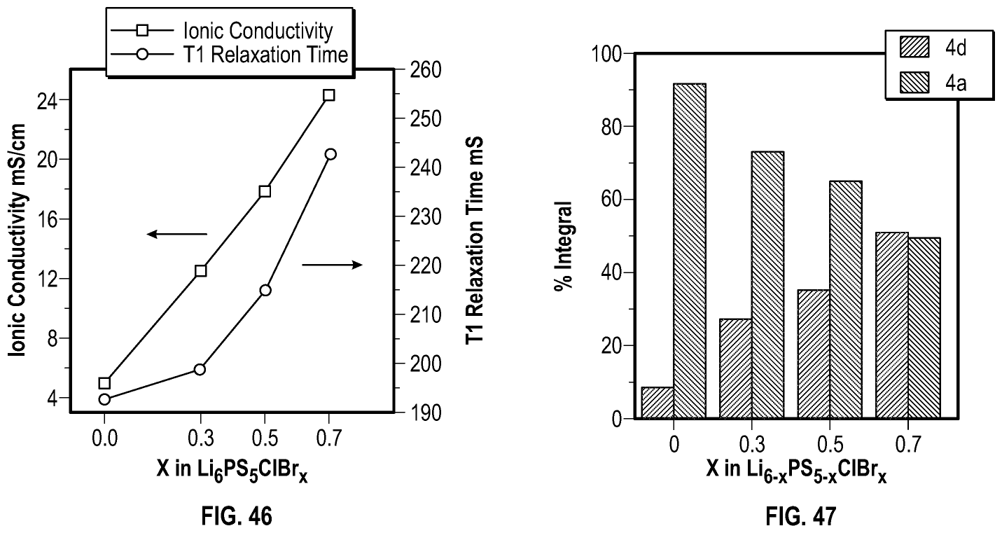

NMR spin lattice relaxation time (T₁) refers to the time the ensemble of spin recovers from nonequilibrium to equilibrium state and depends on the variation of incoherent local field sensed during ionic motions. A model has been developed to explain the correlation time Tc (time for nuclear spin to rotate by one radian) is indicative to ion mobility (Bloembergen, N.; Purcell, E. M.; Pound, R. V. Relaxation Effects in Nuclear Magnetic Resonance Absorption. Phys. Rev. 1948, 73 (7), 679-712). Frequency and temperature dependent NMR spin relaxation rate measurements done on Li₆PS₅Br and Li₆PS₅Cl have indicated that ion motion is in the liquid regime, hence long T₁ time in this system indicated high mobility. FIG. 46 represents the T₁ relaxation time measured from inversion recovery pulse sequence and elucidated increase in T₁ indicating fast ion mobility with bromine substituted argyrodite which indirectly correlated with high ionic conductivity.

To quantify accurately structural disorder among the 4a and 4d sites, ³⁵Cl NMR was acquired. In an ordered system for Li₆PS₅Cl the chlorine occupies the face centered cubic lattice (Wyckoff 4a), however, as mentioned herein, there is site disorder among 4a and 4d. To confirm the assignment of two resonances observed in ³⁵Cl NMR to the two crystallographic sites, Iodine argyrodite with partial substitution of sulfur with chlorine was synthesized in the ratio Li_{5.7}PS_{4.7}ICl_{0.3}. Iodine argyrodite Li₆PS₅I has an ordered minimal site disorder among 4a and 4d due to large ionic size of iodine compared to sulfur. Partial substitution of sulfur with chlorine in the iodine argyrodite should result in majority of chlorine occupying the 4d site, hence Li_{5.7}PS_{4.7}ICl_{0.3} was successfully synthesized and characterized for X-ray diffraction to identify the phase purity. ³⁵Cl NMR revealed two peaks, the peak resonating at 9.33 ppm was identified as chlorine at 4d site.

The two peaks observed in ³⁵Cl NMR were attributed to the two crystallographic sites. As depicted at FIG. 47, with the increase in bromine substitution, the chlorine site occupancy in Wyckoff 4d increased.

### Example 12—Fast Ion Conduction in Li₆₋ₓPS₅₋ₓBr₁₊ₓ

In this example, Li₆₋ₓPS₅₋ₓBr₁₊ₓ was synthesized with increased site mixing of Br. A maximum conductivity of 10 mS cm⁻¹ at 21° C. was achieved when x=0.7 (Li_{5.3}PS_{4.3}Br_{1.7}). The influence of Br⁻/S²⁻ mixing on conductivity was systematically investigated with solid-state NMR coupled with X-ray diffraction and impedance spectroscopy. The role that Li (24 g) plays in ion conduction was examined by ⁶Li→⁷Li tracer-exchange NMR. A statistical distribution of characteristic configurations of 4d sites was observed with ³¹P NMR. The conductivity Li₆₋ₓPS₅₋ₓBr₁₊ₓ did not explicitly involve Br site mixing. The resulting local structures of 4d sites impacted the jump rate of their surrounding Li differently. ³¹P NMR together with density function theory calculations provided a relation for conductivity versus overall jump rate. It suggested that fast ion conduction can be achieved in locally well-structured argyrodite.

Synthesis: Li₂S (99.98%, Sigma-Aldrich), P₂S₅ (99%, Sigma-Aldrich), and LiBr (99%, Sigma-Aldrich) were kept in an argon-filled glovebox (Mbraun) to avoid exposure to oxygen and moisture and dried before use. The powder was then prepared by mixing the as-mentioned precursors using an agate mortar with a stoichiometric ratio. The mixture was then sealed in an airtight quartz tube in argon. The sealed tube was placed in a box furnace with the temperature ramping from room temperature to 300° C. with the rate of 1° C. min⁻¹. The temperature was then kept at 300° C. for 12 h. Then, the heat-treated powder was ground again and pressed into a pellet using a 6 mm stainless-steel mold. The pellet was sintered at 450-550° C. for 12 h under vacuum.

Electrochemical Measurement: The pellet was sandwiched by two indium blocking electrodes, and then assembled together into a cylindrical cell. The Electrochemical Impedance Spectroscopy (EIS) was measured using a Gamry Reference 600+ with frequencies from 1 Hz to 5 MHz. The conductivity was calculated with the equation

$$σ = \frac{L}{S \times R} ,$$

in which L, S, R are the thickness (cm), the contact area (cm²), and the resistance (ohm). The temperature-dependent impedance measurement was carried out using a CSZ microclimate chamber within the range of 20° C. to 120° C.

X-ray diffraction: The pellet was ground into powder and transferred to an XRD holder in a glovebox. The holder containing the sample was sealed using vacuum grease and Kapton film. Afterwards, the powder X-ray diffraction measurement was performed on a Panalytical X'PERT Pro powder diffractometer (Cu—K_{α1}, λ=1.5406 Å) at 45 kV and 40 mA at ambient temperature. The scanning speed is 1.16° min⁻¹ from 274 =10° to 80°.

Rietveld Refinement: Rietveld refinement was carried out using GSAS II software. The following parameters were refined stepwise: (1) scale factor, (2) background coefficient using Chebyschev function with 6 free parameters, (3) peak shape described as pseudo-Voigt function, (4) lattice constants, (5) fractional atomic coordinates, (6) isotropic thermal displacement (Uiso) parameters, and (7) zero shift error. Atomic occupancies of Br and S (4a versus 4d site) were refined by adding constraints in the Uiso parameters with the sum of occupancy set as 1.

Tracer-Exchange: The Li₆PS₅Br pellet was sandwiched by two ⁶Li-rich foils to assemble into a cylindrical cell. The cell was cycled for 100 times with an Abrin battery testing system with a current density of 10 uA cm⁻¹, with the direction of current changed every 30 minutes.

Solid-state NMR Measurement: The ^{6/7}Li and ³¹P magic-angle-spinning (MAS) NMR measurements were carried out on a Bruker Avance III-500 spectrometer with the powdered samples packed in 2.5 mm zirconia rotors spun at 25 kHz. The ^{6/7}Li spectra were collected using a single-pulse sequence, and the spin echo sequence was used to obtain ³¹P spectra. The chemical shift of ^{6/7}Li and ³¹P spectra were referenced to solid LiCl at −1.1 ppm and 85% H₃PO₄ solution at 0 ppm, respectively. The static ⁷⁹Br quadrupolar Carr-Purcell Meiboom-Gill (QCPMG) NMR spectra were performed on an 830 MHz (19.6 T) spectrometer. The ⁷⁹Br shifts were referenced to solid KBr at 54.5 ppm.

Density Functional Theory Calculations: All density functional theory (DFT) energy calculations and NMR shielding tensor calculations were performed in the Vienna ab initio simulation package (VASP) using the projector-augmented-wave approach. Perdew-Burke-Ernzerhof generalized-gradient approximation (GGA-PBE) was used as the exchange-correlation functional, with the latest PAW potential files available in the VASP. The pristine structure of Li₆PS₅Br was taken from Materials Project (ID: mp-985591) (Ong, S. P.; Richards, W. D.; Jain, A.; Hautier, G.; Kocher, M.; Cholia, S.; Gunter, D.; Chevrier, V. L.; Persson, K. A.; Ceder, G. Python Materials Genomics (Pymatgen): A Robust, Open-Source Python Library for Materials Analysis. Computational Materials Science 2013, 68, 314-319). The lowest-energy Li, S, and Br orderings of Li₆₋ₓPS₅₋ₓBr₁₊ₓ were analyzed in the Python Materials Genomics (Pymatgen) package. Based on the stoichiometry, 20 structures were generated at each concentration interval (x=0, 0.125, 0.25, 0.375, 0.5, 0.625, 0.75) in a 2×1×1 supercell. With the increase of Li deficiency, S in 4d sites were gradually replaced by Br. Meanwhile, in order to simulate the true atomic arrangement in the synthesized materials in this work, S²⁻/Br⁻ mixing was considered in these orderings. In cases where x=0, 0.125 and 0.25, S also occupied 4a sites. Geometry optimization and total energy calculations were conducted, with a planewave cutoff of 520 eV and a k-point sampling of 1×2×2 for unit cells consisting of 98 to 106 atoms. The unit cell parameters were relaxed during structural optimization. Chemical shifts were calculated using the linear response method developed by Yates, Pickard and Mauri (Yates, J. R.; Pickard, C. J.; Mauri, F. Calculation of NMR Chemical Shifts for Extended Systems Using Ultrasoft Pseudopotentials. Physical Review B 2007, 76 (2), 024401; Pickard, C. J.; Mauri, F. All-Electron Magnetic Response with Pseudopotentials: NMR Chemical Shifts. Physical Review B 2001, 63 (24), 245101). Structures with the lowest total energy were used for chemical shift calculation.

In an ideally ordered argyrodite structure with no mixing of S²⁻ and Br⁻, S²⁻ occupy two different Wyckoff sites, which are 16e located within the PS₄ unit and 4d in the second coordination sphere of P (4b). Due to the similar ionic radii (S²⁻:0.184 nm; Cl⁻:0.181 nm; Br⁻:0.196 nm; 0.22 nm), S²⁻ (4d) can exchange with halide ions at the 4a position, which can lead to the disorder between 4a and 4d. On the other hand, the PS₄ unit is rigid with strong covalent bonds between P—S, the substitution of S²⁻ (16e) with halide ions is rare. In each unit cell, there are 24 Li⁺ which can show a positional disorder over 24 g and 4 8h sites. 48h sites are off-center positions within the S₃Br tetrahedra. In the middle of the common plane of two face-sharing S₃Br tetrahedra lies the 24 g sites. It should be noted that the distance between two 48 h Li ions is 0.19 nm, so it is not energetically favorable to have Li ions at both 48 h sites simultaneously within the face-sharing double tetrahedra of S₃Br.

Therefore, Li ions only reside at either one of the adjacent 48 h sites or the 24 g within a double tetrahedra. 24 Li ions spread out around the 4d positions, and every 6 Li ions construct a cage-like octahedra. The Li-ion transport can occur within a 48 h pair (doublet), between different 48 h pairs within the cage (intra-cage) and between different cages (inter-cage).

Crystalline Li₆₋ₓPS₅₋ₓBr₁₊ₓ (0≤x≤0.5) was obtained at the annealing temperature of 450-550° C., as described herein. A Rietveld refinement of high-resolution X-ray diffraction pattern of Li₆PS₅Br was collected. Only a small amount of impurity was found in the sample. A broad peak around 20° was from the Kapton film. It showed that 24.4% of 4d sites were taken by Br, indicating considerable site disorder without Br substitution. With increasing amount of Br, the cubic structure was maintained, but with enlargement of the lattice parameter. Taking the (3 1 1) plane as an example, the shift of (3 1 1) diffraction peak around 30° indicated that the lattice experienced an expansion, which may lead to enlarged ion diffusion channels. The lattice parameter as a function of Br amount is plotted, which was in accordance with Vegard's Law.

The EIS of Li₆₋ₓPS₅₋ₓBr₁₊ₓ showed that conductivity (T=21° C.) increased from x=0 to 0.7, and then decreased when x=0.8 due to the change of structure. The highest conductivity of 10 mS cm⁻¹ at 21° C. was achieved at x=0.7, which doubled that of Li₆PS₅Br. The temperature dependence of the ionic conductivity of Li₆₋ₓPS₅₋ₓBr₁₊ₓ. Li₆PS₅Br showed the highest activation energy of 0.227 eV and Li_{5.3}PS_{4.3}Br_{1.7} had the lowest activation energy of 0.178 eV.

To probe structural disorder and understand the origin of the increase in ionic conductivity, high-resolution solid-state ⁶Li NMR was applied. Two Li resonances were observed in the spectra of Li₆₋ₓPS₅₋ₓBr₁₊ₓ. 1.62 ppm resonance was assigned to Li (24g) and the one at 1.59 ppm was assigned to Li (48h) in Li₆PS₅Br. The small difference in the chemical shift stemmed from slightly different deshielding effects on Li at 24 g and 48 h. With increasing amount of Br, more S ions at 4d were substituted by Br ions, which introduced Li vacancies in the cages surrounding the 4d positions. ⁶Li signal shifted towards higher field with smaller ppm values. The ⁶Li isotropic shift was in agreement with the average ⁶Li shift obtained from DFT NMR calculation. The fraction of Li (24 g) and Li (48 h) of Li₆₋ₓPS₅₋ₓBr₁₊ₓ together with their corresponding ionic conductivities was plotted, and the total signal intensity was normalized to 100%. An increase in the 24 g site fraction was observed. It could be explained by improved stability of 24 g sites due to the expansion of the lattice after substituting S with Br. The 24 g site fraction correlated with conductivity, which indicated that Li (24 g) promoted fast ion conduction.

Li ion mobility in Li₆₋ₓPS₅₋ₓBr₁₊ₓ (0≤x≤0.7) was probed with spin-lattice relaxation time (T₁) measurement. According to Bloembergen, Purcell, and Pound (BPP) relaxation model (Bloembergen, N.; Purcell, E. M.; Pound, R. V. Relaxation Effects in Nuclear Magnetic Resonance Absorption. Physical Review 1948, 73 (7), 679-712), the correlation time (τ_{c}), which is the time for spins to transition to distinct Zeeman levels, was reflected by the T₁ of the spins. T1 and τ_{c} were correlated through equation 1 where T₁ is the spin-lattice relaxation time, γ is the magnetogyric ratio, h=h/2π where h is Planck's constant, τ_{c} is the correlation time, r₀ is the interproton distance and ω₀ is the Larmor frequency. Equation 1 can be simplified to equation 2, when ω₀τ_{c}≤1 is satisfied. For liquids and small molecules, which relax fast, the T₁ is negatively correlated with the τ_{c}. While for solids and large molecules with slow motions, the T₁ is proportional to the τ_{c}. Fast Li jump rate of the magnitude of 10⁻⁹ s⁻¹ was observed for Li₆PS₅Br at ambient temperature, suggesting a liquid-like diffusion behavior. Therefore, the T₁ of Li₆₋ₓPS₅₋ₓBr₁₊ₓ should reside at the fast motion regime, which means faster Li-ion motion leads to longer T₁. The T₁ of Li₆₋ₓPS₅₋ₓBr₁₊ₓ as a function of x was plotted, and with increasing Br in Li₆₋ₓPS₅₋ₓBr₁₊ₓ, the ⁷Li T₁ increased, suggesting increased Li-ion motion. The enhanced Li-ion motion may promote Li-ion conduction, which mirrors with the observation of increased Li-ion conductivity with more Br in Li₆₋ₓPS₅₋ₓBr₁₊ₓ.

$$\begin{matrix}( \frac{1}{{T}_{1}} ) = \frac{3 {γ}^{4} {ℏ}^{2}}{10 {r}_{0}^{6}} [ \frac{{τ}_{c}}{1 + {ω}_{0}^{2} {τ}_{c}^{2}} + \frac{2 {τ}_{c}}{1 + 4 {ω}_{0}^{2} {τ}_{c}^{2}} ] & ( 1 ) \\ ( \frac{1}{{T}_{1}} ) = \frac{3}{2} \frac{{γ}^{4} {ℏ}^{2}}{{r}_{0}^{6}} {τ}_{C} & ( 2 )\end{matrix}$$

To further examine the Br/S disorder at 4d sites, ³¹P NMR was employed. In the Li₆₋ₓPS₅₋ₓBr₁₊ₓ structure, four 4d sites located in the second coordination shell of P can be occupied by either S²⁻ or Br⁻. The difference in the resulted configurations of 4d sites could be revealed by different ³¹P NMR resonances yielded by heteronuclear dipolar couplings between P and S/Br. There are five distinctive atomic arrangements at the four 4d sites: 4S, 3S1Br, 2S2Br, 1S3Br, and 4Br. Correspondingly, five ³¹P NMR resonances were detected: P1 (4S), P2 (3S1Br), P3(2S2Br), P4(1S3Br) and P5 (4Br). Significant disorder was observed even at low Br concentration from ³¹P NMR spectra. Notably, the P5 component was undetectable at low Br content, however, starting from x=0.3, all five characteristic local environments of P were observed. The P1 (4S) peak was well-resolved in ³¹P NMR spectra across the whole set of Li₆₋ₓPS₅₋ₓBr₁₊ₓ samples, and its intensity decreased with the increasing amount of Br. Assuming statistical mixing of Br⁻ and S²⁻ at 4d sites, the fraction of each configuration was calculated using equation (1), in which n (n=0,1,2,3,4) and y (0≤y≤1) represented the number of sulfur at the 4d sites and the fraction of 4d sites occupied by S, respectively. The experimental data of ³¹P NMR was in agreement with the predicted fractions of five configurations, which confirmed that the peak of P(5-n) represented the configuration of nS(4-n)Br. Among these five configurations, the fractions of 1S3Br and 4Br increased from x=0 to 0.7. 4S and 3S1Br slightly decreased in the beginning, then dropped abruptly from x=0.3 to 0.5. The change of 2S2Br configuration was less significant relative to other configurations.

AIMD simulations were employed to understand the impact of Br/S disorder on Li-ion density and diffusion. 1×1×1 cells with 4d site occupancies (Br) of 0, 25%, 50%, 75% and 100% were generated for calculations, which corresponded to the atomic arrangements of 4S, 3S1Br, 2S2Br, 1S3Br and 4Br, respectively. It showed a localized Li diffusion within the cage when the 4d sites are fully occupied by S.

However, once the occupancy of Br increased, cages would be connected, forming a network-like diffusion pathway. To form a network for macroscopic diffusion, all three types of jumps should be present: doublet (within a 48 h-48 h pair), intra-cage (between neighbored 48 h-48 h pairs) and inter-cage (between two different cages). This manifested the densities of AIMD trajectories at 500K for (a) 0 and (b) 50% of the 4d sites occupied by bromide in a 1×1×1 cell, in which the 0 Br-occupancy showed low Li density between cages, indicating the deficiency of inter-cage jumps, however, the 50% Br-occupancy exhibited promoted inter-cage jumps.

Meanwhile, the distance between 48 h-48 h started to increase with increasing Br-occupancy, implying the onset of the decrease of doublet jump rate. As a result, the overall rate for macroscopic Li diffusion was limited by inter-cage jumps at low Br-occupancy but limited by doublet jumps at high Br-occupancy. In other words, the overall jump rate was determined by the slowest jump. The rate of doublet jump reduced drastically and became the new limiting jump when Cl-occupancy shifted from 75% to 100%. The diffusion pathway also changed at the Cl-occupancy of 100%. Since the frequency of doublet jump became extremely low, the possibility of the presence of Li along the 48 h-48 h passage decreased significantly. Therefore, the cages were disconnected and Li diffusion became localized again.

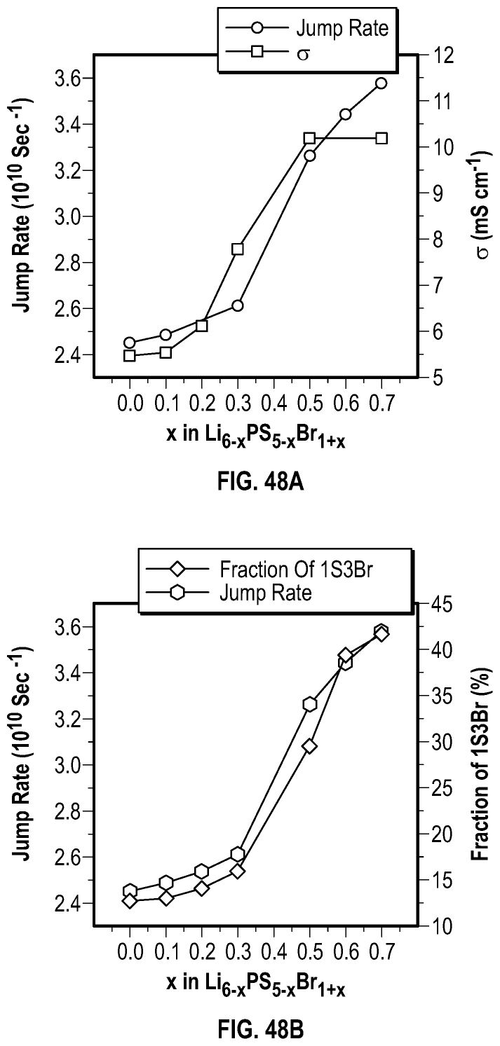

Since different atomic arrangements at 4d sites lead to different limiting Li jump rates, a distribution of distinctive configurations exists in Li₆₋ₓPS₅₋ₓBr₁₊ₓ. Therefore, all configurations should contribute to the overall jump rate for macroscopic ion conduction. The frequencies of three different jumps for different Br occupancies at 4d were calculated by DFT molecular dynamics (MD) simulations. The overall jump rate was estimated by equation (2), in which Pᵢ is the probability of a configuration obtained from ³¹P NMR analysis, and Rᵢ is the limiting jump rate of a corresponding configuration obtained from DFT MD simulation. According to equation (3), in which σ is the conductivity, n is the concentration of the charge carrier, Ze, the charge of the ion, and μ, the mobility of the charge carrier. Mobility could be quantitively described with jump rate. Then, a positive correlation between the measured conductivity and the calculated overall jump rate was established (FIG. 48A) for Li₆₋ₓPS₅₋ₓBr₁₊ₓ. A phase-pure x=0.7 sample should have higher conductivity than the measured conductivity, as the Li_{5.3}PS_{4.3}Br_{1.7} contains small amount of impurities. The fraction of 1S3Br was also compared with overall jump rate (FIG. 48B), and they followed a similar trend as increasing x in Li₆₋ₓPS₅₋ₓBr₁₊ₓ. It suggested that the configuration of 1S3Br was the major contributor to overall jump rate, because this configuration gave the highest limiting jump rate.

Rₒᵥₑᵣₐₗₗ=ΣPᵢ×Rᵢ (4)

σ=nZeμ (5)

The disorder of Br and S at 4d sites could also be directly observed through ⁷⁹Br NMR. ⁷⁹Br (spin− 3/2) often exhibit very large quadrupolar coupling, which significantly broadens ⁷⁹Br NMR resonance over thousands of ppm range. Accurate quantification on disordered component can be extremely daunting due to the challenge of achieving homogeneous broad-band excitation and recovering the signal without distortion. The broad resonance of Li₆₋ₓPS₅₋ₓBr₁₊ₓ can extend up to two thousand ppm, which has a spin-spin relaxation time (T₂) of several microseconds, posing tremendous challenge in data acquisition.

The signal that decays in microseconds is hard to capture by regular single-pulse or spin-echo experiments. Therefore, a QCPMG pulse sequence was utilized to enhance the signal-to-noise ratio at the expense of resolution. Previous ⁷⁹Br NMR study on Li₆PS₅Br have shown a sharp signal (109 ppm) and a broad signal (−40 ppm) that are assigned to ordered and disordered parts, respectively (Deiseroth, H.-J.; Kong, S.-T.; Eckert, H.; Vannahme, J.; Reiner, C.; Zaiβ, T.; Schlosser, M. Li6PS5X: A Class of Crystalline Li-Rich Solids With an Unusually High Li+ Mobility. Angewandte Chemie International Edition 2008, 47 (4), 755-758). Since the crystallographic site 4a is a high-symmetry site, the quadrupolar interaction was weak. As a result, the lineshape of 4a should be sharp. This was then applied to analyzing the spectra acquired by QCPMG ⁷⁹Br experiment. The signal from the sharp component of 4a was allocated into the spikelets near 100 ppm in QCPMG spectra, and the rest of the signals were from 4d. ⁷⁹Br QCPMG spectra of Li₆₋ₓPS₅₋ₓBr₁₊ₓ revealed an obvious increase in Br occupancy at 4d. For comparison, the spectrum of Li_{5.7}PS_{4.7}IBr_{0.3} was exhibited. I⁻ showed no positional mixing with S²⁻ in Li₆PS₅I, and it preferred to sit in 4a. If 4a sites were fully occupied by I⁻, Br⁻ would be forced to sit at 4d sites. The spectrum of Li_{5.7}PS_{4.7}IBr_{0.3} showed enhanced intensity of Br(4d). An analysis of the fraction of 4d occupied by Br from ³¹P and ⁷⁹Br NMR analyses were in good agreement. It showed that Br(4d) occupancy positively correlated with Br amount in the Li₆₋ₓPS₅₋ₓBr₁₊ₓ.

To probe the active crystallographic site in ion conduction, ⁶Li→⁷Li tracer-exchange NMR was utilized. The Li₆PS₅Br sample is sandwiched by two ⁶Li-rich Li foils. Since the electrolyte pellet was naturally abundant in ⁷Li (⁷Li: 92.4%, ⁶Li: 7.6%), driven by a biased electric potential, ⁶Li ions from ⁶Li-rich metal could occupy the vacant/interstitial sites or partially replace the native ⁷Li ions, elucidating the ion transport pathways enriched by ⁶Li.³¹⁻³⁴

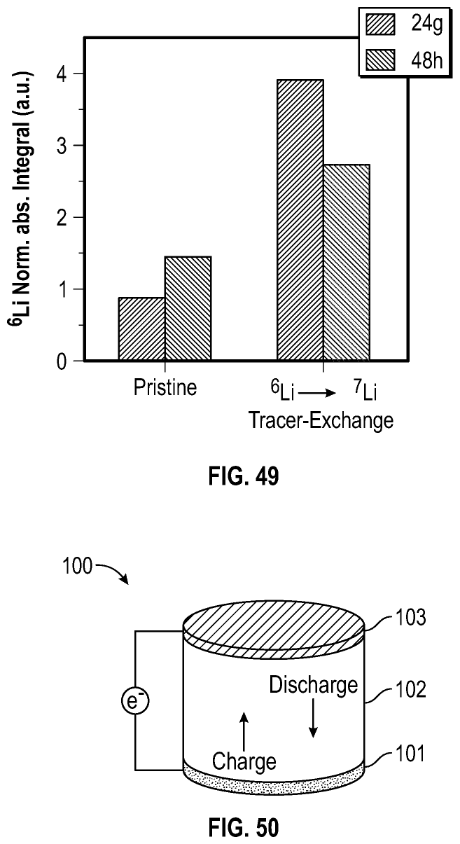

An increase of ⁶Li signal intensity and the preference for 24 g over 48 h was observed from a difference spectrum. The fitting of the difference spectrum showed 65.3% of the total intensity from 24 g and 34.7% from 48 h. FIG. 49 depicts the summary of the quantitative analysis of the signals before and after tracer-exchange. The 24 g component in pristine sample was normalized to 1. The amount of ⁶Li at 24 g and 48 was increased by 4.37 and 1.88 times respectively, which indicated that 24 g is more favorable in ion conduction.

1. A solid electrolyte comprising:
a lithium-argyrodite solid electrolyte of formula (I)
Li₆₋ₐPS₅₋ₐX₁₊ₐ+b LiX (I),
wherein a is about −0.3 to about 0.75,
b is 0 to about 0.3, and
X is selected from the group consisting of Cl, Br, I, and a combination thereof.

2. The solid electrolyte of claim 1, wherein a is about 0.2 to about 0.7.

3. (canceled)

4. The solid electrolyte of claim 1, wherein a is about −0.3 to about 0.3.

5. The solid electrolyte of claim 1, wherein (i) a is about 0.7, and (ii) b is 0.

6. The solid electrolyte of claim 5, wherein X is a combination of Cl and Br.

7. The solid electrolyte of claim 6, wherein X is Cl_{1.0}Br_{0.7}.

8-9. (canceled)

10. The solid electrolyte of claim 1, wherein (i) a is 0.5, and (ii) b is 0.

11-12. (canceled)

13. The solid electrolyte of claim 1, wherein (i) a is 0, and (ii) and b is 0.

14-15. (canceled)

16. The solid electrolyte of claim 1, wherein X is Cl.

17. The solid electrolyte of claim 16, wherein (i) a is −0.1, or (ii) a is −0.2.

18. (canceled)

19. The solid electrolyte of claim 16, wherein (A) (i) a is 0.1, and (ii) b is 0; (B) (i) a is 0.2, and (ii) b is 0; or (C) (i) a is 0.3, and (ii) b is 0.

20-21. (canceled)

22. The solid electrolyte of claim 1, wherein X is Br.

23. The solid electrolyte of claim 22, wherein (A) (i) a is 0.1, and (ii) b is 0; (B) (i) a is 0.2, and (ii) b is 0; and (C) (i) a is 0.3, and (ii) b is 0.

24-25. (canceled)

26. The solid electrolyte of claim 1, wherein (i) a is 0, (ii) b is 0, and (iii) X is a combination of Cl and I.

27. The solid electrolyte of claim 26, wherein X is Cl_{0.9}I_{0.1} or Cl_{0.8}I_{0.2}.

28. (canceled)

29. The solid electrolyte of claim 1, wherein (i) a is 0.3, (ii) b is 0, and (iii) X is a combination of Cl and Br.

30. The solid electrolyte of claim 29, wherein X is C_{1.0}Br_{0.3}, Cl_{0.9}Br_{0.4}, or Cl_{0.8}Br_{0.5}.

31-32. (canceled)

33. The solid electrolyte of claim 1, wherein (i) a is 0.3, (ii) b is 0, and (iii) X is a combination of Cl and I.

34. (canceled)

35. The solid electrolyte of claim 1, wherein (i) a is 0.3, (ii) b is 0, and (iii) X is a combination of Br and I.

36. (canceled)

37. The solid electrolyte of claim 1, wherein (i) a is 0.2, (ii) b is 0.2, and (iii) X is Cl.

38. The solid electrolyte of claim 1, wherein the solid electrolyte has the following formula:
Li_{5.7}PS_{4.7}Cl_{1.3}0.3 LiI (Ia).

39. The solid electrolyte of claim 1, wherein (i) b is 0, and (ii) the solid electrolyte has the following formula:
Li₆₋ₐPS₅₋ₐClBrₐ (Ib),
wherein a is 0 to about 0.7.

40. (canceled)

41. An electronic device comprising the solid electrolyte of claim 1.

42. The electronic device of claim 41, wherein the electronic device is an all-solid-state lithium ion battery comprising an anode, and the anode includes the solid electrolyte.

43. A method of forming a solid electrolyte, the method comprising:
providing a mixture comprising Li₂S, P₂S₅, and LiX, wherein X is selected from the group consisting of Cl, Br, I, and a combination thereof, and the mixture has a mole ratio of [Li:P:S:X] of [about 5.25 to about 6.3:1:about 4.25 to about 5.3:about 0.7 to about 1.75];
grinding the mixture to form a powder;
ball milling the powder to form a milled powder;
sintering the milled powder to form a sintered powder;
optionally grinding the sintered powder;
pressing the sintered powder into a pellet; and
sintering the pellet.

44-49. (canceled)
